(19) United States
(12) Patent Application Publication
(10) Pub. No.: US 2015/0067129 A1
(43) Pub. Date: Mar. 5, 2015

(54) APPARATUS, SYSTEM, AND METHOD OF MANAGING DEVICE, AND RECORDING MEDIUM STORING DEVICE MANAGEMENT PROGRAM

(71) Applicants: Yuuichiroh HAYASHI, Kanagawa (JP); Ryo TAKEMOTO, Kanagawa (JP)

(72) Inventors: Yuuichiroh HAYASHI, Kanagawa (JP); Ryo TAKEMOTO, Kanagawa (JP)

(21) Appl. No.: 14/471,646

(22) Filed: Aug. 28, 2014

(30) Foreign Application Priority Data
Aug. 29, 2013 (JP) 2013-178033
Aug. 29, 2013 (JP) 2013-178042

(51) Int. Cl. H04L 12/24; H04L 12/18

(52) U.S. Cl. CPC H04L 41/0823; H04L 12/1827
USPC 709/223

(57) ABSTRACT

In response to a request for reproducing one or more devices in a first area, one or more devices in a second area are caused to reproduce connections and roles of the one or more devices in the first area, as determined based on usage information indicating use of the one or more devices in the first area and device information for the one or more devices in the second area.

### CROSS-REFERENCE TO RELATED APPLICATIONS

This patent application is based on and claims priority pursuant to 35 U.S.C. §119(a) to Japanese Patent Application Nos. 2013-178033, filed on Aug. 29, 2013, and 2003-178042, filed on Aug. 29, 2013, in the Japan Patent Office, the entire disclosure of which is hereby incorporated by reference herein.

### BACKGROUND

1. Technical Field

The present invention generally relates to managing devices, and more specifically, to an apparatus, system, method, and control program stored in a recording medium each of which is capable of managing devices to reproduce an environment.

2. Description of the Related Art

Recently, various electronic devices such as personal computers (PC), projectors, conference systems, and electronic whiteboards are used during a meeting. Some devices are stored with various data relating to the meeting. For example, the PC is stored with data of an image to be projected through the projector, and the electronic whiteboard is stored with data that reflects writings by the user.

In some cases, the user may need to change a meeting room in the middle of meeting, when the meeting does not end on time. In such case, it is desirable to continue the meeting in the same environment, even after moving to another meeting room. To reproduce the same environment, the user manually configures a projector in another meeting room to project the image, or downloads data that reflects the previously written contents from a management server.

### SUMMARY

In response to a request for reproducing one or more devices in a first area, one or more devices in a second area are caused to reproduce connections and roles of the one or more devices in the first area, as determined based on usage information indicating usage of the one or more devices in the first area and device information for the one or more devices in the second area.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic block diagram illustrating a configuration of a device management system, according to an example embodiment of the present invention;

FIG. 2 is a schematic block diagram illustrating a hardware structure of a management apparatus of the device management system of FIG. 1, according to an example embodiment of the present invention;

FIG. 3 is a schematic block diagram illustrating a functional structure of the management apparatus, and a device subjected for management by the management apparatus, of FIG. 1, according to an example embodiment of the present invention;

FIG. 4 is an example data structure of a meeting room table;

FIG. 5 is an example data structure of a meeting data table;

FIG. 6 is an example data structure of a device management table when reproduction is requested, according to a first scenario;

FIG. 7 is an example data structure of a role list;

FIG. 8 is an example data structure of a connection state table when reproduction is requested, according to the first scenario;

FIG. 9 is an example reproduction request screen;

FIG. 10 is a flowchart illustrating operation of processing a reproduction request, performed by the management apparatus of FIG. 1, according to an example embodiment of the present invention;

FIG. 11 is an example data structure of a connection state table after processing a reproduction request, according to the first scenario;

FIG. 12 is an example data structure of a device management table after processing a reproduction request, according to the first scenario;

FIG. 13 is an example data structure of a device management table when reproduction is requested, according to a second scenario;

FIG. 14 is an example data structure of a connection management table after processing a reproduction request, according to the second scenario;

FIG. 15 is an example data structure of a device management table when reproduction is requested, according to the third scenario;

FIG. 16 is an example data structure of a connection state table after processing a reproduction request, according to the third scenario;

FIG. 17 is an example data structure of a temporary device management table, according to an example embodiment of the present invention;

FIG. 18 is a flowchart illustrating operation of reproducing a meeting environment according to the example embodiment of FIG. 17, which may be performed in addition to operation of FIG. 10;

FIG. 19 is a schematic block diagram illustrating a functional structure of the management apparatus, and the device subjected for management by the management apparatus, of FIG. 1, according to an example embodiment of the present invention;

FIG. 20 is an example data structure of a prioritized meeting room table, according to an example embodiment of the present invention;

FIGS. 21A and 22B are a flowchart illustrating operation of processing a reproduction request, performed by the management apparatus, according to the example embodiment of FIG. 20;

FIG. 22 is an example data structure of a device management table when reproduction is requested, according to a fourth scenario;

FIG. 23 is an example data structure of a connection state table when reproduction is requested, according to the fourth scenario;

FIG. 24 is an example data structure of a state history table, according to the fourth scenario;

FIG. 25 is an example data structure of a connection state table after processing a reproduction request, according to the fourth scenario;

FIG. 26 is an example data structure of a prioritized device table, according to a fifth scenario;

FIG. 27 is an example data structure of a state history table, according to the fifth scenario;

FIG. 28 is a flowchart illustrating operation of reproducing a meeting environment, according to an example embodiment, which may be performed in addition to operation of FIG. 10;

FIG. 29 is an illustration of a screen for notifying a user, which may be displayed in the example embodiment of FIG. 28;

FIG. 30 is a schematic block diagram illustrating a functional structure of the management apparatus, the relay device, and the device subjected for management by the management apparatus, of FIG. 1, according to an example embodiment of the present invention;

FIG. 31 is an example data structure of a meeting room table;

FIG. 32 is an example data structure of a storage condition table;

FIG. 33 is an example data structure of reproduction data;

FIG. 34 is an example data structure of a contents data table;

FIG. 35 is an example data structure of a storage data table;

FIG. 36 is a data sequence diagram illustrating operation of storing reproduction data, according to an example embodiment of the present invention;

FIG. 37 is an example reproduction request screen;

FIG. 38 is a data sequence diagram illustrating operation of processing a reproduction request, according to an example embodiment of the present invention;

FIG. 39 is example data of a reproduction request;

FIG. 40 is example data of a reproduction request;

FIG. 41 is an example data structure of reproduction data, according to an example embodiment of the present invention;

FIGS. 42A and 42B are a data sequence diagram illustrating operation of processing a reproduction request, according to an example embodiment of the present invention;

FIG. 43 is an example data structure of information indicating the change to be reflected to reproduction data, for each meeting room;

FIGS. 44A and 44B are a data sequence diagram illustrating operation of processing a reproduction request, according to an example embodiment of the present invention;

FIG. 45 is a data sequence diagram illustrating operation of storing reproduction data, according to an example embodiment of the present invention;

FIGS. 46 and 47 are a data sequence diagram illustrating operation of storing reproduction data, according to an example embodiment of the present invention;

FIG. 48 is a data sequence diagram illustrating operation of storing reproduction data, according to an example embodiment of the present invention;

FIG. 49 is an example data structure of a storage data table, according to a modified example; and

FIG. 50 is an example data structure of reproduction data, according to a modified example.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

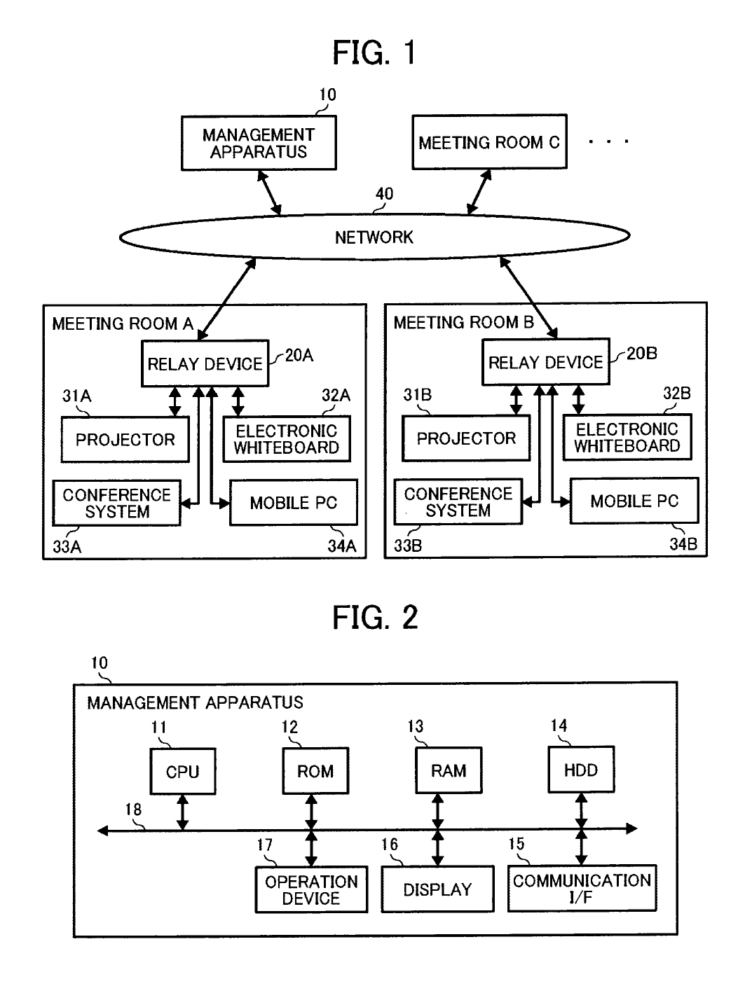

Referring now to FIGS. 1 to 29, an apparatus, system, method, and program stored on a recording medium, each of which is capable of reproducing a meeting environment, are explained according to an example embodiment of the present invention.

FIG. 1 illustrates a configuration of a device management system according to an example embodiment of the present invention.

The device management system of FIG. 1 includes a plurality of devices that are provided in each one of a plurality of remotely located areas such as meeting rooms A to C, and a management apparatus 10 capable of communicating with the devices in each meeting room through a network 40. The network 40 may be any desired communications network of wired or wireless, such as the Internet and/or a local area network (LAN).

The management apparatus 10 manages various data regarding the plurality of devices provided in each meeting room, such as device information regarding available functions of each device in each meeting room. For example, as described later, the device information may indicate one or more roles that can be performed by each device, and one or more communication functions that are available to each device. That is, the device information indicates capability of each device.

The management apparatus 10 further manages usage information regarding usage of each device of one or more devices in each meeting room, which reflects how each device has been previously used or currently used. The usage information may indicate, for example, a connection state of the device such as a counterpart device connected to each device, a communication function used by each device to establish a connection with the counterpart device such as information regarding a communication interface being used, an input device to which each device receives data from, an output device from which each device outputs to, etc. In the following, information regarding the connection state of the device is referred to as connection state information. The usage information may further indicate a role that is performed by each device, an operation state of each device such as information indicating whether the device is powered on, etc., which may be collectively referred to as operation state information. The usage information may further indicate contents information indicating the contents being used by each device.

The management apparatus 10 further manages various data regarding a meeting to be held or being held on each meeting room such as scheduled information regarding the meeting, or information indicating whether the meeting is being held.

The management apparatus 10 further controls operation of one or more devices provided in each meeting room, for example, through transmitting a request for performing specific operation to each device. In one example, the management apparatus 10 transmits a request to each device, which requests to send the usage information to the management apparatus 10, to collect usage information. In another example, the management apparatus 10 transmits a request to each device to connect with the counterpart device, using a specific communication function of each device that is determined based on the usage information. In another example, the management apparatus 10 transmits a request to each device to perform a role that is determined based on the usage information.

For the descriptive purposes, a configuration of the meeting room having a plurality of devices is illustrated for the meeting room A and the meeting room B.

In this example, a relay device 20A and a relay device 20B are provided, respectively, in the meeting room A and the meeting room B. For the descriptive purposes, in the following examples, the relay devices 20A and 20B may be collectively or each referred to as the relay device 20. The relay device 20 controls relay of communication of each device in the meeting room with the management apparatus 10. Alternatively, any device in the meeting room may be provided with the relay function to operate as the relay device 20. Alternatively, any device in the meeting room may directly communicate with the management apparatus 10.

The meeting room A is provided with a plurality of devices such as a projector 31A, electronic whiteboard (“whiteboard”) 32A, conference system 33A and mobile personal computer (PC) 34A. The projector 31A projects an image generated based on input image data, on a projection surface such as a screen. The whiteboard 32A displays contents drawn onto the board surface, while displaying the input image data onto the board surface. The conference system 33A, provided with a camera, microphone, display, and speaker, etc., exchanges various images or sounds with the other conference system that is remotely located, to carry out interactive communication between the remotely located sites. The mobile PC 34A, which may be implemented by a general-purpose PC, performs various operations such as transmitting image data to the projector 31A, and storing the contents drawn onto the board surface of the whiteboard 32A in a memory.

Further, in this example, the meeting room B is provided with a plurality of devices such as a projector 31B, electronic whiteboard 32B, conference system 33B, and mobile PC 34B, each of which is substantially similar in function to each one of the devices provided in the meeting room A. Alternatively, any one of the devices in the meeting room B does not have to be substantially similar in function to the corresponding one of the devices in the meeting room A.

In this example illustrated in FIG. 1, the devices provided in the meeting room A and the devices provided in the meeting room B are substantially similar, in combination, number, or type of devices provided in each meeting room, however, the devices provided in the respective meeting rooms may differ depending on the meeting room. For example, one or more of the devices provided in one meeting room may not be provided in the other meeting room, or one or more additional devices that are not provided in one meeting room may be provided in the other meeting room. In another example, the type of the devices may differ, depending on the meeting room.

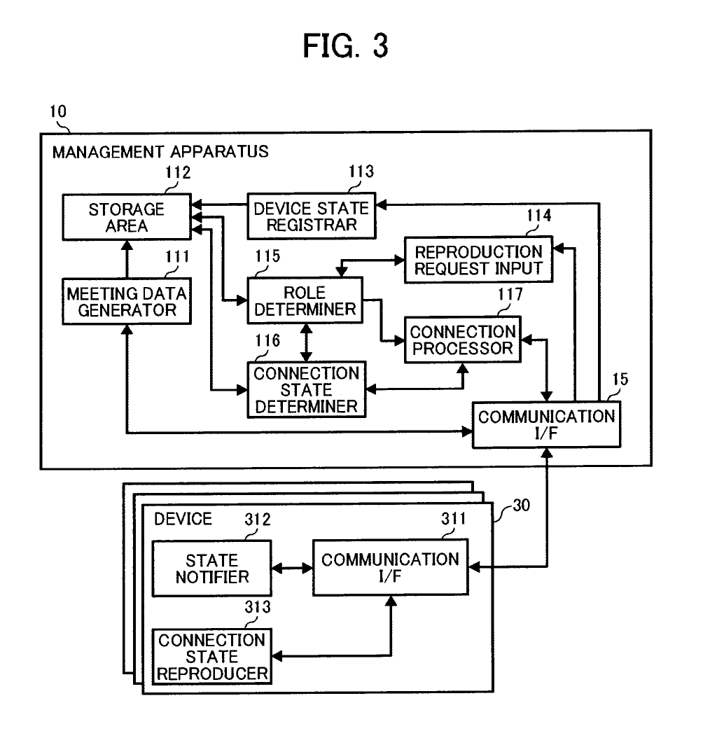

For the descriptive purposes, each device provided in the meeting room, which is a device to be managed by the management apparatus 10, is referred to as the device 30. As illustrated in FIG. 3, the device 30 is provided with functions that are common among the devices that are managed by the management apparatus 10, in addition to specific functions such as a projection function or conference function that differ among the devices.

Referring to FIG. 2, a hardware structure of the management apparatus 10 of FIG. 1 is explained according to an example embodiment of the present invention. The management apparatus 10 may be implemented by a genera-purpose computer, and includes a central processing unit (CPU) 11, a read only memory (ROM) 12, a random access memory (RAM) 13, a hard disk drive (HDD) 14, a communication interface (I/F), 15, a display 16, and an operation device 17, which are connected through a system bus 18.

The CPU 11 loads control program stored in the ROM 12 or HDD 14, onto the RAM 13 functioning as a work area, to control entire system of the management apparatus 10 according to the executed program. For example, the CPU 11 controls various device management operations according to a device management program.

The HDD 14, which is implemented by a nonvolatile memory, stores various programs for execution by the CPU 11, and various data such as various tables described below. The communication I/F 15 is a communication interface such as a network interface circuit, which allows the management apparatus 10 to communicate with the external apparatus such as the relay device 20 or the device 30, through the network 40.

The display 16, which may be implemented by a liquid crystal display (LCD), outputs various information to a user, such as, through displaying various data. The operation device 17 interacts with the user to receive a user input, and may be implemented by a keyboard, mouse, or touch panel, etc.

Any one of the display 16 and the operation device 17, each of which has a function of user interface, may be implemented as a device independent of the management apparatus 10. For example, the display 16 or the operation device 17 may be freely attached to or detached from the management apparatus 10. In another example, the management apparatus 10 may receive a user instruction from the external apparatus functioning as the use interface, such as the device 30, through the network 40. In such case, the display 16 or the operation device 17 does not have to be provided in the management apparatus 10, as long as the CPU 11 is provided with a control circuit to control the external apparatus functioning as the user interface.

The relay device 20, which may be implemented by the general-purpose computer, has a hardware structure that is similar to the management device 10, except that a relay control program is installed onto the memory.

The device 30 may have an information processing unit, which is implemented by a hardware structure similar to the hardware structure of FIG. 2 that includes a processor such as the CPU, and a memory such as the ROM or RAM. The device 30 may be installed with a device management program for the device 30. In addition to the information processing unit, the device 30 includes specialized hardware dedicated to perform specific function, such as hardware for performing the projection function, hardware for performing the display function, and hardware for performing detecting writings.

Referring now to FIG. 3, a functional structure of the management apparatus 10, and the device 30 to be managed by the management apparatus 10, is explained according to an example embodiment of the present invention.

The management apparatus 10 of FIG. 3 includes a meeting data generator 111, a storage area 112, a device state registrar 113, a reproduction request input 114, a role determiner 115, a connection state determiner 116, and a connection processor 117. These functional modules are implemented by the CPU 11, which operates in cooperation with the hardware of the management apparatus 10, according to the device management program stored in the memory.

The meeting data generator 111 generates meeting data according to a user instruction, and stores the meeting data in a meeting data table (FIG. 5). The meeting data generator 111 generates or modifies the meeting data, such as settings relating to the meetings.

The storage area 112, which may be implemented by any desired memory such as the RAM 13 or the HDD 14, stores various data, for example, in the form of table.

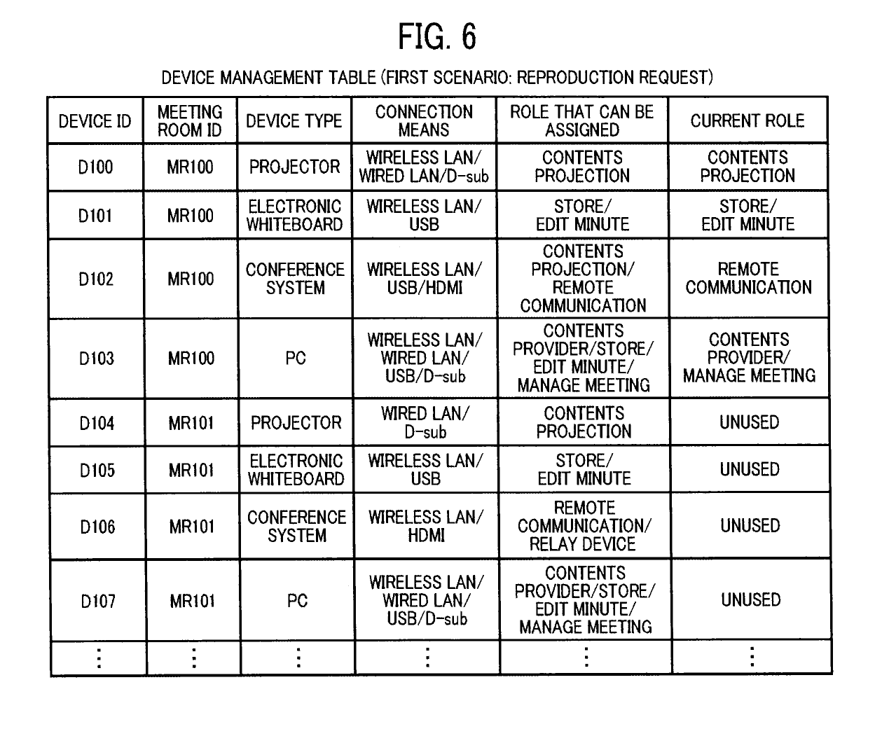

The device state registrar 113 registers information indicating the operation state of the device 30 managed by the management apparatus 10, such as the role currently assigned to the device 30, to the storage area 112, as the operation state information. The device state registrar 113 further registers information indicating the connection among the devices 30, to the storage area 112, as the connection state information. In one example, the device state registrar 113 may register such as the operation state information and the connection state information to the storage area 112, according to notification including the information received from the device 30, which may automatically send the notification including the information. Alternatively, the device state registrar 113 may request the device 30 to send notification including the operation state information and the connection state information to the management apparatus 10. In this example, the device state registrar 113 registers the operation state information of the device 30, to a device management table (FIG. 6). The device state registrar 113 registers the connection state information to a connection state table (FIG. 8).

In addition to the operation state information of the device 30, the device state registrar 113 registers various data regarding the device 30 in the meeting room, such as identification information, type, or available functions of the device 30, to the device management table (FIG. 6) as device information to be used for managing the device 30. The device state registrar 113 may register such information regarding the device 30 (device information), according to a user instruction. Alternatively, the device state registrar 113 may search for the device 30 to be managed by the management apparatus 10, and obtains device information from the searched device 30. For example, the device state registrar 113 may detect any device, disposed in the meeting room and communicable through the relay device 20, as the device 30 for management.

The reproduction request input 114 receives a user instruction for reproducing a meeting environment in one meeting room (source meeting room), onto the other meeting room (destination meeting room). In response to receiving the user instruction for reproducing the meeting environment, the reproduction request input 14 instructs the role determiner 115 to assign a role of a device in the source meeting room to a device 30 in the destination meeting room, as a part of operation of reproducing the meeting environment.

The role determiner 115 selects a device 30 in the destination meeting room, to have the role performed by the device 30 in the source meeting room, based on data available from such as the device management table (FIG. 6).

The connection state determiner 116 determines a connection, such as a communication function, to be used by the device 30 in the destination meeting room, which is selected by the role determiner 115 to have the role of the device 30 in the source meeting room. For example, the connection state determiner 116 refers to the connection state table (FIG. 8) to determine connections to be established among the devices 30 in the destination meeting room to reproduce connections established among the devices 30 in the source meeting room. The connection state determiner 116 may determine a communication function to be used by the device 30 in the destination meeting room, based on the communication function used by the device 30 in the source meeting room. In case the same communication function is not available to the device 30 in the destination meeting room, the connection state determiner 116 selects an alternative communication function based on data in the device management table (FIG. 6).

The connection processor 117 instructs the device 30 in the destination meeting room that is selected by the role determiner 115, to use the communication function that is determined by the connection state determiner 116 to connect to a specific counterpart device 30 in the destination meeting room, to establish connections among the devices 30 in the destination meeting room. In case the connection is not established with the counterpart device 30 as instructed by the connection processor 117, the connection processor 117 requests the connection state determiner 116 to reselect an alternative communication function of the device 30 in the destination meeting room.

Still referring to FIG. 3, the device 30 includes a communication I/F 311, a state notifier 312, and a connection state reproducer 313. These functional modules are implemented by the CPU 11, which operates in cooperation with the hardware of the device 30, according to the device management program for the device 30, stored in the memory. For example, such program may be downloaded from the management apparatus 10, when the device 30 accesses the management apparatus 10. More specifically, the device management program may be distributed over more than one device, which may be remotely located, to perform operation of managing devices to reproduce an environment of one area onto the other area.

The communication I/F 311 is a communication interface such as a network interface circuit, which allows the device 30 to communicate with the external device such as the relay device 20 and the management apparatus 10. The communication I/F 311 may be made common to the other interface used for communication with the other device 30, or may be made separate from the other interface used for communication with the other device 30.

The state notifier 312 notifies the connection state of the device 30 with the other device (connection state information), and the operation state of the device 30 (operation state information), to the management apparatus 10. The connection state information includes a device ID of the device 30 that requests for connection (connection source device), a device ID of the counterpart device 30 (connection destination device), and a type of communication function used for connection. As the type of communication function, information regarding a communication interface may be managed, such as a communications protocol. The operation state information includes information indicating the role currently assigned to the device 30. With the operation state information and the connection state information of the device 30, which are sent from each device 30 in the meeting room, the management apparatus 10 is able to manage information that reflects a meeting environment of the meeting room.

The connection state reproducer 313 receives an instruction to establish a connection with a specific device 30, from the management apparatus 10. As described above, the connection processor 117 instructs the devices 30 in the destination meeting room that are selected to perform the roles of the devices 30 in the source meeting room, to reproduce connections among the devices 30 based on the connections that have been established among the devices 30 in the source meeting room. In response to the instruction from the management apparatus 10, the connection state reproducer 313 connects the device 30 (connection source device) with the counterpart device 30 (connection destination device) using a specific communication function that is instructed. When connection with the connection destination device is successfully established as requested by the management apparatus 10, the state notifier 312 sends notification to the management apparatus 10 to indicate that the connection state has changed. With this connection state information, the management apparatus 10 is able to know whether connection is successfully established according to the request.

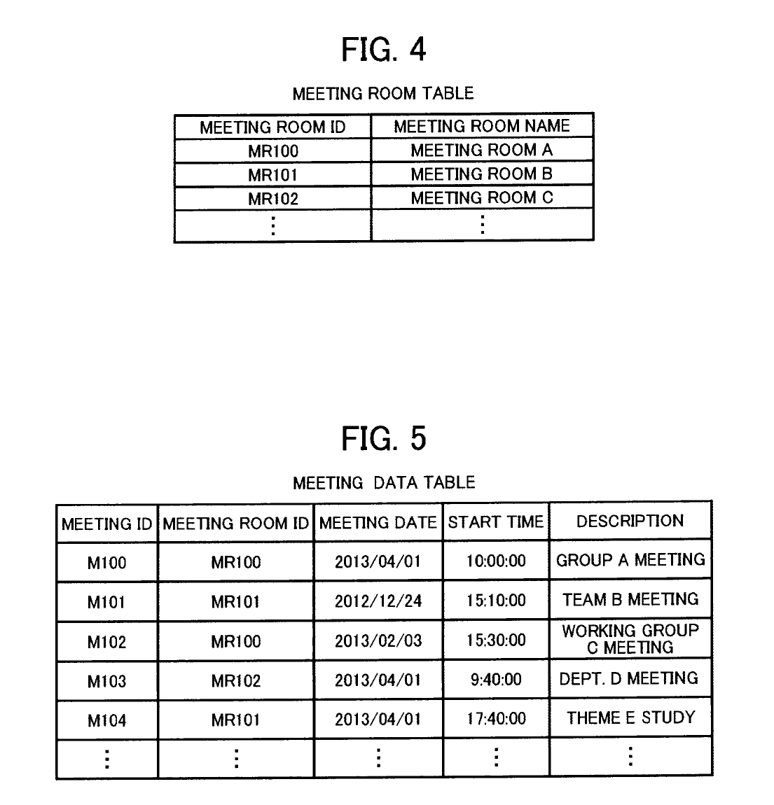

FIG. 4 illustrates an example data structure of a meeting room table, which associates a meeting room ID and a meeting room name for each meeting room, being managed by the management apparatus 10. In the following examples, the management apparatus 10 manages the meeting room using a meeting room ID. However, in order for the user to easily select a meeting room, the management apparatus 10 obtains a character string representing the meeting room name that matches the meeting room ID, from the meeting room table, and displays the obtained meeting room name. The contents of the meeting room table may be previously stored by an administrator of the management apparatus 10, based on information regarding the meeting room in which the device 30 is located.

FIG. 5 illustrates an example data structure of a meeting data table, which registers information regarding a meeting to be held for each meeting room. The meeting data table stores, for each one of meetings, a meeting ID, a meeting room ID, a meeting date, a start time, and description.

The meeting ID is identification information that identifies the meeting. The meeting room ID is identification information that identifies a meeting room in which the meeting is to be held. The meeting date is the date when the meeting is to be held. The start time is the time when the meeting is to be started. The description is any information that may be freely input by the user, such as any information relating to the meeting. For example, the user may input descriptive information regarding the meeting.

The contents of the meeting data table may be managed by the management apparatus 10, based on information regarding the meeting to be held, which may be input by the administrator of the management apparatus 10 or the user at the other device. The data regarding a specific meeting may be kept stored in the meeting data table, even after such meeting ends.

FIG. 6 illustrates an example data structure of the device management table, which stores information regarding each device 30 in the meeting room. The device management table of FIG. 6 stores, for each device, a device ID, meeting room ID, device type, connection means, role that can be assigned, and current role.

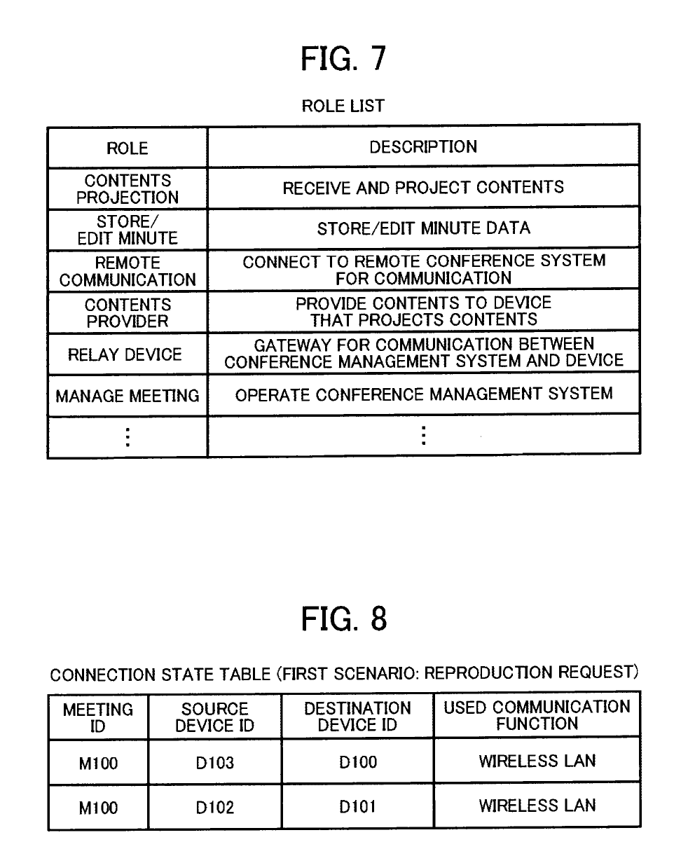

The device ID is identification information that identifies a device. The meeting room ID is identification information that identifies a meeting room in which the device is located. The device type is information indicating a type of the device. The connection means is information indicating a communication function that is available for use by the device to connect with the other device. In case a plurality of communication functions are available, the “connection means” field lists the plurality of communication functions. The role that can be assigned indicates a role that the device is capable of performing such that the device can be assigned with. In case a plurality of roles can be assigned to the device, the “role that can be assigned” field lists the plurality of roles. In this example, a plurality of roles is available as listed in FIG. 6, which may be described below referring to the role list of FIG. 7. The current role indicates a role that is currently assigned to the device.

In case the device is not assigned with any role, the “current role” data field has the value “unused”. That is, such device with the value “unused” is not performing any role, while the meeting is being held. For example, if the user is not using a videoconference system, as all of the participants are in the same room, the videoconference system is not used even it is located in the meeting room. In another example, if no meeting is held, all of the devices in the meeting room are unused.

The above-described data may be managed by the management apparatus 10, according to information regarding the device in the meeting room that is input by the administrator of the management apparatus 10 or the user at the other device. For example, the device state registrar 113, which may be implemented by the CPU 11, of the management apparatus 10 registers various device information to the storage area 112, such as information regarding the current role being assigned to the device. Alternatively, the management apparatus 10 may automatically register such information, based on information provided from each device 30. Alternatively, the management apparatus 10 may be already stored with such information, or may be updated to have such information, based on information provided from a services provider of the management apparatus 10.

The device management table of FIG. 6 illustrates the example case in which a meeting is held in the meeting room “A” having the meeting room ID “MR100”, and a meeting is not held in the meeting room “B” having the meeting room ID “MR101”.

For each one of the devices in the meeting room A, having the device IDs “D100” to “D103”, information indicating the current role is stored. For each one of the devices in the meeting room B, having the device IDs “D104” to “D107”, the current role is “unused” as there is no meeting being held in the meeting room B.

The management apparatus 10 may manage information regarding the current role, according to a user instruction, or automatically based on the operation state of each device 30 that may be obtained from each device 30.

In case the current role information is managed according to the user instruction, before starting the meeting, the user in the meeting room starts up each device, establishes connection for each device, and checks settings of each device. Based on the results of such operation, the user inputs information indicating the current role assigned to each device to the management apparatus 10. For example, the user accesses an address of the management apparatus 10 using a web browser installed onto a PC operated by the user, and inputs various data using a graphical user interface (GUI) displayed on a web browser screen. The management apparatus 10 generates values to be input as the current role of each device, based on the input information input by the user.

In case the current role information is automatically managed by the management apparatus 10, the management apparatus 10 periodically monitors the operation state of each device registered in the device management table. For example, based on notification regarding the operation state from each device, which may be automatically transmitted or transmitted in response to an inquiry to the device, the management apparatus 10 may generate the value indicating the current role assigned to each device. For the device that is not turned on, the management apparatus 10 assumes that such device is not used, and assigns the value “unused” to such device. The user may set each device with a specific role, or the management apparatus 10 may access each device to set the device with a specific role.

FIG. 7 is an example data structure of a role list, which defines a specific rule, such as contents to be described in the “role that can be assigned” field or the “current role” field in the device management table. The role list includes a role indicating a type of role that can be assigned to the device 30, and a description of the specific role. The roles to be registered to the role list of FIG. 7 may be determined according to a user preference. In this specific example, the role to be used to carry out a meeting is specified. The contents in the description data field may be used as a character string for display to the user. The role table of FIG. 7 may additionally store identification information that identifies a role, which may be referred to by the management apparatus 10 or the device 30.

FIG. 8 is an example data structure of a connection state table, which stores various information indicating a connection between or among various devices in the meeting room. The connection state table of FIG. 8 includes a meeting ID, a connection source device ID, a connection destination device ID, and a used communication function, in association with one another.

The meeting ID is one example of identification information that identifies a meeting, which is held in a meeting room having devices that have established and having a specific connection. The meeting ID may be set, according to the contents of the meeting data table (FIG. 5). In case the meeting room is changed, for example, in the middle of meeting, the meeting room that is registered to the meeting data table (FIG. 5) in association with the meting ID may differ from the meeting room that the meeting is actually being held. Even in such case, using the meeting ID that is uniquely assigned to each meeting, the connection state information of each device in the meeting room that the meeting is currently held can be managed.

The connection source device ID is a device ID that identifies a device that requests for connection. The connection destination device ID is a device ID that identifies a device that is requested to be connected by the connection source device. These devices IDs may be set according to the contents of the device management table.

The used communication function is a communication function used for a connection between the connection source device and the connection destination device. The communication function may be selected from a plurality of available communication functions that are described in the “communication means” field of the device management table of FIG. 6.

In this example, the management apparatus 10 may generate the contents to be stored in the connection state table according to a user instruction, or may automatically generate based on the connection state of the device 30 that may be collected from each device 30, as described above in the case of managing the operation state using the device management table.

Preferably, in the case of managing data according to the user instruction, the management apparatus 10 collects connection state information of the device 30 to determine whether the device 30 is connected as instructed by the user, before registering data to the connection state table of FIG. 8.

In this example, the storage area 112, which stores information regarding the connection state such as the connection state table, functions as a storage area that stores usage information that at least indicates a connection state of each device of some devices in the meeting room. The CPU 11 of the management apparatus 10 performs the function of registering data to the storage area storing usage information.

Next, example operation of reproducing a meeting environment in a destination meeting room to keep the environment substantially the same as that of a source meeting room, when a user moves from the source meeting room to the destination meeting room, performed by the management apparatus 10 in cooperation with the device 30, is explained.

In some cases, a meeting may take a longer time than scheduled. In such case, a meeting room that a user is currently using (referred to as a source meeting room) may have already be booked by the other user. In such case, the user, i.e., the meeting participants, may need to move out from that source meeting room, to another meeting (referred to as a destination meeting room). It is usually desirable for the user to keep the same environment, even after moving to the destination meeting room.

For example, the user may want to use the same functions provided by the devices in the source meeting room, using different devices in the destination meeting room. More specifically, the user may want to display the image, which has been displayed in the source meeting room in the same manner, using the same type of device in the destination meeting room. The user may want to display writing data, which is displayed on the device (such as whiteboard) in the source meeting room in the same manner, using the same type of device in the destination meeting room. The user may want to continue discussion with the remotely located area, in case the conference system is used in the source meeting room, in the same manner using the same type of device in the destination meeting room. In order to reproduce the same meeting environment of the source meeting room, the devices 30 in the destination meeting room that are capable of performing the same roles of the devices 30 in the source meeting room need to be specified. Further, such devices 30 specified in the destination meeting room should be connected in a manner to establish the connection state of the devices 30 in the source meeting room.

With the increased use in wireless network system, there are increased number of candidates of a connection destination for each device 30 in the meeting room. That is, according to the user need, the connection state of devices 30 in the meeting room may vary. Even in case of wired network system, the devices 30 connected through the wired network not always have the same configuration, as the configuration may differ depending on the user need. Further, the communication functions may differ among devices, such that means for connection that is available for the source meeting room may not be available for the destination meeting room. For example, a wired network may be only available for older devices.

Accordingly, the connection state of devices 30 may greatly differ among the meeting rooms for various factors, such as due to the functions of the devices in the meeting room and preference of the user operating the devices, etc. It is thus difficult and time-consuming for the user to manually reproduce the same environment of the source meeting room, in the destination meeting room.

In view of this, the management apparatus 10 of FIG. 1 controls the devices 30 in the destination meeting room, to reproduce a meeting environment of the devices 30 in the source meeting room, in response to a request from the user.

More specifically, the user accesses the management apparatus 10, for example, through a PC, to request for reproducing a meeting environment of the source meeting room, onto the destination meeting room. In this example, the meeting environment may be defined by the operation state of each device in the meeting room, and the connection state of each device in the meeting room. Further, the user may request to reproduce the meeting environment, at any location, such as before leaving the source meeting room or after moving to the destination meeting room, or on the way of moving from the source meeting room to the destination meeting room.

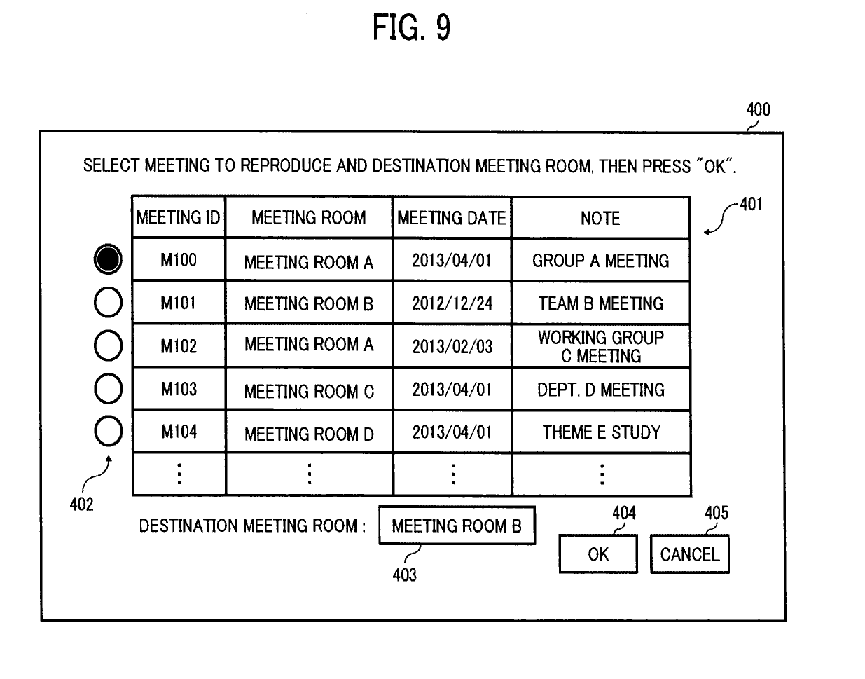

FIG. 9 is an example reproduction request screen 400, which allows a user to input a request for reproducing a meeting environment onto a destination meeting room.

In one example, the management apparatus 10 displays the reproduction request screen 400 through a user terminal operated by the user, such as the mobile PC 34, in response to access by the user terminal.

The reproduction request screen 400 includes a meeting list section 401, a plurality of radio buttons 402, a destination meeting room input 403, an “OK” key 404, and a “CANCEL” key 405.

The meeting list section 401 is an area for displaying a list of meetings that are currently held and managed by the management apparatus 10. The meeting list may be generated based on the contents of the meeting data table of FIG. 5, and the current date/time. The meeting room name may be displayed based on the contents of the meeting room table of FIG. 4. For example, the meeting data generator 111 may extract information regarding one or more meetings having the meeting date and time that fall within a range set based on the current date and time, such as the meeting ID, meeting room ID, meeting date, and the description. The meeting data generator 111 further obtains the meeting room name that matches the meeting room ID being extracted, using the meeting room table of FIG. 4.

One of the radio buttons 402 may be selected to indicate a user selection that selects a meeting environment that the user desires to reproduce. In most cases, the user selects a specific meeting that the user currently participates in. Further, as a part of the user selection, the user may select a source meeting room from which the user plans to move out, from the meeting rooms listed in the meeting list section 402. The source meeting room is a meeting room used by the user for a currently-held meeting. In FIG. 9, the meeting room A is selected, as the source meeting room, which lists in association with the meeting ID “M100”. In alternative to allowing the user to freely select the source meeting room, the management apparatus 10 may previously select a meeting room where the user is present for display to the user.

The destination meeting room input 403 is an area, which displays information indicating the destination meeting room that is input by the user. The user may directly input text data in the destination meeting room input 403, using any desired input device such as a keyboard. Alternatively, the management apparatus 10 may generate a list of meeting rooms that are currently available for use, based on information obtained from the meeting data table or usage information of each meeting room, and request the user to select one meeting room from the list as the destination meeting room.

The “OK” key 404, when selected, confirms user selection of the source meeting room and/or the destination meeting room, and sends a request for reproducing a meeting environment of the source meeting room onto the destination meeting room to the management apparatus 10. The “CANCEL” key 405, when selected, closes the reproduction request screen 400 without sending a reproduction request.

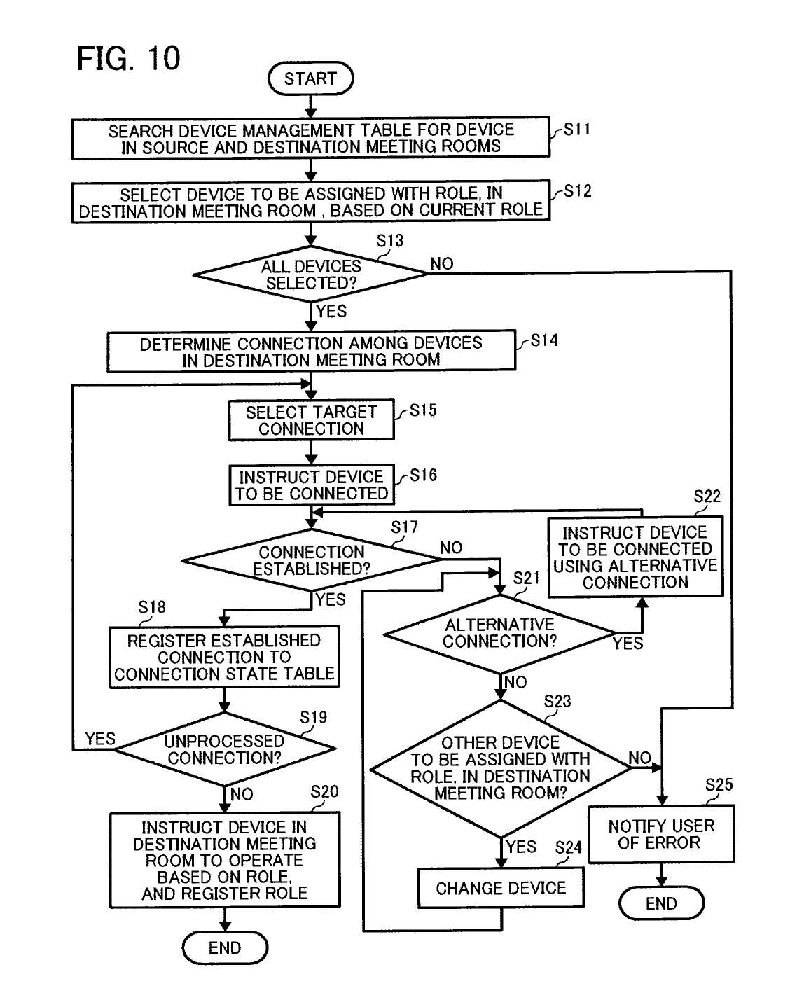

FIG. 10 is a flowchart illustrating operation of reproducing a meeting environment, performed by the management apparatus 10, according to an example embodiment of the present invention. The CPU 11 of the management apparatus 10 starts operation of FIG. 10 in response to detection of a reproduction request, which is generated based on user input to the reproduction request screen 400 of FIG. 9 and received at the reproduction request input 114 (CPU 11) of the management apparatus 10 through the communication I/F 15. In this example, the reproduction request includes information regarding the source meeting room and the destination meeting room.

At S11, the CPU 11 searches the device management table (FIG. 6) for a plurality of devices 30 in the source meeting room and a plurality of devices 30 in the destination meeting room. The source and destination meeting rooms are each identified by the meeting room ID, which is obtained from the meeting room table of FIG. 4 using the meeting room name that is obtained from the reproduction request.

At S12, the CPU 11 selects, for each one of the devices 30 in the source meeting room currently performing a specific role, a device to be assigned with that role from the devices 30 in the destination meeting room. More specifically, the CPU 11 refers to the “current role” field of the device management table (FIG. 6) to obtain the current role for each device in the source meeting room, and further refers to the “role that can be assigned” field of the device management table (FIG. 6) to select a device capable of performing the obtained current role from the devices in the destination meeting room. If a plurality of devices are available in the destination meeting room to perform the current role of the device in the source meeting room, the CPU 11 may select any device in the destination meeting room to assign the role, as long as the devices in the destination meeting room are selected to each correspond to the devices in the source meeting room. If the number of devices in the destination meeting room is greater than that of the devices in the source meeting room, there may be at least one device in the destination meeting room that remains unselected.

At S13, the CPU 11 determines whether all devices in the source meeting room have corresponding devices in the destination meeting room that are selected at S12 to perform the current roles needed for meeting currently held in the source meeting room. When it is determined that selection is not made for all devices in the source meeting room (“NO” at S13), the CPU 11 determines that the destination meeting room is not provided with the devices, which are necessary to reproduce a meeting environment of the source meeting room. The operation proceeds to S25 to notify the user of an error, and the operation ends.

When it is determined that selection is made for all devices in the source meeting room (“YES” at S13), the CPU 11 determines that the destination meeting room is provided with the devices that are necessary to reproduce a meeting environment of the source meeting room, and the operation proceeds to S14. The above-described operation of determining a role to be assigned to each device in the destination meeting room may be performed by the role determiner 115, which may be implemented by the CPU 11 that operates with the device management program.

At S14, the CPU 11 refers to the selection result at S12 and the connection state table (FIG. 8) to determine connections among the devices in the destination meeting room, based on connections among the devices in the source meeting room. More specifically, the CPU 11 obtains, for each connection established in the source meeting room, a connection source device and a connection destination device. Based on the selection result at S12 that indicates the correspondence between the device in the source meeting room and the device in the destination meeting room each assigned with the same role, the CPU 11 determines a connection source device in the destination meeting room, and a connection destination device in the destination meeting room, as devices to establish a connection. In this example, the communication function to be used for such connection between the devices may be preset, based on information obtained from the “used communication function” field of the connection state table (FIG. 8). In this manner, the CPU 11 is able to prepare for establishing a connection between a connection source device and a connection destination device, in the destination meeting room, to reproduce the connection state of the source meeting room.

Based on the connections to be established among the devices in the destination meeting room, which are determined at S14, the CPU 11 performs S15 to S19 and S21 to S24, for each of the connections to be established. This operation of controlling connections is performed by the connection state determiner 116 and the connection processor 117, which together control connections among the devices 30 in the destination meeting room to reproduce a meeting environment of the source meeting room onto the destination meeting room.

At S15, the CPU 11 selects a connection to be processed, as a target connection.

At S16, the CPU 11 instructs the devices 30 to be connected, i.e., the connection source device and the connection destination device, to establish connection using the communication function that is determined at S14. For example, the CPU 11 instructs the connection source device (the request device 30) to connect with the connection destination device (the counterpart device 30) using the determined communication function. Similarly, the CPU 11 instructs the connection destination device (the request device 30) to connect with the connection source device (the counterpart device 30) using the determined communication function. With such instruction, the CPU 11 may provide the request device 30 with information regarding an address of the counterpart device, service set identifier (SSID), or security information, etc., as needed.

In response to the instruction for connecting with the counterpart device 30, the connection state reproducer 313 of the request device 30 starts operation of establishing connection with the counterpart device 30. As long as the request device 30 and the counterpart device 30 are turned on, and the determined communication function is available to each of the devices 30 including availability of a cable to connect both devices 30 in case wired communication is selected, the request device 30 and the counterpart device 30 should be able to establish a connection. When any one of these conditions is not met, or due to the other reasons, the connection between the request device 30 and the counterpart device 30 may fail. In such case, the state notifier 312 of the request device 30 sends notification to the management apparatus 10, through the communication I/F 311, to indicate that connection fails. With this notification, the CPU 11 of the management apparatus 10 is able to know whether the connection is successfully established. In case any one of the devices to be connected is not turned on, the management apparatus 10 does not receive any notification from that device at least for a predetermined time period, and assumes that connection fails.

At S17, the CPU 11 of the management apparatus 10 determines whether the connection is successfully established between the devices as requested at S16. When it is determined that the connection is established (“YES” at S17), the CPU 11 registers connection state information indicating the established connection, to the connection state table, and ends operation of connecting for the target connection. More specifically, referring to FIG. 8, the CPU 11 registers the meeting ID, the connection source device ID, the connection destination device ID, and the used communication function in association with one another. The meeting ID is obtained from the reproduction request, which is the meeting ID selected by the user through the reproduction request screen 400.

Referring back to S17, when it is determined that connection is not successfully established (“NO” at S17), the operation proceeds to S21. At S21, the CPU 11 determines whether there is any alternative communication means, that is, an alternative communication function, to be used for establishing the connection between the devices. More specifically, the CPU 11 refers to the “connection means” fields in the device management table (FIG. 6), to search for one or more alternative communication functions to be used for the connection between the connection source device and the connection destination device. When there are one or more alternative communication functions that are not tried, it is determined that there is an alternative communication means (“YES” at S21), and the operation proceeds to S22.

At S22, the CPU 11 instructs the devices, i.e., the connection source device and the connection destination device, to establish a connection using the alternative communication function. In case more than one alternative communication function is available, the CPU 11 may select one at a time using any desired selection algorithm. For example, the CPU 11 may select a communication function in order, according to the order of lists in the “communication means” field. In another example, the CPU 11 may select a communication function that is wireless, before selecting wired communication that requires a cable connection. In another example, the CPU 11 may select a communication function in compatible with the communication standards with faster communication speeds.

After sending the instruction to the device 30, the operation proceeds to S17 to determine whether the connection is successfully established, as described above referring to S17. When it is determined that the connection is established (“YES” at S17), the operation proceeds to S18. Otherwise (“NO” at S17), the operation repeats S22.

When it is determined that there is no alternative communication function at S21 (“NO” at S21), the CPU 11 determines that connection cannot be established between the devices selected at S14 or re-selected at S22, and the operation proceeds to S23.

At S23, the CPU 11 determines whether there is any other device capable of performing the same role as that of the device to be connected, in the destination meeting room, for example, referring to the device management table (FIG. 6). In case there is more than one device, the CPU 11 selects one device, using any desired selection algorithm. In one example, the CPU 11 may select the device having the device type that is the same as the corresponding device in the source meeting room, or the device having more available functions. While the CPU 11 may try to replace both of the connection source device and the connection destination device, if the CPU 11 knows a specific device causing a connection failure, the CPU 11 searches for an alternative device to replace that specific device.

When it is determined that there is an alternative device (“YES” at S23), at S24, the CPU 11 changes the devices (at least one device) to be connected to establish the target connection, from those devices (at least one device) selected at S14 or previously selected at S24, to the devices selected at S23. The operation returns to S21 to search for a communication function to be used for establishing the connection between the devices, and proceeds to S22 to instruct the devices to connect using the selected communication function.

When the CPU 11 is not able to search for any alternative device corresponding to the device in the source meeting room (“NO” at S23), the CPU 11 determines that the destination meeting room is not provided with devices that are necessary to reproduce a meeting environment of the source meeting room, and the operation proceeds to S25 to notify an error.

Assuming that the connection is successfully established, at S19, the CPU 11 determines whether there is any connection to be established, which is not selected as a target connection for processing. When it is determined that there is a connection to be established (“YES” at S19), the operation proceeds to S15 to select another connection to repeat operation of instructing the device 30 to establish a connection.

When it is determined that there is no more connection to be established (“NO” at S19), the operation proceeds to S20. At S20, the CPU 11 instructs each one of the devices 30 in the destination meeting room, which are selected at S12 or changed at S24, to start operation based on the assigned role. The CPU 11 further registers information indicating the assigned role, to the “current role” field for each device in the destination meeting room, in the device management table.

Information regarding the connection state and the current role of each device in the source meeting room may be deleted, for example, in response to an instruction for ending the use of the source meeting room is accepted. Alternatively, the information regarding the connection state and the current role for the source meeting room may be deleted, in response to completion of the operation of FIG. 10.

As described above, the management apparatus 10 selects the devices 30 in the destination meeting room, which correspond to the devices 30 in the source meeting room, to carryout the functions that have been performed by the devices 30 in the source meeting room. The management apparatus 10 further connects the selected devices 30 in the destination meeting room, in a similar manner based on the connections among the devices 30 in the source meeting room, for example, using the same communication functions. With this configuration, the management apparatus 10 is able to reproduce a meeting environment of the source meeting room, onto the destination meeting room, even when the source meeting room and the destination meeting room are different in available devices.

Further, in case the devices in the destination meeting room cannot be connected using the same communication functions as those of the communication functions used by the devices in the source meeting room, the management apparatus 10 automatically tries with an alternative communication function. With this configuration, the management apparatus 10 is able to reproduce a meeting environment that is substantially similar to that of the source meeting room, onto the destination meeting room, without requiring further instruction from a user.

In the above-described example referring to FIG. 10, operation of controlling connections among the devices 30 are performed, one connection at a time. Alternatively, operation of controlling connections among the devices 30 may be concurrently performed for a plurality of connections.

At S16 of FIG. 10, when the CPU 11 can determine that a connection fails based on contents of the device management table, the CPU 11 does not have to perform S16, but performs S17 to determine that the connection fails referring to the device management table. For example, when any one of the devices to be connected does not have any communication function determined at S14, the CPU 11 can determine that connection fails and selects an alternative communication function.

In the following, several different scenarios will be described to illustrate the above-described operation of reproducing a meeting environment of the source meeting room onto the destination meeting room. In these scenarios, it is assumed that the user moves from the source meeting room A having the meeting room ID “MR100” to the destination meeting room B having the meeting room ID “MR101”, to continue a meeting. That is, the operation state and the connection state of the devices 30 in the meeting room A, will be reproduced by the corresponding devices 30 in the meeting room B. For the descriptive purposes, in the following, each device 30 will be referred to using its device ID. For example, the device 30 having the “projector” device type and the device ID “D100” will be referred to as the “D100” projector or the “D100” device.

(First Scenario: FIGS. 6, 8, 11, and 12)

The first scenario illustrates an example case in which a part of the devices in the meeting room B are not provided with the communication functions used by the devices in the meeting room A. More specifically, the management apparatus 10 stores the device management table of FIG. 6 and the connection state table of FIG. 8, at least at the time when the meeting is being held in the meeting room A. In response to a request for reproducing a meeting environment of the meeting room A onto the meeting room B, which may be input by the user through the reproduction request screen 400 of FIG. 9, the management apparatus 10 starts operation of FIG. 10.

At S11, the management apparatus 10 searches the device management table of FIG. 6, using the meeting room IDs of the source meeting room A and the destination meeting room B that are respectively obtained from the meeting room table of FIG. 4 using the meeting room names of the reproduction request. Specifically, in this example, the management apparatus 10 obtains the devices D100 to D103 in the source meeting room A having the meeting room ID “MR100”, and the devices D104 to D107 in the destination meeting room B having the meeting room ID “MR101”, from the device management table of FIG. 6.

At S12, the management apparatus 10 searches the device having the role “contents projection” from the devices D104 to D107 in the destination meeting room, which corresponds to the projector D100 having the current role “contents projection” in the source meeting room. Referring to FIG. 6, the management apparatus 10 determines to assign the “contents projection” role to the D104 projector, as the D104 projector is only the device in the destination meeting room having such function.

For the device corresponding to the whiteboard D101, there are two devices in the destination meeting room, specifically, the whiteboard D105 and the PC D107, which can have the “store/edit minute” role. While any one of the whiteboard D105 and the PC D107 may be selected, in this example, the management apparatus 10 selects the whiteboard D105 having a device type that is the same as that of the whiteboard D101 in the source meeting room.

Similarly, the management apparatus 10 selects the conference system D106 in the destination meeting room to perform the “remote communication”, currently performed by the conference system D102 in the source meeting room. The management apparatus 10 selects the PC D107 in the destination meeting to perform the “contents provider/manage meeting” role, currently performed by the PC D103 in the source meeting room.

In case one device 30 is performing a plurality of roles, such as in the case of PC D103 in the source meeting room, such functions may be performed by more than one device 30 in the destination meeting room. In order to reproduce the meeting environment of the source meeting room, it is, however, desirable to select one device 30 capable of performing the plurality of roles, currently performed by one device 30 in the source meeting room.

At S13, the management apparatus 10 determines that all devices in the destination meeting room are selected at S12 to perform the current roles performed by devices in the source meeting room (“YES” at S13), and the operation proceeds to S14.

At S14, based on the selection result of S12, the management apparatus 10 determines connections among the devices in the destination meeting room, so as to correspond to connections of the devices in the source meeting room as registered to the connection state table of FIG. 8. More specifically, referring to FIG. 8, the device ID of the connection source device, which is the device in the source meeting room, is replaced with the device ID of the corresponding device in the destination meeting room. Similarly, the device ID of the connection destination device, which is the device in the source meeting room, is replaced with the device ID of the corresponding device in the destination meeting room. The selection result of S12 indicates that the devices D100 to D103 in the source meeting room correspond to the devices D104 to D107 in the destination meeting room, respectively. Based on this selection result, in FIG. 8, the management apparatus 10 determines that connections are to be established, between the device D107 and the device D104 through a wireless LAN, and between the device D106 and the device D105 through a wireless LAN.

The management apparatus 10 performs operation of controlling the devices 30 in the destination meeting room to establish these connections.

For the connection between the device D107 and the device D104 through the wireless LAN, connection fails as the projector D104 does not have the “wireless LAN” communication function. The management apparatus 10 refers to the device management table of FIG. 6 to search for an alternative communication function, to obtain the communication function “wired LAN” that is common to the devices D107 and D104. At S22, the management apparatus 10 instructs the devices D107 and D104 to establish connection through the wired LAN.

For the connection between the device D105 and the device D105 through the wireless LAN, connection is successfully established, as these devices both have the wireless LAN communication function.

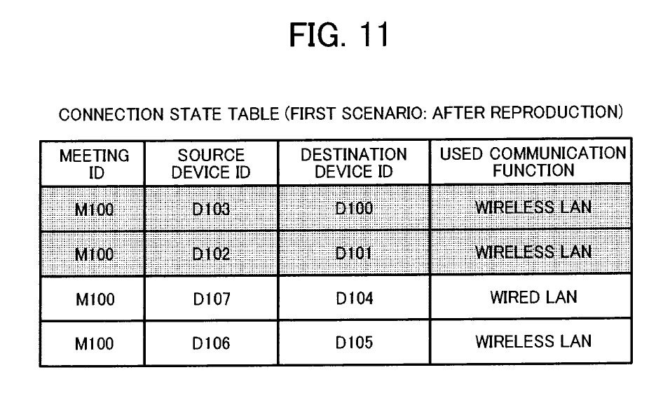

At S18, the management apparatus 10 registers the connection state of these devices to indicate the established connections, to the connection state table of FIG. 8. FIG. 11 illustrates the connection state table, after registering the connection state information indicating the newly established connections among the devices in the destination meeting room. In FIG. 11, the hatched portion of the table corresponds to information indicating the connection state information of the source meeting room. The management apparatus 10 may delete data of the hatched portion, after confirming that the user ends to use the source meeting room.

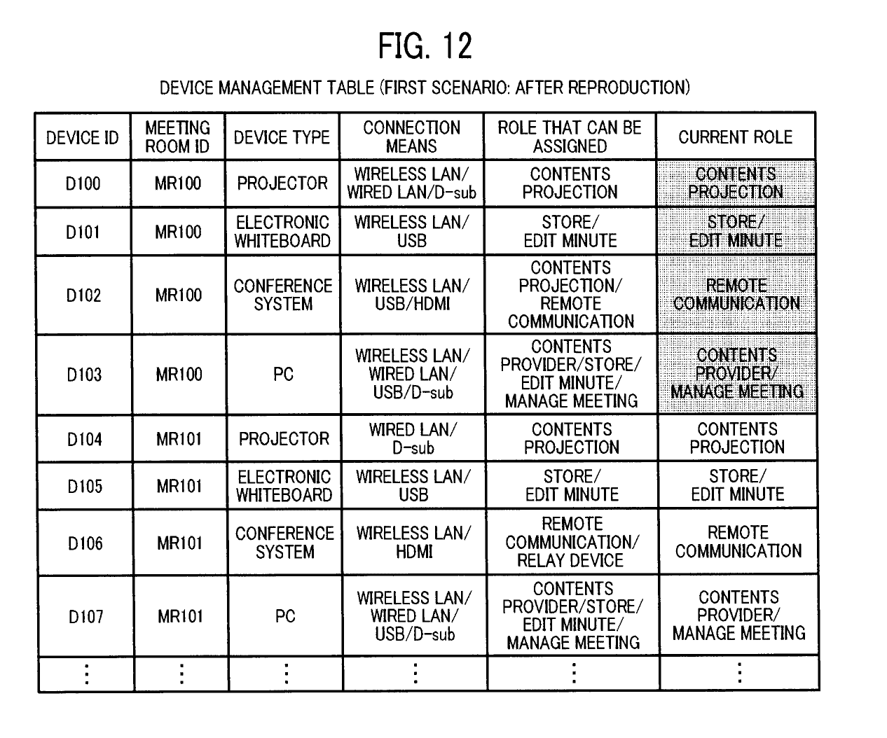

At S20, the management apparatus 10 registers information indicating the current role, which is assigned to each one of the devices D104 to D107 in the destination meeting room that are determined at S12. FIG. 12 illustrates the device management table, after registering the operation state information indicating the current role being assigned to each of the devices D104 to D107 in the destination meeting room. In FIG. 12, the hatched portion of the table corresponds to information indicating the current role assigned to each device in the source meeting room. The management apparatus 10 may delete data of the hatched portion, after confirming that the user ends to use the source meeting room.

As described above, the management apparatus 10 assigns the roles, which are currently performed by the devices in the source meeting room A having the meeting room ID “MR100”, to the devices in the destination meeting room B having the meeting room ID “MR101”. The management apparatus 10 further requests the devices in the destination meeting room B to establish connections, based on the connections established among the devices in the source meeting room A. In this manner, the management apparatus 10 automatically reproduces a meeting environment of the source meeting room, onto the destination meeting room. It is to be noted that, in case a LAN cable is disconnected, or the power of the device is not turned on, the user needs to connect the cable or turn on the power of the device.

Further, the meeting environment to be reproduced onto the destination meeting room may not always be the same as the meeting environment of the source meeting room.

For example, in case there is no device in the destination meeting room having the same communication function as that of the communication function provided by the corresponding device in the source meeting room, the management apparatus 10 automatically changes a communication function of the device. Specifically, in the above-described example scenario, while the projector and the PC in the source meeting room A are connected via a wireless LAN, the projector D104 and the PC D107 in the destination meeting room B are connected via a wired LAN, as the projector D104 is not provided with the wireless LAN communication function.

Through performing operation of FIG. 10, even when devices differ between the source meeting room and the destination meeting room, the management apparatus 10 is able to determine the operation state and the connection state of each device in the destination meeting room to reproduce substantially the same environment as that of the source meeting room. Even when the meeting room is changed from the source meeting room to the destination meeting room, the user does not have to change settings of each device in the destination meeting room such that the user is able to continue discussions more smoothly under substantially the same environment.

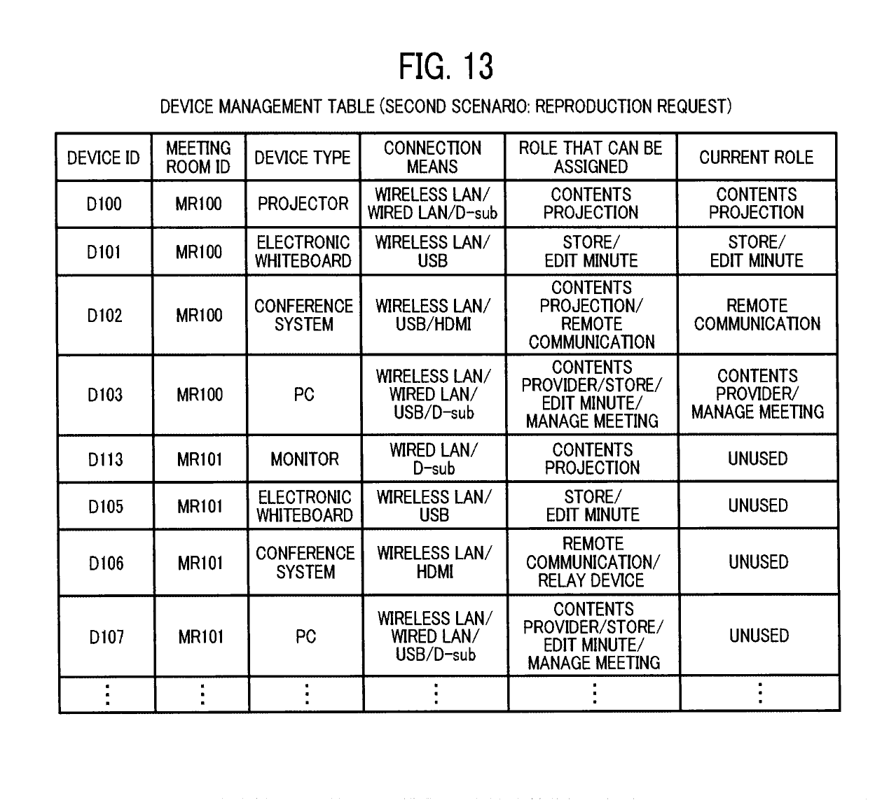

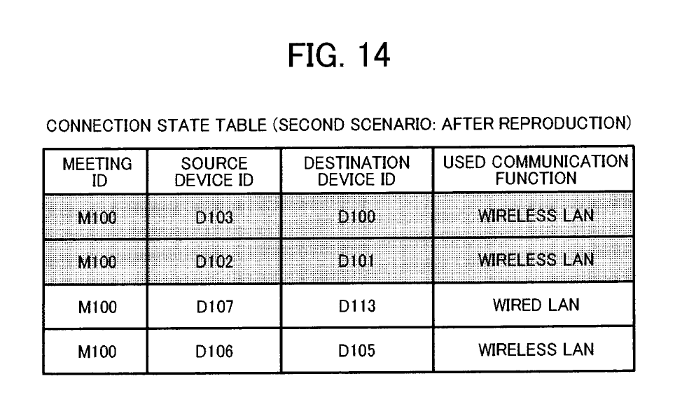

(Second Scenario: FIGS. 13 and 14)

The second scenario of FIGS. 13 and 14 illustrates an example case in which a part of the devices in the meeting room B (destination meeting room) differ in device type than the devices in the meeting room A (source meeting room). In this scenario, the management apparatus 10 stores the device management table of FIG. 13 and the connection state table of FIG. 8, at least at the time when the meeting is being held in the meeting room A. Further, in this example, the monitor D113 is provided in the meeting room B having the meeting room ID “MR101”, in replace of the D104 projector in the first scenario.

In operation of FIG. 10, the management apparatus 10 determines the devices D105 to D107 in the destination meeting room B to have the roles currently assigned to the devices D101 to D103 in the source meeting room, as described above in the first scenario. The monitor D113 in the destination meeting room is selected to correspond to the projector D100 in the source meeting room, since the monitor D113 is only the device having the “contents projection” role in the destination meeting room.

At S14, based on the selection result of S12, the management apparatus 10 determines connections among the devices in the destination meeting room, so as to correspond to connections of the devices in the source meeting room as registered to the connection state table of FIG. 8. More specifically, based on the selection result of S12, in FIG. 8, the management apparatus 10 determines that connections are to be established, between the device 107 and the device D113 through a wireless LAN, and between the device D106 and the device D105 through a wireless LAN.

The management apparatus 10 performs operation of controlling the devices 30 in the destination meeting room to establish these connections.

For the connection between the device D107 and the device D113 through the wireless LAN, since the monitor D113 is not provided with the wireless LAN communication function, the management apparatus 10 refers to the device management table of FIG. 13 to search for an alternative communication function to obtain the communication function “wired LAN” that is common to the devices D107 and D113. At S22, the management apparatus 10 instructs the devices D107 and D113 to establish connection through the wired LAN.

For the connection between the device D106 and the device D105 through the wireless LAN, connection is successfully established, as these devices both have the wireless LAN communication function.

At S18, the management apparatus 10 registers the connection state of these devices to indicate the established connections, to the connection state table of FIG. 8. FIG. 14 illustrates the connection state table, after registering the connection state information indicating the newly established connections among the devices in the destination meeting room. The management apparatus 10 may delete data of the hatched portion, corresponding to information indicating the connection state information of the source meeting room, after confirming that the user ends to use the source meeting room.

At S20, the management apparatus 10 registers information indicating the current role, which is assigned to each one of the devices D113, and D105 to D107 in the destination meeting room that are determined at S12.

As described above, even when the device types differ between the devices in the source meeting room and the devices in the destination meeting room, the management apparatus 10 is able to control role assignment and connections of the devices in the destination meeting room so as to reproduce a meeting environment of the source meeting room.

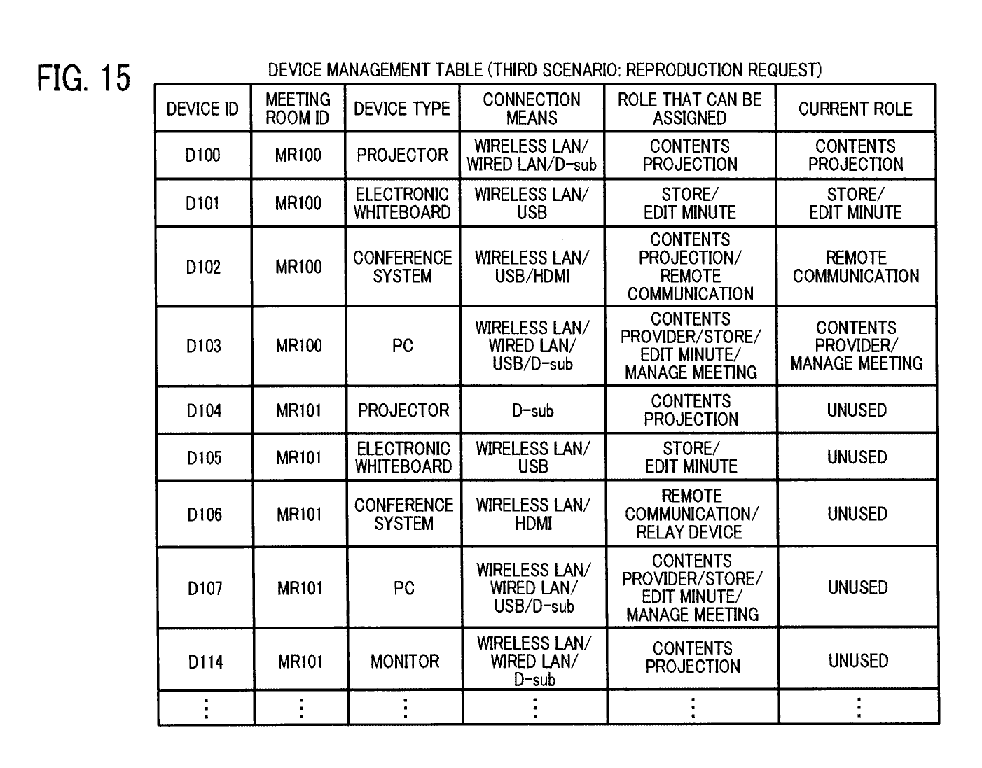

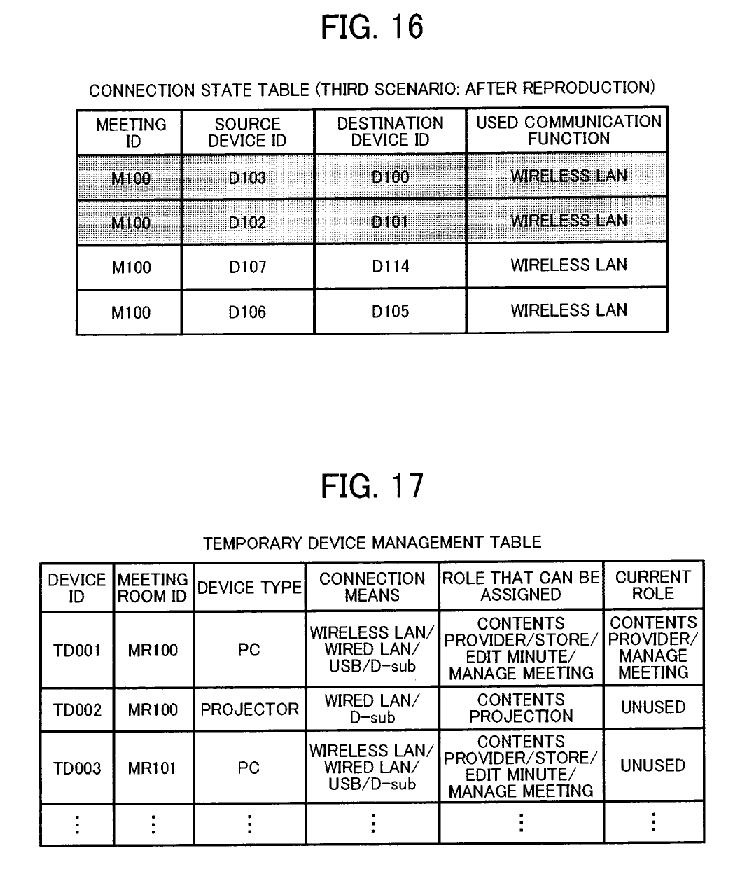

(Third Scenario: FIGS. 15 and 16)

The third scenario of FIGS. 15 and 16 illustrates an example case in which there is a device in the destination meeting room, which is not capable of connecting with another device in the destination meeting room, even with an alternative communication function. In this scenario, the management apparatus 10 stores the device management table of FIG. 15 and the connection state table of FIG. 8, at least at the time when the meeting is being held in the meeting room A. The third scenario is substantially the same as the first scenario, except for some differences. The differences include that the projector D104 provided in the meeting room B having the meeting room ID “MR101” is capable of communicating only using the “D-Sub” communication function, the PC D107 is not compatible with the “D-sub” communication function, and the D114 monitor is provided in replace of the projector D104 in the first scenario.

In operation of FIG. 10, the management apparatus 10 determines the devices D105 to D107 in the destination meeting room B to have the roles currently assigned to the devices D101 to D103 in the source meeting room, as described in the first scenario. While any one of the projector D104 and the monitor D114 can be selected to perform the “contents projection” role of the projector D100, the management apparatus 10 determines to select the projector 104 having the same device type as that of the projector D100.

At S14, based on the selection result of S12, the management apparatus 10 determines connections among the devices in the destination meeting room, so as to correspond to connections of the devices in the source meeting room as registered to the connection state table of FIG. 8. More specifically, based on the selection result of S12, in FIG. 8, the management apparatus 10 determines that connections are to be established, between the device 107 and the device D104 through a wireless LAN, and between the device D106 and the device D105 through a wireless LAN.

The management apparatus 10 performs operation of controlling the devices 30 in the destination meeting room to establish these connections.

For the connection between the device D107 and the device D104 through the wireless LAN, since the projector D104 is not provided with the wireless LAN communication function, the management apparatus 10 refers to the device management table of FIG. 15 to search for an alternative communication function, which is common to the devices D107 and D104. Since there is no communication function common to both devices, at S21, the management apparatus 10 determines that there is no alternative communication function and proceeds to S23.

At S23, the management apparatus 10 searches for a device capable of performing the “contents projection” role of the device D100, and selects the monitor D114 as the device to be assigned with the “contents projection” role. At S24, the management apparatus 10 changes the device to be connected with the D107 device, from the projector D104 to the monitor D114.

At S21, the management apparatus 10 searches for a communication function that is common to the PC 107 and the monitor D114 to obtain the wireless LAN communication function. In case there is more than one communication function that is common, the management apparatus 10 may select a communication function, using any desired selection algorithm. In this example, in order to reproduce the communication state similar to that of the source meeting room, the wireless LAN is selected.

At S22, the management apparatus 10 instructs the devices D107 and D114 to establish a connection through the wireless LAN.

For the connection between the device D106 and the device D105 through the wireless LAN, connection is successfully established, as these devices both have the wireless LAN communication function.

At S18, the management apparatus 10 registers the connection state of these devices to indicate the established connections, to the connection state table of FIG. 8. FIG. 16 illustrates the connection state table, after registering the connection state information indicating the newly established connections among the devices in the destination meeting room. The management apparatus 10 may delete data of the hatched portion, corresponding to information indicating the connection state information of the source meeting room, after confirming that the user ends to use the source meeting room.

At S20, the management apparatus 10 registers information indicating the current role, which is assigned to each one of the devices D114, and D105 to D107 in the destination meeting room that are determined at S12.

As described above, even when there is a device not capable of connecting with a specific device as instructed by the management apparatus 10, the management apparatus 10 is able to control role assignment and connections of the devices in the destination meeting room so as to reproduce a meeting environment of the source meeting room.

The above-described apparatus, system, method, and program stored on a recording medium, each of which is capable of reproducing a meeting environment may be implemented in various ways other than the embodiment described referring to FIGS. 1 to 16. For the descriptive purposes, several modified examples are described below.

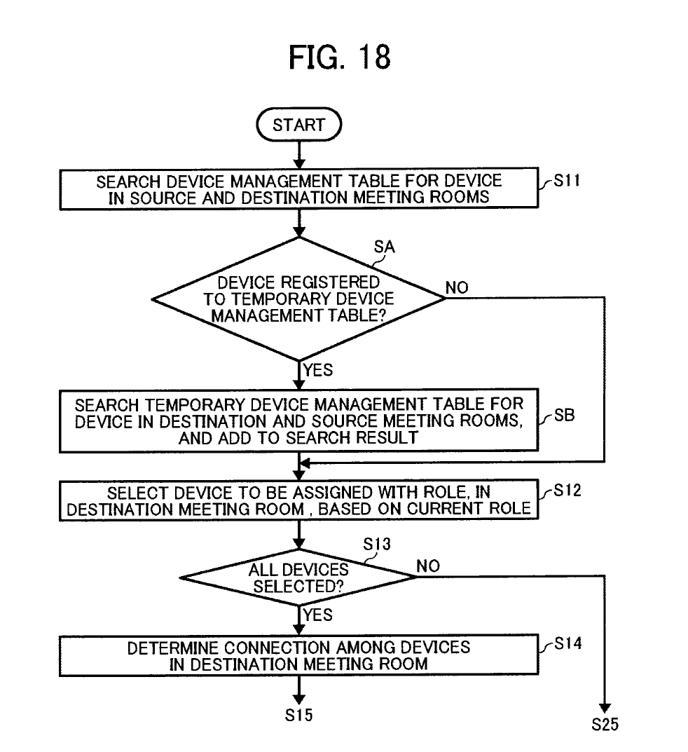

(Modified Example: FIGS. 17 and 18)

Referring now to FIGS. 17 and 18, a modified example is explained. In this embodiment of FIGS. 17 and 18, the management apparatus 10 operates in a substantially similar manner as described above referring to FIGS. 1 to 16, except for some differences. The differences include additionally managing a temporary device, which is temporarily brought into the meeting room for use, as a device to be managed by the management apparatus 10.

In some cases, the user, who is a meeting participant, may bring in any device (“temporary device”) to the meeting room to use such device, while connecting with the other devices provided in the meeting room. When the meeting ends, the user leaves the meeting room with such device. In this embodiment, the management apparatus 10 manages temporary devices, using a temporary device management table of FIG. 17, in addition to the devices provided in the meeting room.

The temporary device management table of FIG. 17 stores, for each temporary device, a device ID, meeting room ID, device type, connection means, role that can be assigned, and current role.

The device ID is identification information that identifies a temporary device, which is temporarily assigned to the temporary device when the temporary device is registered to the temporary device management table of FIG. 17. In one example, the device ID may be randomly assigned to the temporary device, such that the same device may be assigned with a different ID every time the device is brought into the meeting room for management by the management apparatus 10. Alternatively, the temporary device may be assigned with a device ID unique to the temporary device, such that the same device ID is assigned to a specific device every time the device is brought into the meeting room for management by the management apparatus 10.

The management apparatus 10 may manage contents of the temporary device management table of FIG. 17, in a substantially similar manner as described above in the example case of managing the device management table. More specifically, the management apparatus 10 registers information regarding the temporary device, when the management apparatus 10 detects a new device in a meeting room, which is not registered to the temporary device management table. For example, the management apparatus 10 detects the new device, when connection to the relay device in a meeting room from the temporary device is detected, when the device in a meeting room accesses the management apparatus 10, or when the device in a meeting room notifies the management apparatus 10 of its entry into the meeting room. Alternatively, if the temporary device has location information, the temporary device may automatically access the management apparatus 10 to notify its presence in the meeting room when the device detects that the device is brought into the meeting room.

When the new device, which is located in the meeting room, is detected, the management apparatus 10 obtains information regarding the device such as the device type, the communication function, the role that can be assigned, etc., to register such information in the temporary device management table. The temporary device may send such information regarding the device to the management apparatus 10, either automatically, or in response to an inquiry from the management apparatus 10. In either case, the temporary device is assumed to be provided with a function allowing management by the management apparatus 10, such as the state notifier 312 or the connection state reproducer 313 (FIG. 3). The management apparatus 10 determines whether the temporary device, which requests for registration, is allowed for management by the management apparatus 10, based on the information regarding the device such as the device type. For example, for the first time the temporary device accesses the management apparatus 10, the device management program may be downloaded onto the temporary device to be managed by the management apparatus 10.

The management apparatus 10 deletes information regarding the temporary device, from the temporary device management table, when the temporary device becomes undetectable in the meeting room that is associated with the device ID, or when a request for deleting information regarding the temporary device is received from the user. Preferably, the management apparatus 10 deletes information regarding the temporary device, when a predetermined time period elapses after the temporary device becomes undetectable or when such request is received. In this manner, the management apparatus 10 is able to use information regarding the temporary device to reproduce a meeting environment, even after the user moves the temporary device from the source meeting room to the destination meeting room.

The management apparatus 10, which additionally manages the temporary device, performs operation of reproducing a meeting environment, in a substantially similar manner as described above referring to FIG. 10 with some differences as illustrated in FIG. 18. More specifically, the management apparatus 10 additionally performs steps SA and SB between S11 and S12 of FIG. 10.

At SA, the CPU 11 determines whether the temporary device management table (FIG. 17) is registered with a temporary device. When it is determined that the temporary device is registered (“YES” at SA), the operation proceeds to SB. When it is determined that the temporary device is not registered (“NO” at SA), the operation proceeds to S12.

At SB, the CPU 11 searches the temporary device management table (FIG. 17) for a device in the source meeting room and a device in the destination meeting room, and adds a search result to the search result obtained at S11.

Assuming that the temporary device in the source meeting room is assigned with a role, at S13, the management apparatus 10 selects a device in the destination meeting room capable of performing the role of the temporary device. The temporary device, which is added as a device in the destination meeting room, will be subject for selection in addition to the device located in the meeting room. For this reasons, there is no need to make distinction between the temporary device and the device located in the meeting room.

As described above, the management apparatus 10 is able to reproduce a meeting environment of the source meeting room onto the destination meeting room, while considering the use of a device that may be brought into the meeting room by a user.

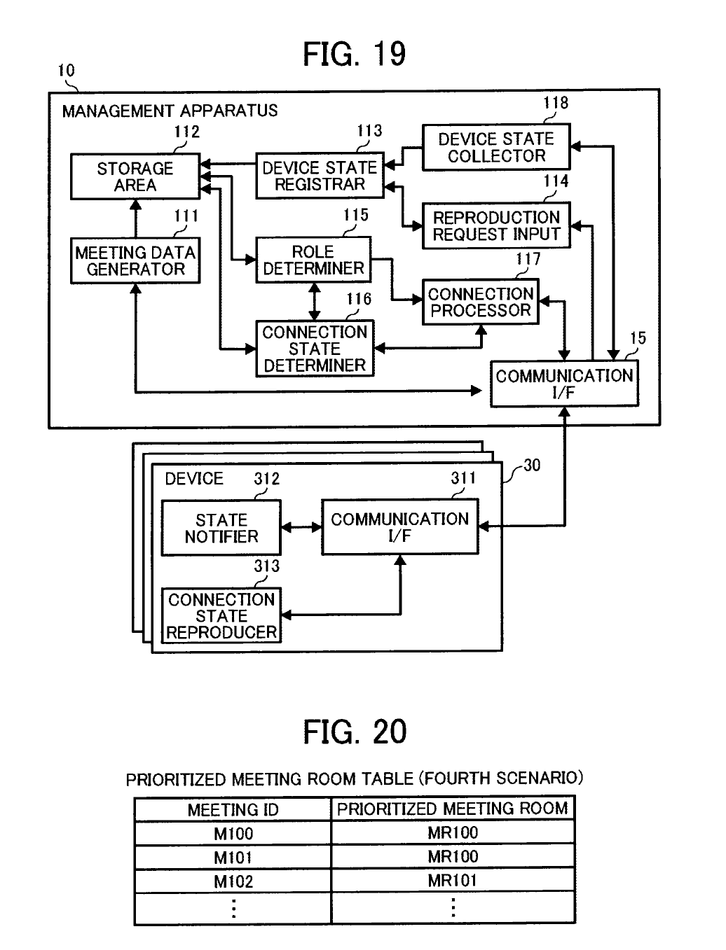

(Modified Example: FIG. 19)

Referring to FIG. 19, a modified example is explained. In this embodiment of FIG. 19, the management apparatus 10 operates in a substantially similar manner as described above referring to FIGS. 1 to 16, except for some differences. The differences include additionally collecting connection state information of each device through accessing the device 30.

FIG. 19 illustrates a functional structure of the management apparatus 10, and the device 30 to be managed by the management apparatus 10, of the device management system of FIG. 1 according to this embodiment. The management apparatus 10 of FIG. 19 is substantially similar to the management apparatus 10 of FIG. 3, except for the addition of a device state collector 118.

The device state collector 118 accesses each device 30 subjected for management, periodically (such as every Sunday or any day previously set) or any desired time (such as when the meeting begins), to obtain the operation state information and the connection state information of the device 30. The device state collector 118 sends the operation state information and the connection state information of each device 30 to the device state registrar 113. The device state registrar 113 registers the received operation state information to the device management table, and the received connection state information to the connection state table.

If the number of devices 30 to be managed by the management apparatus 10 increases, processing notification regarding the operation state and the connection state from each device 30 becomes complicated, while causing the increase in network traffic. In view of this, the management apparatus 10 may be programmed to access each device 30 to collect information, in a manner so as to reduce the processing load or the load on network.

For example, the management apparatus 10 may access the relay device 20 to instruct the relay device 20 to collect information regarding the devices 30 and send such information at once to the management apparatus 10. This reduces a number of communication packets, thus reducing the processing load and the load on network.

(Modified Example: FIGS. 20 to 25)

Referring now to FIGS. 20 to 25, a modified example is explained. In this embodiment of FIGS. 20 to 25, the management apparatus 10 operates in a substantially similar manner as described above referring to FIGS. 1 to 16, except for some differences. The differences include additionally setting a priority to a connection state in a meeting room for each meeting.

In this embodiment illustrated in FIGS. 20 to 25, the user may change the meeting room more than once, such as by moving from the meeting room A to the meeting room B, and from the meeting room B to the meeting room C. In some cases, due to the difference in device provided in each meeting room, the connections among the devices in the meeting room B cannot be exactly the same as the connections among the devices in the meeting room A, but the connections among the devices in the meeting room C can be exactly the same as the connections among the devices in the meeting room A. For example, in the first scenario of the above-described embodiment, in the meeting room B, the PC D107 and the projector D104 are connected through the wired LAN, as the projector D104 is not provided with the wireless LAN communication function. Even in such case, the meeting room C may have the projector having the “contents projection” role, which can be connected to the PC through the wireless LAN, to reproduce a connection state of the devices in the meeting room A more closely.

In the above-described case, when moving from the meeting room B to the meeting room C, the management apparatus 10 tries to reproduce the meeting environment of the meeting room B, onto the meeting room C. In such case, even when the meeting room C is capable of reproducing the meeting environment of the meeting room A more closely, the meeting environment is reproduced onto the meeting room C while reflecting the meeting environment reproduced by the meeting room B. In view of this, in some cases, it may be more preferable to set priority to a connection state of a meeting room, such that a meeting environment is reproduced based on the prioritized connection state of the meeting room.

FIG. 20 illustrates an example data structure of a prioritized meeting room table, which may be stored in the storage area 112. The prioritized meeting room table of FIG. 20 stores a meeting ID and a prioritized meeting room in association with each other. The meeting ID is one example of identification information that identifies a meeting. The prioritized meeting room indicates a source meeting room to be used in priority to refer to, in case the meeting environment is to be reproduced in a destination meeting room based on the source meeting room.

The management apparatus 10 may register information to the prioritized meeting room table of FIG. 20, preferably at the time when registering information to the meeting data table of FIG. 5. Alternatively, the prioritized meeting room table may be set such that the meeting room in which the meeting is to be firstly held is preset as the prioritized meeting room. In another example, the prioritized meeting room may be changed at any desired time, according to a user instruction. In another example, the prioritized meeting room may not be registered. The operation of managing the prioritized meeting room table may be performed by the CPU 11.

As described above, when the prioritized meeting room is set, a source meeting room is not always a meeting room in which a meeting is being held, or a meeting room from which the user leaves for a destination meeting room. If a different meeting is taking place in the source meeting room after the user moves out from the source meeting room, which is set as the prioritized meeting room, the operation state information and the connection state information to be referred to by the management apparatus 10 to reproduce a meeting environment may have been deleted from the device management table and the connection state table, before a request for reproducing is sent to the management apparatus 10.

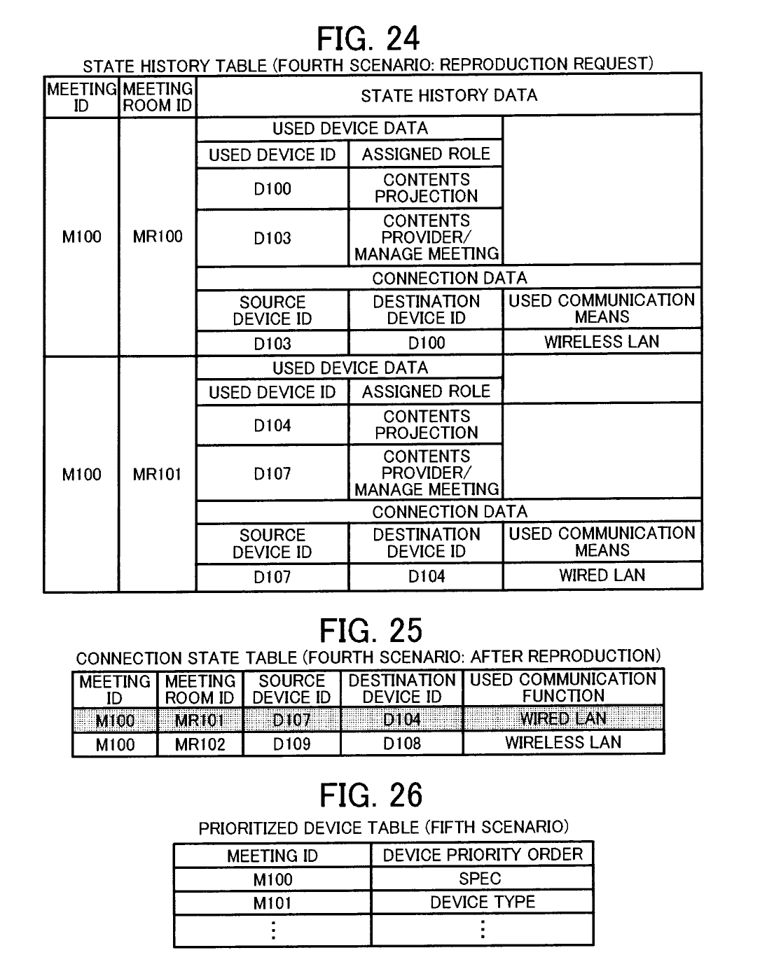

In view of this, the management apparatus 10 registers the operation state information regarding the devices in the meeting that is previously held in the source meeting room, to a state history table of FIG. 24. The state history table of FIG. 24 stores, for each meeting and a meeting room in which the meeting is being held, devices used in that meeting, roles assigned to these devices, and connection state information indicating connections among the devices.

The meeting ID is one example of identification information that identifies a meeting. The meeting room ID is one example of identification information that identifies a meeting room, which may also be used to identify the meeting.

The used device data includes, for each device used in the meeting, a device ID, and an assigned role that is assigned to the device. The used device data may be copied from the “device ID” and “current role” fields of the device management table. If the “current role” field of the device is “UNUSED” in the device management table, such device does not have to be registered to the state history table of FIG. 24.

The connection data includes the connection source device ID, the connection destination device ID, and the used communication means, which may be copied from the fields of the connection state table.

The CPU 11 of the management apparatus 10 registers the above-described information to the state history table, as a part of usage information. The other examples of usage information include information regarding a role assigned to each device that is stored in the device management table, and the connection state information indicating a connection of each device.

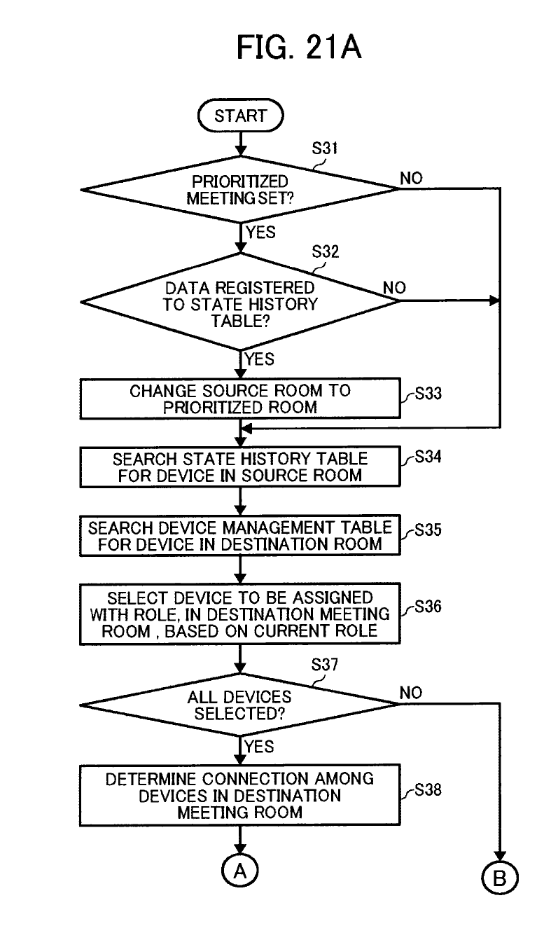

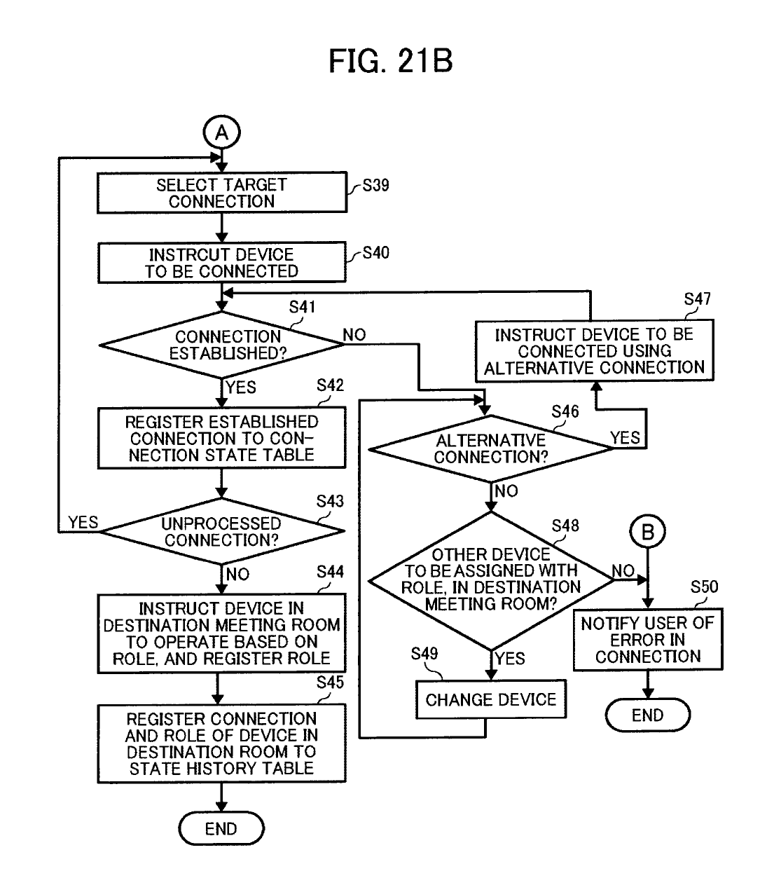

FIGS. 21A and 21B illustrate operation of reproducing a meeting environment, performed by the CPU 11 of the management apparatus 10, according to an example embodiment of the present invention.

The management apparatus 10 receives a reproduction request for reproducing a meeting environment of a source meeting room onto a destination meeting room, which is input through the reproduction request screen 400 of FIG. 9, as described above referring to FIG. 10. In this example, the user selects the meeting room A as the source meeting room, and the meeting room B as the destination meeting room, when moving from the meeting room A to the meeting room B. The user selects the meeting room B as the source meeting room, and the meeting room C as the destination meeting room, when moving from the meeting room B to the meeting room C.

Referring to FIG. 21, at S31, the CPU 11 of the management apparatus 10 refers to the prioritized meeting room table of FIG. 20 to determine whether any prioritized meeting room is set as the source meeting room to be used. When the prioritized meeting room is set (“YES”), the operation proceeds to S32. Otherwise (“NO”), the operation proceeds to S34.

At S32, the CPU 11 refers to the state history table of FIG. 24 to determine whether information regarding the prioritized meeting room is stored. When information regarding the prioritized meeting room is stored (“YES”), the operation proceeds to S33. Otherwise (“NO”), the operation proceeds to S34.

At S33, the CPU 11 determines that information regarding the prioritized meeting room is available, and changes the source meeting room from the meeting room specified through the reproduction request screen 400 to the prioritized meeting room that is registered to the prioritized meeting room table.

At S34, the CPU 11 searches the state history table for devices in the source meeting room. In case the source meeting room is changed from the meeting room specified by the reproduction request (that is, the meeting room in which the meeting is currently held), to the prioritized meeting room, the subjected source meeting room is the prioritized meeting room.

At S35, the CPU 11 searches the device management table for devices in the destination meeting room. S34 and S35 in FIG. 21A corresponds to S11 of searching for devices in the source meeting room and the destination meeting room.

S36 to S44 and S46 to S50 are performed in a substantially similar manner as described above referring to S12 to S20 and S21 to S25 of FIG. 10, except that information regarding the source meeting room is obtained from the state history table.

Further, at S45 of FIG. 21B, the CPU 11 registers information regarding the destination meeting room, such as the connection state and the current role of each device, to the state history table as history data of the source meeting room.

As described above, in this embodiment, the management apparatus 10 reproduces a meeting environment of a source meeting room, which is set in priority for that meeting, onto a destination meeting room. By setting a most desirable meeting environment, such as a meeting room that can provide the most desirable connections among devices as a prioritized meeting room, the management apparatus 10 can refer to such information every time the user requests to reproduce a meeting environment. With this configuration, even when the user moves from a meeting room in which the most desirable meeting environment cannot be reproduced, the management apparatus 10 can try to reproduce a meeting environment of the prioritized meeting room onto a destination meeting room, thus providing the most desirable meeting environment as long as the destination meeting room is capable of providing such meeting environment.

In the above-described embodiment, only one meeting room is set as a prioritized meeting room. Alternatively, a plurality of meeting rooms may be set as a prioritized meeting room, each of the meeting rooms being assigned with a priority order. The management apparatus 10 refers to the prioritized meeting room in priority order.

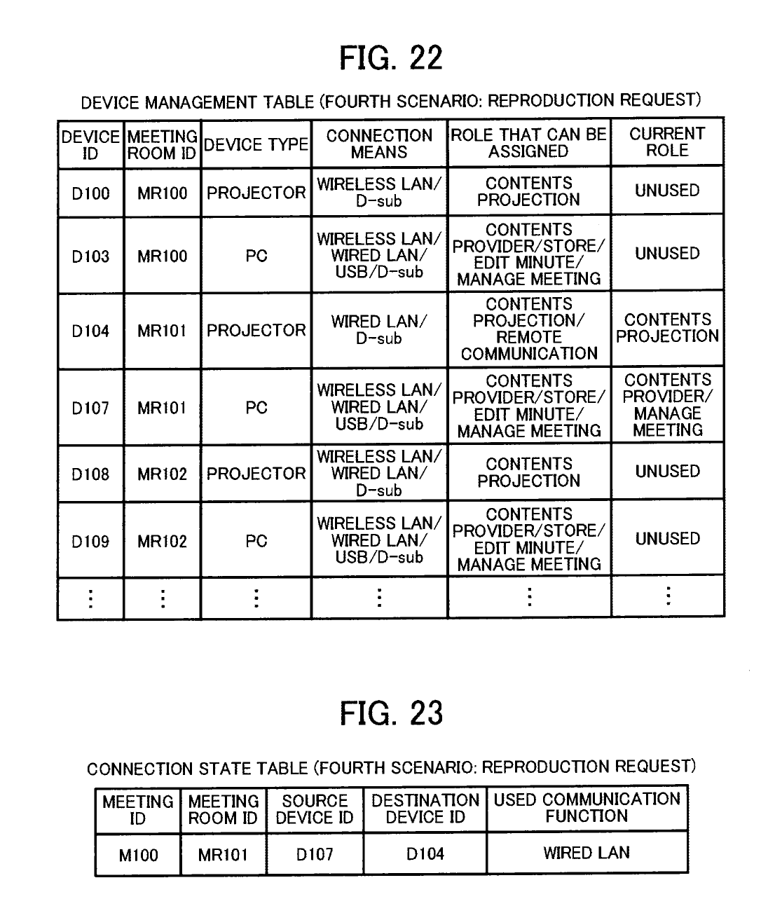

Next, example operation of reproducing a meeting environment is explained, according to a fourth scenario. In this scenario, the management apparatus 10 stores the prioritized meeting room table of FIG. 20, the device management table of FIG. 22, the connection state table of FIG. 23, and the state history table of FIG. 24 in any desired memory. Further, in this example, the meeting having the meeting ID “M100” is held on the meeting room A having the meeting room ID “MR100”, and the user moves from the meeting room A to the meeting room B having the meeting room ID “MR101”. Further, the user moves from the meeting room B to the meeting room C having the meeting room ID “MR102”.

The CPU 11 refers to the prioritized meeting room table of FIG. 20 to determine that the meeting room “MR100” is set as the prioritized meeting room for the meeting “M100”. The CPU 11 further refers to the state history table of FIG. 24 to determine that information regarding the prioritized meeting room “MR100” is stored. The CPU 11 changes the source meeting room, from the meeting room “MR101” to the prioritized meeting room “MR100”.

The CPU 11 further refers to the device management table of FIG. 22 to obtain devices in the destination meeting room “MR102”. Based on the state history data for the meeting ID “M100” and the meeting room ID “MR100”, the CPU 11 assigns the roles to the devices in the meeting room “MR102”, and instructs the devices in the meeting room “MR102” to establish connections that are determined based on the state history data for the meeting room “MR100”.

More specifically, in this example, the CPU 11 assigns the “contents provider/manage meeting” role of the device D103, to the PC D109. The CPU 11 further assigns the “contents projection” role of the device D100, to the projector D108. The CPU 11 instructs the devices 109 and 108 to establish a connection through the wireless LAN, as indicated by the connection data obtained from the state history table of FIG. 24. Since the devices 109 and 108 are both compatible with the wireless LAN, the connection is established. Accordingly, the management apparatus 10 registers the connection state information regarding the meeting room “MR102” to the connection state table, as illustrated in FIG. 25.

If the prioritized meeting room is not set in the above-described example, the management apparatus 10 refers to the connection state information of the meeting room B “MR101”, and instructs the devices D107 and D104 to connect through a wired LAN. In this example, when moving from the meeting room A to the meeting room B, the connection state has changed, as the projector D104 in the meeting room B is not provided with the wireless LAN communication function (See FIG. 22). This information regarding the connection state of the devices in the meeting room B is registered to the connection state table of FIG. 25.

In the meeting room C “MR102”, the devices 109 and 108 may be connected through the wired LAN, as both devices are provided with the wired LAN communication function. However, it may be desirable to connect via a wireless LAN, as there is no need to look for cables or connect with cables, or relocate devices in case the cable is not connected. By setting the meeting room A as a prioritized meeting room, the management apparatus 10 is able to refer to a meeting environment, such as connections among devices in the meeting room A, to reproduce a meeting environment that is desirable to at least the user participating in the meeting.

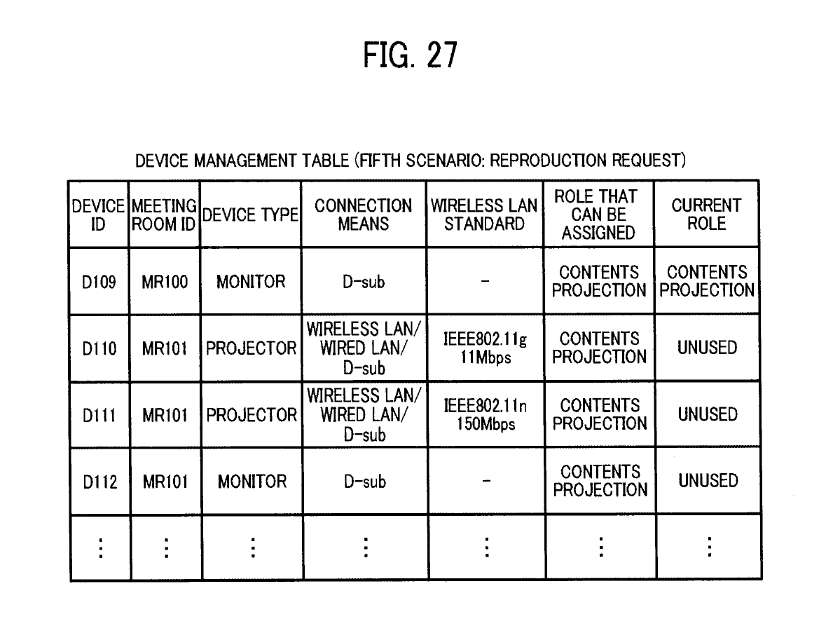

(Modified Example: FIGS. 26 and 27)

Referring now to FIGS. 26 and 27, a modified example is explained. In this embodiment of FIGS. 26 and 27, the management apparatus 10 operates in a substantially similar manner as described above referring to FIGS. 1 to 16, except for some differences. The differences include additionally setting a rule to select devices to be used at S12 of FIG. 10.

In this example, the management apparatus 10 stores a prioritized device table of FIG. 26, which defines, for each meeting, a device selection rule for selecting devices in a destination meeting room to perform specific roles of devices in a source meeting room.

The prioritized device management table of FIG. 26 stores, for each meeting, a meeting ID and a device priority order in association with each other.

The meeting ID is one example of identification information that identifies a meeting. The device priority order indicates a priority order in selecting a device. In this example, a device specification and a device type can be used as a device priority order. When the device specification (“SPEC”) is selected, the management apparatus 10 selects the device having a higher specification. When the device type is selected, the management apparatus 10 selects the device having a device type that is the same, or similar, to the device in the source meeting room.

Now, example operation of reproducing a meeting environment of a source meeting room onto a destination meeting room, using the prioritized device table of FIG. 26, performed by the management apparatus 10, is explained.

In this example referred to as a fifth scenario, it is assumed that the management apparatus 10 stores a device management table of FIG. 27, at least at the time when the reproduction request is sent to the management apparatus 10. In the following, operation of selecting the devices at S12 of FIG. 10 is described, as operation of determining connections to be established or instructing devices to connect will be performed in a substantially similar manner as described above referring to FIG. 10.

The device management table of FIG. 27 stores, in addition to data in the device management table of FIG. 6, information regarding the wireless LAN standards, which indicates a specific wireless LAN standard that the device is compatible with.

It is assumed that the source meeting room is the meeting room A “MR100”, and the user requests to reproduce a meeting environment onto the destination meeting room while selecting the meeting room B “MR101”.

At S11, the management apparatus 10 detects a monitor D109 in the source meeting room, which has the “contents projection” role. The management apparatus 10 detects the projector D110, the projector D111, and the monitor D112 in the destination meeting room, which all have the “contents projection” function, as a candidate of a device corresponding to the monitor D109.

Assuming that the meeting ID of the meeting subjected for reproducing is “M100”, the device priority order is set as “SPEC” in FIG. 26. The management apparatus 10 selects the projector D111, which is compatible with the wireless LAN standards of faster communication speeds, as the device to have the “contents projection” role in the destination meeting room. The management apparatus 10 is previously stored with information indicating an order of the wireless LAN, wired LAN, and D-Sub in terms of specification.

In another example, assuming that the meeting ID of the meeting subjected for reproducing is “M101”, the device priority order is set as “DEVICE TYPE” in FIG. 26. The management apparatus 10 selects the monitor D112 having the same device type as that of the monitor D109 in the source meeting room.

As described above, in this embodiment, even when there is a plurality of devices in the destination meeting room that can be assigned with a role of the device in the source meeting room, the device can be selected using a priority order previously set according to the user preference.

For example, if the user prefers the outer appearance or operability of the device to be in common or similar, the user can select based on the device type. If the user prefers the faster communication speeds, the user can select based on the device specification. In the above-described case, only the communication function is considered as the device specification, however, any other functionality may be considered such as display image quality, CPU processing speeds, or memory capacity. Alternatively, the priority order may be set such that both of the device specification and the device type are to be considered for device selection. Alternatively, any other information regarding the device may be used as a rule to select devices.

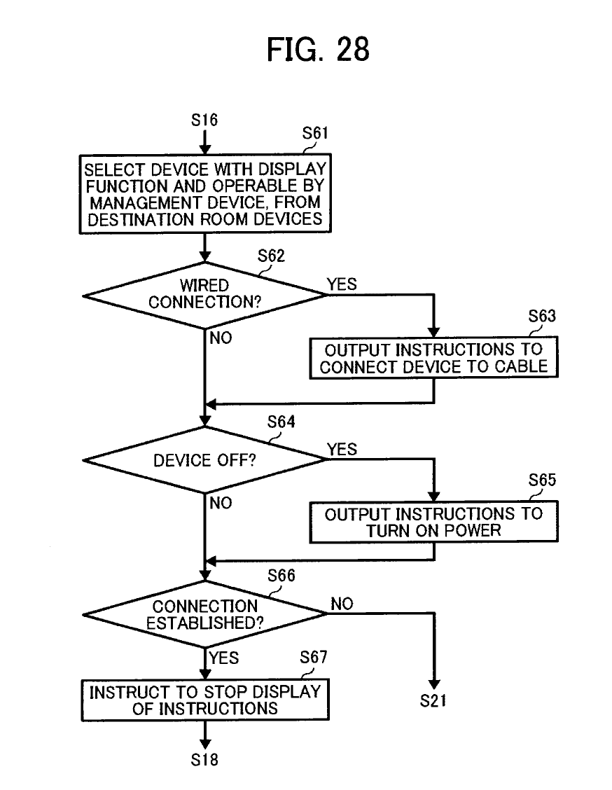

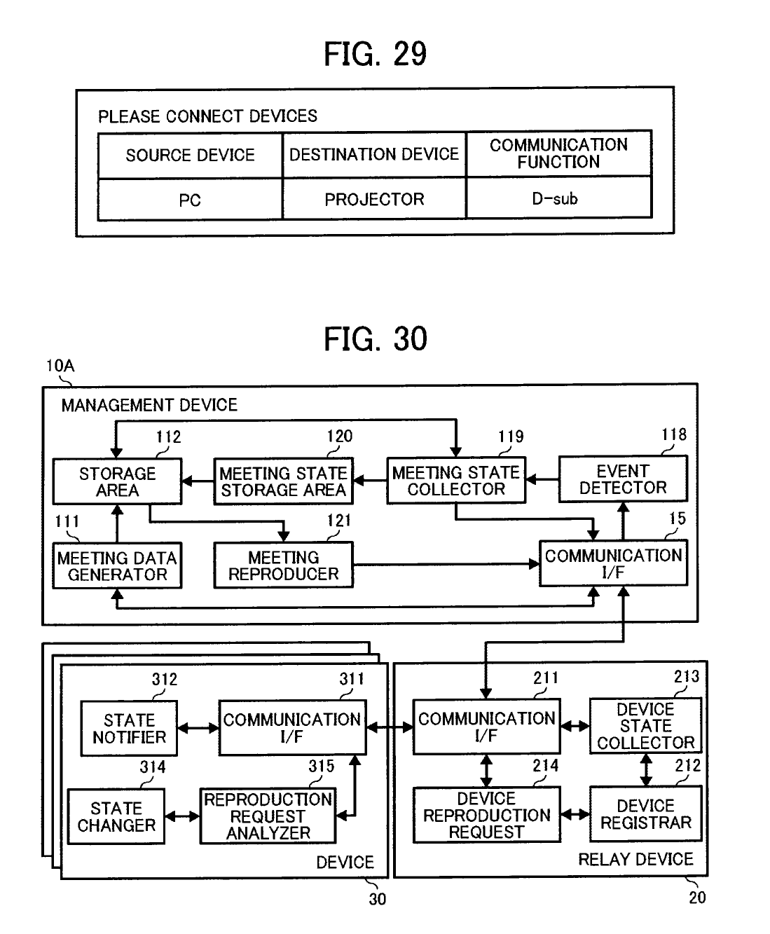

(Modified Example: FIGS. 28 and 29)

Referring to FIGS. 28 and 29, a modified example is explained. In this embodiment of FIGS. 28 and 29, the management apparatus 10 operates in a substantially similar manner as described above referring to FIGS. 1 to 16, except for some differences. The differences include additionally displaying a message, when the management apparatus 10 determines that the connection instructed at S16 of FIG. 10 needs a user operation to establish the connection.

FIG. 28 is a flowchart illustrating a part of operation of reproducing a meeting environment of a source meeting room, which differs from operation of FIG. 10.

After performing S16 of FIG. 10, which instructs the devices to establish connections, the operation proceeds to S61, in replace of S17.

At S61, the CPU 11 of the management apparatus 10 selects a device having the display function and operable by the management apparatus 10, from the devices in the destination meeting room. The management apparatus 10 may specify a device having the display function, using information obtainable from the device management table. The devices with the display function include the device capable of projecting an image such as the projector, and the device provided or connected with a screen such as a PC. The device operable by the management apparatus 10 means that the device is turned on, and is capable of displaying information, such as a message, according to the instruction from the management apparatus 10.

S61 of selecting the device having the display function and operable may be performed, when the management apparatus 10 determines that display of a message to a user is needed.

At S62, the CPU 11 of the management apparatus 10 determines whether the connection instructed at S16 requires wired connection. When it is determined that the wired connection is required (“YES” at S62), the operation proceeds to S63. Otherwise (“NO” at S62), the operation proceeds to S64.

At S63, the CPU 11 instructs the device for displaying, which is selected at S61, to display a message requesting the user to connect the device to be connected to a cable. For example, the device for displaying, which receives such request, displays a screen of FIG. 29, which requests the user to connect between the PC and the projector through the D-Sub cable.

At S64, the CPU 11 determines whether the device to be connected is turned off. When it is determined that the device to be connected is turned off (“YES” at S64), the operation proceeds to S65. Otherwise (“NO” at S64), the operation proceeds to S66.

At S65, the CPU 11 instructs the device for displaying, which is selected at S61, to display a message requesting the user to turn on the device to be connected.

At S66, the CPU 11 determines whether the connection is successfully established. When it is determined that the connection is established (“YES” at S67), the operation proceeds to S67. Otherwise (“NO” at S66), the operation returns to S21 of FIG. 10.

At S67, when the CPU 11 instructs the device for displaying to display a message either at S63 or S65, the CPU 11 requests the device that is displaying such message to stop displaying, and the operation proceeds to S18 of FIG. 10.

At S63 or S65, the CPU 11 may wait for a predetermined time period, before processing to S66, as the user may need time to connect the cable or turn on the device.

As described above, in this embodiment, in case a user operation is required, such as to connect the device with a cable to establish a wired network, the management apparatus 10 may notify the user of a need for connecting the devices through a wired network. This suppresses an error in establishing a wired connection, due to disconnection to a wired network. Similarly, the management apparatus 10 may notify the user of a need for turning on the power of the device. This suppresses an error in establishing a connection, as the power of the device is not turned on. In this embodiment, connection to the cable, and the turning on the power, may be considered as performing connections, physically. In addition or in alternative to the above-described operation, as long as the management apparatus 10 requires some physical operation to establish a connection, the management apparatus 10 may notify the user of such needs.

In addition to or in alternative to notification through a display, the management apparatus 10 may notify the user in any other means, for example, by outputting sounds such as a voice message, or by sending an email to the device operated by the user such as the PC having the “manage meeting” role.

As described above referring to FIGS. 1 to 29, in case the user changes a meeting room during a meeting, the user may request the management apparatus 10 to reproduce a meeting environment onto a destination meeting room. In response to the request, the management apparatus 10 refers to information regarding a source meeting room, such as the operation state information and the connection state information of devices in the source meeting room, to control devices in the destination meeting room to reproduce the meeting environment.

While the above-described example only describes the case when the user moves from one meeting room to another meeting room to continue to have a meeting, any one of the above-described techniques may be applicable to the other situation in which the user desires to reproduce an environment of devices in one area, using other devices in the other area. In other words, under the situation where a plurality of devices are provided in each one of a plurality of areas, and when there is a need for reproducing an environment of devices in one area, using other devices in the other area, any one of the above-described techniques may be used.

In addition to reproducing the role of each device and the connection state of each device, the user may want to reproduce specific configurations of each device, such as the volume of output sounds, the brightness of a display screen, and a screen size.

Further, the user may want to reproduce a meeting environment that reflects a specific time during a meeting, irrespective of whether a meeting room is changed or not. In other words, under the situation where a plurality of devices are provided in each one of a plurality of areas, there may be a need for reproducing an environment of a specific point in time, using devices that may be the same or different than previously-used devices, or using devices located in the same area or different area than previously-used area. In such case, the device management system of FIG. 1 may be configured as illustrated in FIG. 30.

Referring now to FIGS. 30 to 50, an apparatus, system, method, and program stored on a recording medium, each of which is capable of reproducing a meeting environment, are explained according to an example embodiment of the present invention.

FIG. 30 illustrates a functional structure of a management apparatus 10A, a relay device 20, and a device 30 to be managed by the management apparatus 10A, according to an example embodiment of the present invention.

The management apparatus 10A is substantially similar in hardware structure to the management apparatus 10 of FIG. 2, but different in functional structure to the management apparatus 10 of FIG. 3. Further, the device 30 of FIG. 30 is different in functional structure to the device 30 of FIG. 3. Further, the relay device 20 of FIG. 30 is different in functional structure to the device 20 illustrated in FIGS. 1 to 29.

In a substantially similar manner as described above for the management apparatus 10, the management apparatus 10A manages various data regarding the devices provided in each meeting room, such as the operation state of each device, the connection state of each device, contents being used, and various data regarding a meeting to be held or being held on each meeting room such as scheduled information regarding the meeting, or information indicating whether the meeting is being held. The management apparatus 10 further requests each device in the meeting room to transmit operation state information and contents information, to reproduce the operation state, or to reproduce the contents, etc.

As described above referring to FIG. 1, devices provided in each meeting room may differ depending on the meeting room. In order to reproduce a meeting environment of a source meeting room onto a destination meeting room, it is desirable to have devices that are similar in characteristics for both of the source meeting room and the destination meeting room. Specific characteristics to be considered as a part of the meeting environment may, however, differ according to a design specification of the system. For example, if the operation state and the connection state are an important factor, such characteristics should be taken into account to select devices having the same device type and communication function. For example, if a screen size is not an important factor to be considered, such characteristics may not be considered as a part of the meeting environment. If a number of devices is an important factor to be considered, the number of devices in each meeting room should be the same.

Referring to FIG. 3, the management apparatus 10A includes the communication I/F 15, the meeting data generator 111, the storage area 112, an event detector 118, a meeting state collector 119, a meeting state storage area 120, and a meeting reproducer 121. These functional modules are implemented by the CPU 11 (FIG. 2), which operates in cooperation with the hardware of the management system 10A illustrated in FIG. 2, according to the device management program stored in the memory.

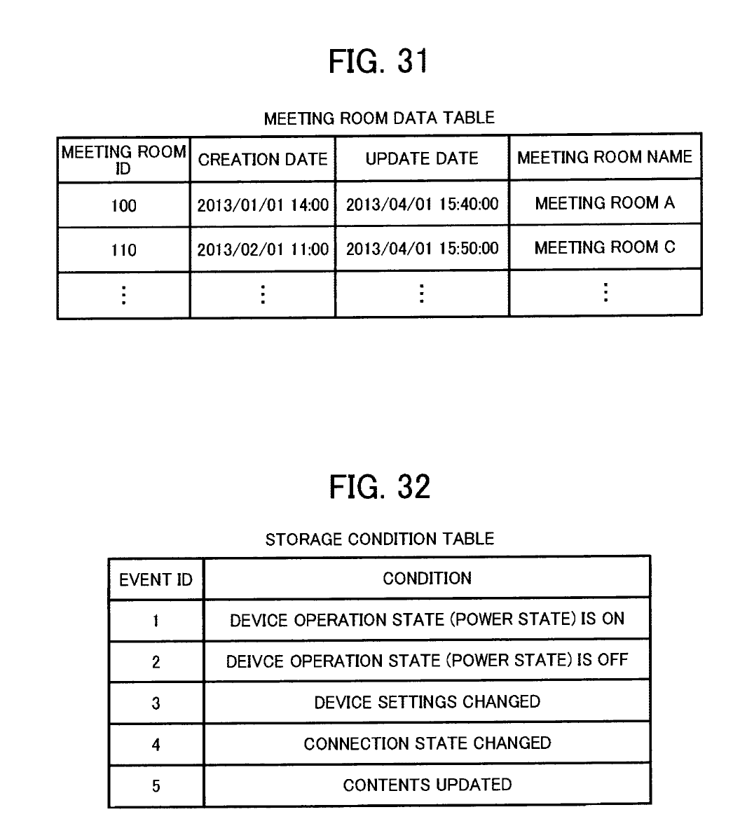

The meeting data generator 111 generates meeting data according to a user instruction, and stores the meeting data in the meeting data table (FIG. 5). The meeting data generator 111 generates or modifies the meeting data, such as information regarding the meeting room having the devices such as by using the meeting room table (FIG. 31).

The storage area 112, which may be implemented by any desired memory such as the RAM 13 or the HDD 14, stores various data, for example, in the form of table.

The event detector 118 detects an event of various types, which is notified by the device 30 through the relay device 20. The event includes state change information indicating the change in operation state of the device 30. The event detector 118 functions as a determiner in response to receiving the state change information. More specifically, the event detector 118 determines whether to register the operation state of the device, based on whether the state change information matches a condition specified by a storage condition table of FIG. 32. When the event detector 118 determines that the state change information is to be stored, the event detector 118 requests the meeting state collector 119 to collect information such as operation state information of the devices including the device that sends the state change information.

The meeting state collector 119 is provided with the function of storing the state information. In response to the instruction from the event detector 118, the meeting state collector 119 collects the operation state information and the contents being used, from each device of the devices subjected for data collection. The meeting state collector 119 may send an instruction for collecting, to the relay device 20 that relays communication between the management apparatus 10A and each device 30 subjected for data collection. In response to such instruction, the relay device 20 collects necessary data from each device of the devices 30 subjected for data collection, and sends such data to the management apparatus 10A. The meeting state collector 119, which receives the collected data from the relay device 20, sends the collected data to the meeting state storage area 120.

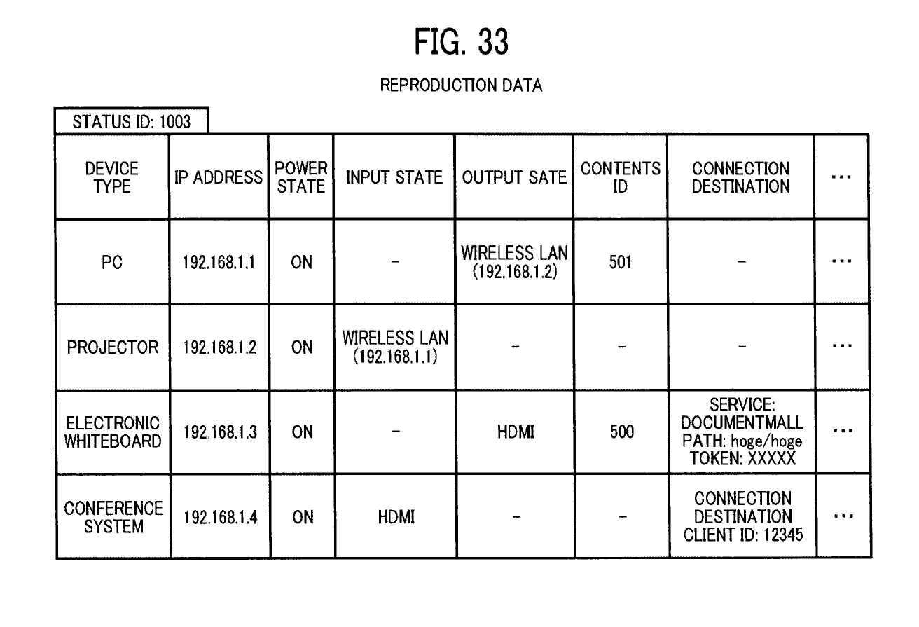

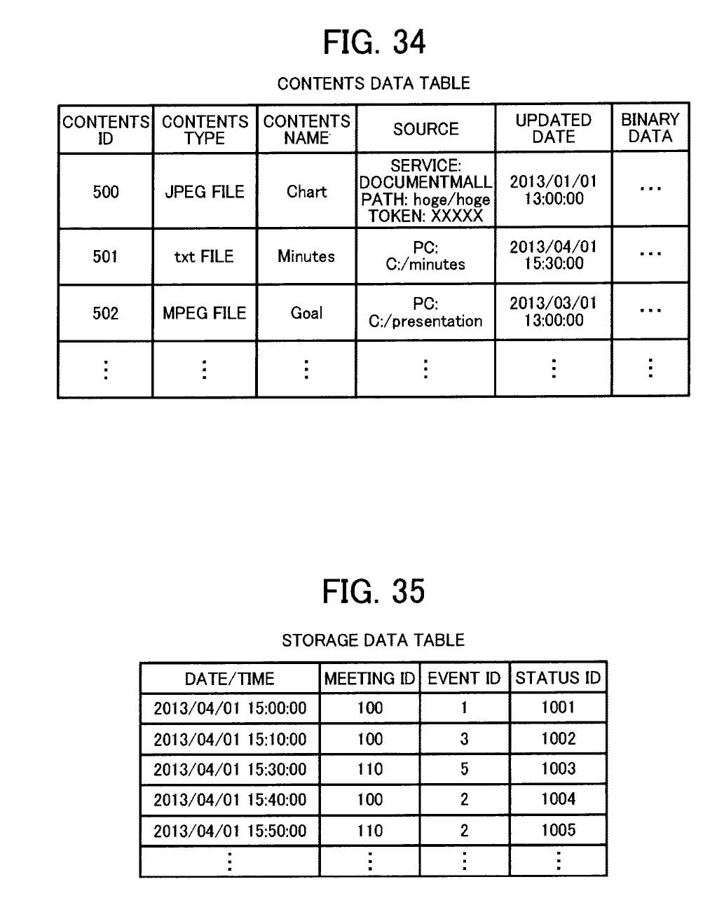

The meeting state storage area 120, which may be implemented by any desired memory, stores the collected data regarding each device, which is received from the meeting state collector 119, as reproduction data (FIG. 33). The reproduction data is assigned with a unique status ID. For information regarding the contents being used (“contents data”), the CPU 11 of the management apparatus 10A assigns a unique contents ID to the contents data, and stores the contents data to the contents data table (FIG. 34). The contents ID, which is assigned, is registered to the reproduction data table of FIG. 33 in association with a specific device using such contents data. In this manner, using a status ID as a key, the management apparatus 10A is able to obtain the operation state of each device and the contents being used, which are collected at the meeting state collector 119.

The meeting state storage area 120 further stores information indicating the date when the reproduction data is stored, to a storage data table of FIG. 35.

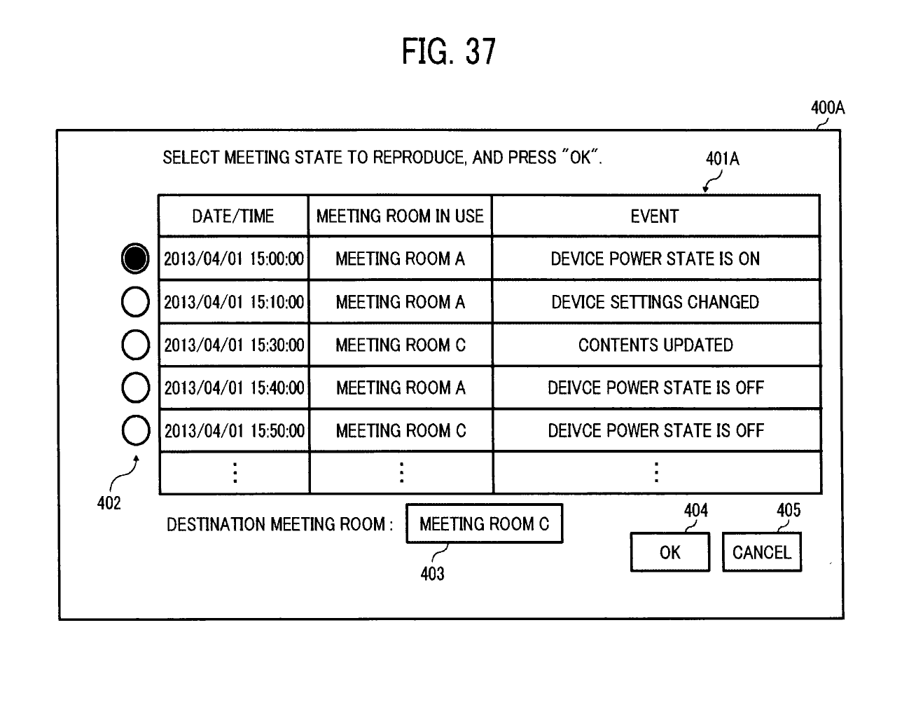

The meeting reproducer 121 receives a request for reproducing a meeting environment. For example, the meeting reproducer 121 displays reproduction data, stored in the meeting state storage area 120, to the user, and requests the user to select the reproduction data to be used for reproducing a meeting environment. In one example, the user at a user terminal such as a PC may access a predetermined address of the management apparatus 10A using the web browser. In response to such access, the management apparatus 10 sends data to be displayed, to cause the web browser to display a reproduction request screen 400A of FIG. 37.

Further, in response to a reproduction request that is input through the reproduction request screen 400A, the meeting reproducer 121 reads the selected reproduction data from the meeting state storage area 120, and performs operation of reproducing a meeting environment based on the selected reproduction data. More specifically, the meeting reproducer 121 instructs each device in the destination meeting room, to operate based on the operation state specified by the selected reproduction data, and reproduce the contents specified by the selected reproduction data. The meeting reproducer 121 may instruct the relay device 20 that relays communication between the management apparatus 10A and the devices in the destination meeting room, to reproduce a meeting environment based on the reproduction data. The relay device 20 instructs each device in the destination meeting room to operate according to the reproduction data, and sends a result of processing the reproduction request to the management apparatus 10A.

Still referring to FIG. 30, the relay device 20 includes a communication I/F 211, a device registrar 212, a device state collector 213, and a state reproduction request 214. These functional modules are implemented by the CPU 11 (FIG. 2), which operates in cooperation with the hardware of the relay device 20, according to the relay management program stored in the memory.

The communication I/F 211 allows the relay device 20 to communicate with various devices such as the management apparatus 10A and the device 30, through the network 40. For example, the communication I/F 211 relays information regarding an event, such as the change state information, from the device 30 to the management apparatus 10A.

The device registrar 212 registers information regarding each one of the devices 30, which are managed by the relay device 20 to communicate with the management apparatus 10A. For the descriptive purposes, the device 30 subject for management by the relay device 20 in relaying communication is referred to as the device 30 for relay management. The device registrar 212 at least stores a device type and an address (such as an IP address) of the device 30 for relay management. The administrator may previously register such information regarding each device 30. Alternatively, the relay device 20 may automatically search for any device 30 for relay management, which is provided in the meeting room, and registers information regarding such device.

The device state collector 213 requests each device for relay management, which is registered at the device registrar 212, to send the operation state information and the contents information, in response to an instruction from the meeting state collector 119 of the management apparatus 10A. The device state collector 213 sends the operation state information and the contents information, which are collected from the respective devices for relay management, to the meeting state collector 119, for example, in batch.

The state reproduction request 214 requests each device for relay management, which is registered at the device registrar 212, to operate based on the operation state specified by the reproduction data and reproduce contents specified by the reproduction data, in response to an instruction received from the meeting reproducer 121 of the management apparatus 10A. Based on notification from each device, the state reproduction request 214 determines whether the reproduction request has been processed by each device to generate a processing result, and sends the processing results regarding the devices for relay management to the meeting reproducer 121 of the management apparatus 10A.

Still referring to FIG. 30, the device 30 includes the communication I/F 311, the state notifier 312, a reproduction request analyzer 315, and a state changer 314. These functional modules are implemented by the CPU 11 (FIG. 2), which operates in cooperation with the hardware of the device 30, according to a device management program stored in the memory.

The communication I/F 311 is a communication interface such as a network interface circuit, which allows the device 30 to communicate with the external device such as the relay device 20 and the management apparatus 10A. In this example, the data to be transmitted to the management apparatus 10A from the device 30, is transmitted through the relay device 20 that transfers the received data to the management apparatus 10A. The device 30 thus transmits data to be transmitted to the management apparatus 10A, to the relay device 20.

The state notifier 312 sends the state change information indicating the change in operation state of the device 30, to the management apparatus 10A through the relay device 20. Since the management apparatus 10A determines whether to register the state change information, the device 30 is programmed to send the state change information to the management apparatus 10A every time the change in operation state is detected, or any desired time to reduce a network traffic if this is desirable. The state notifier 312 sends the operation state information indicating the current state, and contents information indicating the contents being used, to the management apparatus 10A, in response to the instruction from the relay device 20 or the management apparatus 10A. As described above, the operation state information and the contents information may be registered as reproduction data.

The reproduction request analyzer 313 receives a request for reproducing a meeting environment based on the reproduction data from the relay device 20. In response to the request for reproducing, the reproduction request analyzer 313 analyzes the reproduction request, and instructs the state changer 314 to perform specific operation based on the reproduction data. The reproduction request analyzer 313 further sends a processing result of the reproduction request, to the relay device 20.

The state changer 314 reproduces the operation state of the device 30, and the contents, in response to the instruction from the reproduction request analyzer 313. For example, changing of the operation state to reproduce the operation state based on the reproduction data includes, but not limited to, changing a connection destination, changing a parameter for volume or light level, and changing an operation mode to a sleep mode or from the sleeping mode. The contents may be reproduced using any function of the device 30, such as displaying, projecting, outputting sounds, or supplying display data to the other device.

Next, various data stored in the storage area 112 is explained, according to an example embodiment of the present invention.

FIG. 31 illustrates an example data structure of a meeting room data table, which stores information regarding a meeting room having devices to be managed by the management apparatus 10A. In this example, one meeting room is provided with a plurality of devices, which may be referred to as a group of devices, each being managed by the relay device 20 in relaying data with the management apparatus 10A. The meeting room data table of FIG. 31 includes a meeting room ID, creation date, update date, and meeting room name.

The meeting room ID is one example of identification information that identifies a meeting room. The creation date indicates a date/time when an entry of meeting room data is created. The update date indicates the last date/time when the reproduction data for that meeting room is stored. The meeting room name is a name of the meeting room. The contents of the meeting room data table may be registered by an administrator of the management apparatus 10, for example, based on information regarding the meeting rooms each of which has the devices 30 to be managed by the management apparatus 10A.

FIG. 32 illustrates an example data structure of a storage condition table, which stores a rule to be used for the event detector 118 that determines whether reproduction data is stored in response to receiving state change information from the device 30.

The storage condition table of FIG. 32 stores, for each event, an event ID and a condition, in association with each other. The condition indicates a condition that, when it is met, reproduction data is stored. When the received state change information meets the condition, the management apparatus 10A determines that the reproduction data is to be stored. The event detector 118 determines that, when the received state change information meets any one of the conditions stored in the storage condition table of FIG. 32, the reproduction data regarding the devices including the device that sends the state change information is to be stored.

The event ID is one example of identification information that identifies an event. The event ID may be used to specify, under which condition, the reproduction data is stored. For example, when the reproduction data is stored in response to receiving state change information indicating that the power of the device 30 is turned on, the meeting state storage area 120 obtains the event ID “1” from the storage condition table, and registers the event ID “1” to the storage data table of FIG. 35.

FIG. 33 illustrates an example data structure of reproduction data, stored in the meeting state storage area 120. The reproduction data, which is information regarding the devices in the meeting room, includes a device type, IP address, power state, input state, output state, contents ID, and connection destination. The reproduction data is assigned with a unique status ID.

The status ID is one example of identification information that identifies the reproduction data. The device type is information indicating a device type of each device. The IP address is an IP address assigned to each device. The power state indicates whether the power of the device is turned on or off. In addition to information indicating the power is on or off, the power state may indicate an energy save mode in which the device operates with less energy.

The input state indicates a communication function to be used for inputting an image and a sound to the device, and an IP address of an input device that inputs data to the device if the device is connected through a network. The output state indicates a communication function to be used for outputting an image and a sound from the device, and an IP address of an output device from which the device outputs data if the device is connected through a network. In operation of reproducing a meeting environment, the communication function of each device is set, such that data can be transferred from the input device to the output device. The input device and the output device in this embodiment are both provided in the same meeting room. In case the device is to be connected to the external device, provided outside the meeting room, such information is registered in the “connection destination” field of the reproduction data.

The contents ID is one example of identification information that identifies the contents being used by the device. The information regarding the contents itself is registered to the contents data table of FIG. 34, as described below.

The connection destination indicates a connection destination to which the device is to be connected, in case the device is to be connected to the external device outside the meeting room. The description of this “connection destination” field is optional, such that any information that can be used for communication with the external device, such as an address, path, identification information of the device, or a token for communication, may be stored.

In addition to the reproduction data illustrated in FIG. 33, any information that may be used for reproducing a meeting environment such as settings information of any device 30 may be stored as the reproduction data. For example, a sound volume, a light level of screen, a screen size, etc., may be registered. The management apparatus 10A may be previously set with information indicating specific items of data to be stored as the reproduction data.

The reproduction data of FIG. 33 corresponds to one entry of reproduction data. The management apparatus 10A stores a plurality of entries of reproduction data, each being assigned with a status ID. The reproduction data may additionally include identification information of each device.

FIG. 34 illustrates an example data structure of contents data table, which registers information regarding the contents being used (produced) by the device at least when the reproduction data is collected. The contents data table of FIG. 34 includes a contents ID, contents type, contents name, source, update date, and binary data.

The contents ID is one example of identification information that identifies contents data. The contents ID is also registered to the reproduction data of FIG. 33. The contents type is a type of contents data. While this example stores a data format as a contents type, any other characteristics of contents data may be used. The contents name is a name of the contents.

The source is information indicating a source from which the contents is obtained. While the source may be identified in various ways, any information that can be used to obtain the same contents each time an access is made, can be stored. For example, in case the contents data is stored locally, a path may be described. If the contents is stored on the Internet, a uniform resource locator (URL) may be used. In case the contents data is stored in a database, a search parameter may be used. If authentication information is needed to obtain the contents data, such authentication information may be or may not be stored, according to the security policy.

The update date indicates the date/time when the contents data is updated last. The update date may be used to determine, when accessing the contents using the source again, whether the contents has been updated.

The binary data is the contents data being used by the device, in a binary format. With this binary data, if the contents data to be reproduced is the same as that of the contents data being stored, the management apparatus 10 does not have to obtain the contents data again using the source data.

FIG. 35 illustrates an example data structure of storage data table, which indicates under which condition the reproduction data stored in the storage area 112 is collected. The storage data table of FIG. 35 includes, for each reproduction data being stored, a date/time, meeting ID, event ID, and status ID.

The date/time indicates a date/time when the reproduction is stored. The meeting room ID is one example of identification information that identifies a meeting room in which the devices subjected for data collection are located. That is, the meeting room ID indicates a meeting room provided with a plurality of devices having at least one device with the operation state subjected for data collection. The event ID is identification information that indicates an event type of the event that triggers collection of reproduction data, which is set based on the storage condition table of FIG. 32. The status ID is identification information that identifies the reproduction data being stored.

Now, operation of storing information regarding a meeting environment in a meeting room, and reproducing the meeting environment, performed by the management apparatus 10A, relay device 20, and device 30, is explained according to an example embodiment of the present invention.

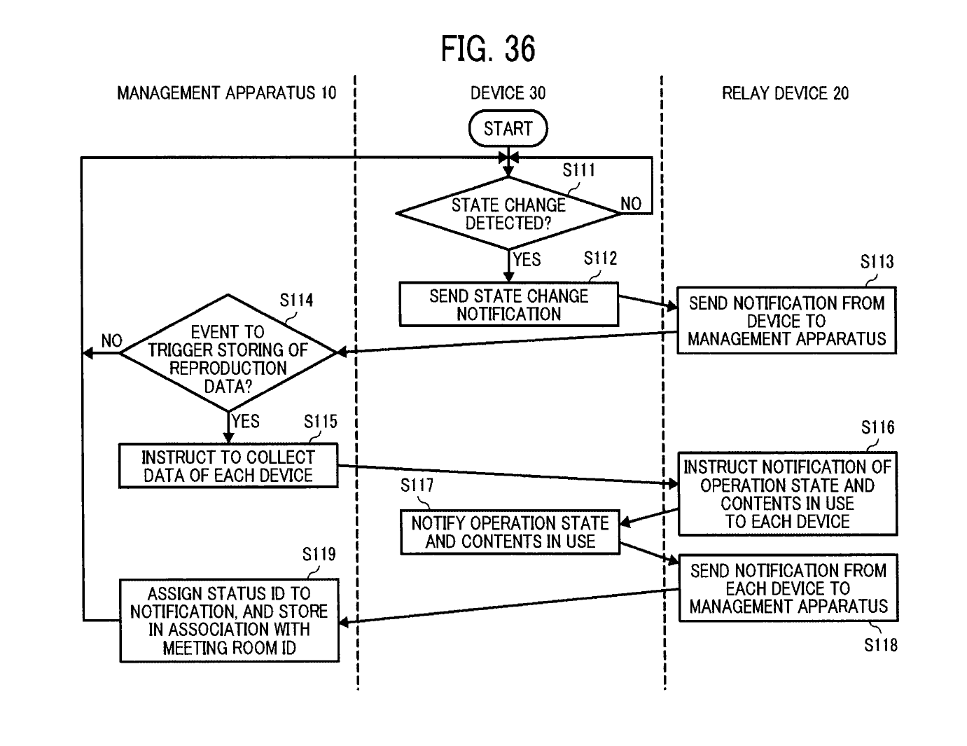

FIG. 36 illustrates operation of storing reproduction data, performed by the device management system of FIG. 30, according to an example embodiment of the present invention.

When the power is turned on or the system is restarted, at S111, the device 30 starts monitoring any change in operation state. When the change in operation state is detected (“YES” at S111), the operation proceeds to S112 to notify the management apparatus 10A of the change in operation state. More specifically, in this example, the device 30 sends the state change information (state change notification) to the relay device 20. At S113, the relay device 20 sends the state change information to the management apparatus 10A. When there is no change in operation is detected at S111 (“NO” at S111), the device 30 keeps monitoring.

At S114, in response to the state change information from the device 30, the management apparatus 10A determines whether the state change information indicates an event that triggers storing of reproduction data. When it is determined that the state change information is not an event that triggers storing of reproduction data (“NO” at S114), the operation at the management apparatus 10A ends. The device 30 then continues monitoring.

When it is determined that the state change information is an event that triggers storing of reproduction data (“YES” at S114), the management apparatus 10A determines to collect the operation state information and the contents information from each device, which is located in the same meeting room where the device that sends the state change information locates. At S115, the management apparatus 10A requests the relay device 20, which is located in the room where the device sending the state change information locates, to collect information regarding each device of a group of devices subject for data collection, such as information to be registered as reproduction data of FIG. 33.

At S116, the relay device 20 instructs each device subject for data collection to send the operation state information and the contents information to the relay device 20. More specifically, the devices subject for collection include the device that sends the state change information, and a plurality of devices that are located in the same meeting room where the device that sends the state change information is located. Assuming that the relay device 20 is provided for each meeting room, the devices subject for data collection correspond to devices for relay management by the relay device 20. At S117, each device 30 sends the operation state information and the contents information to the relay device 20.

At S118, the relay device 20, which receives the operation state and the contents information from the devices for relay management, sends the received information to the management apparatus 10A. In case the contents information from the device 30 includes the contents in use, the relay device 20 assigns a contents ID to the contents data. The relay device 20 further converts the contents data to have a data format that can be registered to the contents data table of FIG. 34. The relay device 20 further adds the contents ID to the operation state information received from the device 30, to generate the reproduction data as illustrated in FIG. 33.

At S119, the management apparatus 10A, which receives the reproduction data, assigns a status ID to the reproduction data, and stores the reproduction data in association with a meeting ID. The correspondence between the reproduction data and the meeting ID may be made, by registering information regarding the reproduction data that is stored, to the storage data table (FIG. 35).

As described above, in response to detection of a trigger in at least one device in a meeting room, the management apparatus 10A stores reproduction data, indicating the operation state of each device in the meeting room. While it may be desirable to store reproduction data at many times for one meeting, if a data size or efficiency in selecting reproduction data is considered, the management apparatus 10A may be set to store reproduction data only when the state of device greatly changes. This rule for storing the reproduction data may be changed, through updating the storage condition table of FIG. 32.

Referring to FIG. 36, at S116, the relay device 20 may send a request to each device 30, while addressing an IP address of each device. Alternatively, the relay device 20 may broadcast the request to a network, and each device determines whether to reply to that request.

At S118, in prior to receiving information from all devices, the relay device 20 may transfer the information received from the device to the management apparatus 10A. In such case, the management apparatus 10A determines whether information is received from all devices. Editing data, such as converting a data format and assigning a contents ID, may be performed at the management apparatus 10A.

At S116, when the relay device 20 cannot detect any one of the devices 30 in the meeting room, the relay device 20 may determine that such device is not in use, for example, as the power of the device is turned off, or the device is disconnected from a cable. In such case, the relay device 20 determines that the operation state of such device indicates that the power is turned off.

Next, operation of reproducing a meeting environment of a source meeting room, onto a destination meeting room, is explained according to an example embodiment of the present invention. To request for reproducing a meeting environment of a source meeting room onto a destination meeting room, the user at a terminal, such as a PC, may access the management apparatus 10A to request for reproducing a meeting environment. In some cases, the user may want to reproduce a meeting environment of a source meeting room, onto a destination meeting room, after the user moves from the source meeting room to the destination meeting room to continue to have the meeting.

FIG. 37 illustrates the example reproduction request screen 400A, which allows the user to input a request for reproducing a meeting environment onto a destination meeting room.

In one example, the management apparatus 10A displays the reproduction request screen 400A through a user terminal operated by a user, such as the device 30 in the meeting room or a PC (such as a temporary device 30) bought by the user into the meeting room, in response to access by the user terminal.

The reproduction request screen 400A includes a meeting list section 401A, a plurality of radio buttons 402, a destination meeting room input 403, an “OK” key 404, and a “CANCEL” key 405.

The meeting list section 401A is an area for displaying a list of reproduction data that are stored in the storage area 112, that is, a list of states of meeting that can be reproduced. In this example illustrated in FIG. 37, the meeting list section 401A lists the date/time when the reproduction data is collected (stored), the meeting room in use, and the event type that triggers collection of the reproduction data, based on the storage data table of FIG. 35 and the meeting room data table of FIG. 31. The event type may be obtained using the event ID, from the storage condition table of FIG. 32. Alternatively, any other information may be displayed.

One of the radio buttons 402 may be selected to indicate a user selection that selects reproduction data that the user wants to use in reproducing a meeting environment, from the reproduction data listed in the meeting list section 402.

The destination meeting room input 403 is an area, which displays information indicating the destination meeting room that is input by the user. The user may directly input text data in the destination meeting room input 403, using any desired input device such as a keyboard. Alternatively, the management apparatus 10A may generate a list of meeting rooms that are currently available for use, based on information obtained from the meeting room data table or usage information of each meeting room, and request the user to select one meeting room from the list as the destination meeting room. Alternatively, since the relay device 20 is provided in each meeting room, the IP address of the relay device 20 may be selected to specify the destination meeting room.

The “OK” key 404, when selected, confirms user selection of the reproduction data and/or the destination meeting room, and sends a request for reproducing a meeting environment specified by the selected reproduction data onto the destination meeting room to the management apparatus 10A. The “CANCEL” key 405, when selected, closes the reproduction request screen 400A without sending a reproduction request.

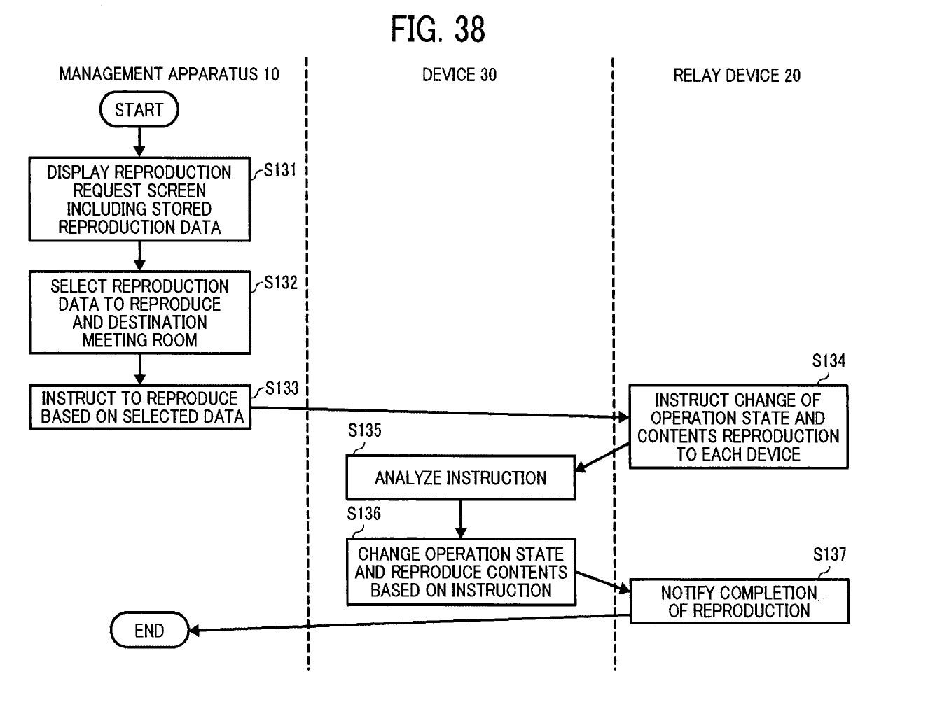

FIG. 38 is a data sequence diagram illustrating operation of reproducing a meeting environment, performed by the device management system of FIG. 30, according to an example embodiment of the present invention.

In response to detection of an access from a user terminal, at S131, the management apparatus 10A displays a reproduction request screen, such as the screen 400A, which includes a list of reproduction data, to the user terminal. The user terminal, which may be implemented by the PC or a smart device such as a smart phone, may access the management apparatus 10A using the browser or dedicated application.

In response to the user selection on the reproduction data and the destination meeting room through the screen 400A as described above referring to FIG. 37, at S132, the management apparatus 10A obtains the reproduction request including the selected reproduction data and destination meeting room.

At S133, based on the selection, the management apparatus 10A instructs the relay device 20, which manages the devices in the selected destination meeting room, to cause the operation state of each device in the selected destination meeting room to reproduce a meeting environment specified by the selected reproduction data. The management apparatus 10A sends the selected reproduction data, and the contents information identified by the contents ID of the reproduction data, to the relay device 20.

In response to the instruction, at S134, the relay device 20 instructs each device indicated by the reproduction data, out of the devices for relay management, to operate in the operation state specified by the reproduction data, and reproduce the contents specified by the reproduction data.

At S135, each device 30, which receives the instruction (reproduction request) from the relay device 20, analyzes the instruction. At S136, the device 30 changes the operation state and reproduces the contents based on the instruction, and returns a processing result of the reproduction request to the relay device 20.

In response to receiving the response indicating that the change and reproduction are successfully performed from the device 30, at S137, the relay device 20 sends notification indicating completion of reproduction to the management apparatus 10A.

The management apparatus 10A confirms the completion of reproduction, and the operation ends.

Through the above-described operation of FIG. 38, the device management system automatically reproduces a meeting environment selected by the user, using the devices in the destination meeting room selected by the user. As the meeting environment is reproduced, contents that has been used, for example, for a specific meeting in a source meeting room at a desired time is reproduced in the destination meeting room.

In this example, the meeting environment is automatically stored, every time the operation state of at least one device in the meeting room changes, as described above referring to FIG. 36. With the reproduction data, the user can select reproduction data of a desired point of time for a desired meeting. The user can easily operate the devices under a condition that is substantially the same as the previous condition, even with devices different from the previously used devices. For example, even when the meeting room in which the meeting is held changes from the source meeting room to the destination meeting room, the meeting can be carried out more smoothly. In another example, even when the meeting is to be continued on a different date, the meeting can be carried out more smoothly, as the contents previously used can be easily reproduced.

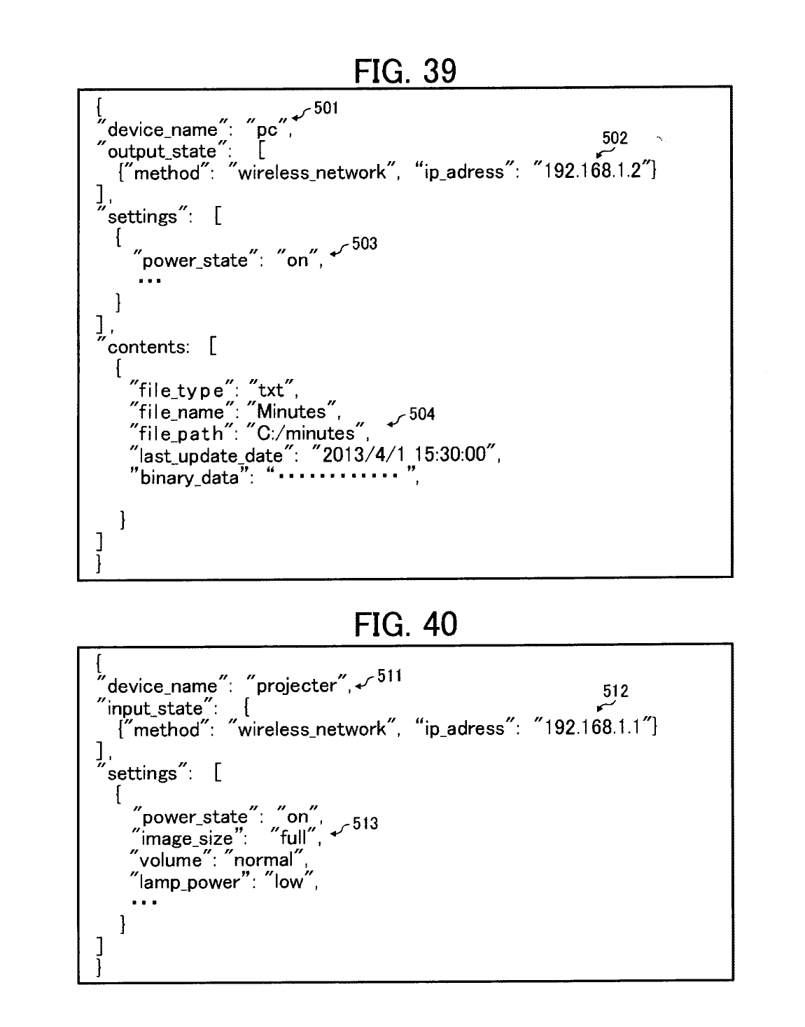

FIGS. 39 and 40 illustrate example data of a reproduction request, which is transmitted from the relay device 20 to the device 30. FIG. 39 illustrates example data of a reproduction request transmitted to the device 30 implemented by the PC, which requests the device 30 to reproduce according to the reproduction data for the PC in FIG. 33. FIG. 40 illustrates example data of a reproduction request transmitted to the device 30 implemented by the projector, which requests the device 30 to reproduce according to the reproduction data for the projector in FIG. 33. While these data are generated in JavaScript Object Notation (JSON) format, any desired file format may be used.

In FIG. 39, “device_name: “pc” data 501 indicates that this data is data for the device 30 having the device type “PC”. The “output_state” data 502 instructs to change the output settings, so as to communicate with the device having the IP address “192.168.1.2” through the wireless LAN.

The “settings” data 503 instructs to change the power state to “On”. The “settings” data 503 may further include the other instruction regarding the other settings.

The “contents” data 504 indicates the source of the contents to be reproduced, or binary data. While only the binary data is needed to reproduce contents, with the source indicating the location of the contents, the device 30 is able to obtain the contents data in case the binary data cannot be processed.

In FIG. 40, “device_name: projector” data 511 indicates that this data is data for the device 30 having the device type “projector”. The “input_state” data 512 instructs to change the input settings, so as to communicate with the device having the IP address “192.168.1.1” through the wireless LAN.

The “settings” data 513 indicates to change the power state to “On”, the image size to “full”, the volume to “normal”, and lamp power to “low”. Since the contents is not to be reproduced, there is no contents data.

As described above, when the IP address is to be reproduced even in a meeting room that is different from a meeting room having devices from which reproduction data is collected, the devices should be located at different places over a network. If more than one device is located at the same place on the network, the same IP address may be assigned to different devices, thus causing a trouble in reproducing the operation state such as the input state and the output state according to the reproduction data.

In view of this, the relay device 20 is provided to relay data between a network to which the devices in the meeting room are connected, and a network on which the management apparatus is connected. Further, it is desirable to make the correspondence between the device type and the IP address, common to all device groups, such that the relay device 20 can easily locate the device of each type that is located at a specific network location.

Alternatively, each device may be assigned with a fixed IP address. In such case, the IP address is not managed as an item to be reproduced. Alternatively, only when the reproduction data is to be reproduced in the meeting room, which is the same as the meeting room that the reproduction data is stored, the IP address may be used as an item to be reproduced.

Further, the relay device 20 does not have to be provided with the function of generating and sending instructions to respective devices, in response to an instruction from the management apparatus 10A, as described above referring to FIG. 30, FIG. 36, and FIG. 38. More specifically, the device reproduction request 214 does not have to be provided. In such case, the relay device 20 may transfer data transmitted from the management apparatus 10A to a network in the meeting room, or transfer data transmitted from the device 30 to the management apparatus 10A through the network 40.

If the IP address is not managed as an item to be reproduced, the relay device 20 may not be provided in the meeting room. In such case, the management apparatus 10A and the device 30 may directly communicate with each other. Without the relay device 20, the management apparatus 10A needs to be provided with information indicating a group of devices located in the same meeting room.

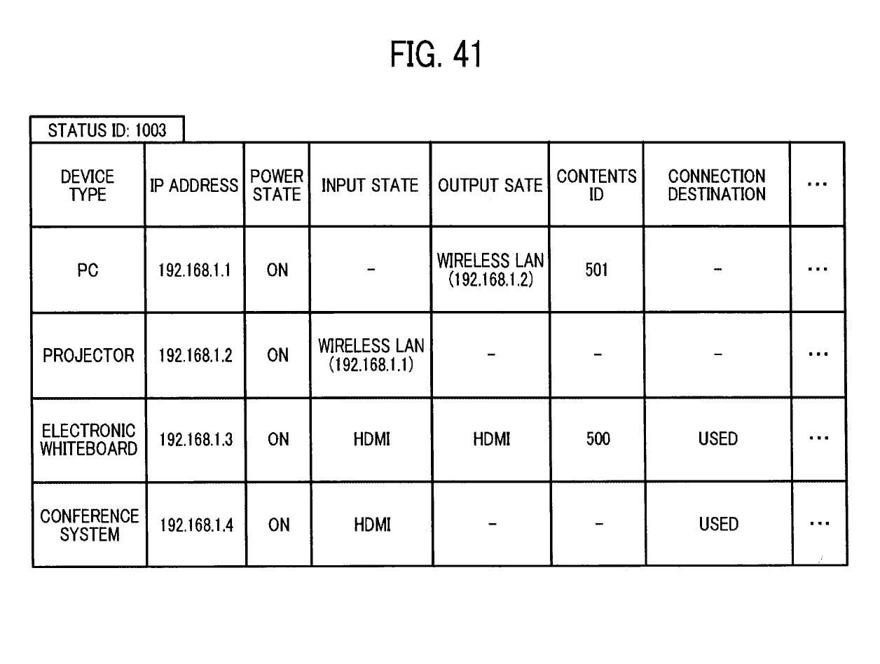

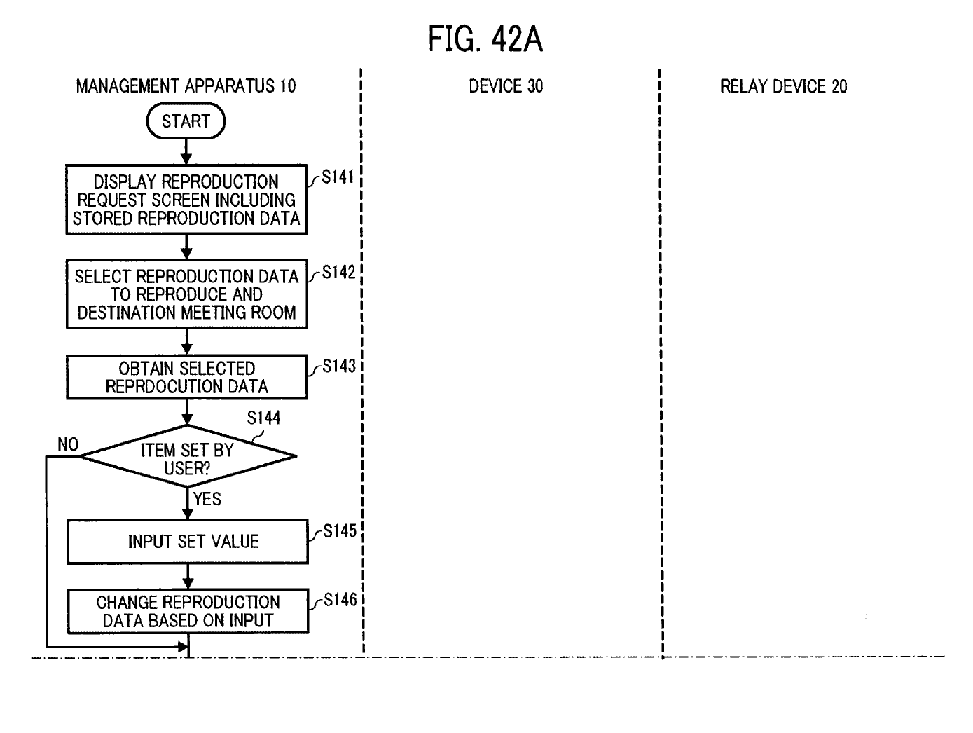

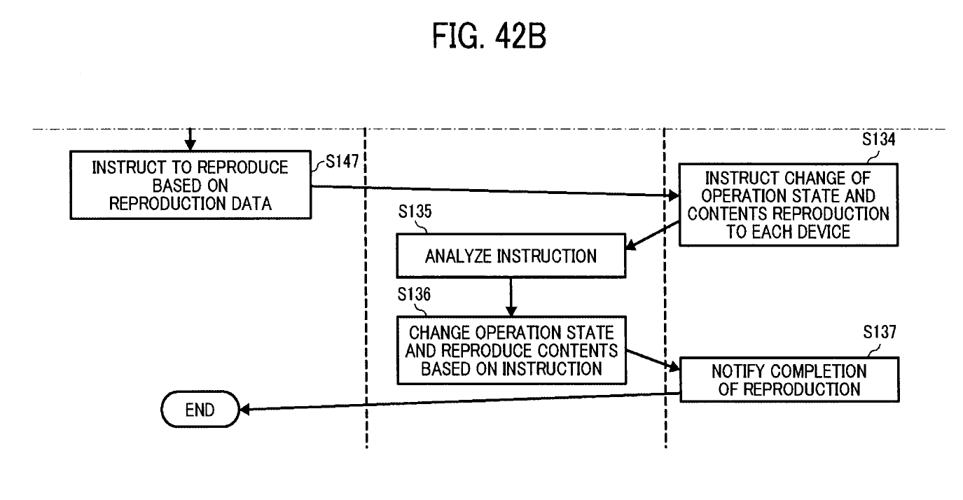

(Modified Example: FIGS. 41 and 42)

Referring now to FIGS. 41, 42A and 42B, a modified example is explained. In this embodiment of FIGS. 41, 42A and 42B, the device management system operates in a substantially similar manner as described above referring to FIGS. 30 to 40, except for some differences. The differences include partially changing the reproduction data when reproducing.

FIG. 41 illustrates an example data structure of reproduction data. The reproduction data of FIG. 41 has an item that can be set by the user when reproducing, which differs from the reproduction data of FIG. 33. In this example, the “connection destination” items for the whiteboard and the conference system, with the value “Used”, are set as an item that can be set by the user.

The management apparatus 10A is previously registered with information indicating which item is to be set with the value “Used”. When storing the reproduction data, the management apparatus 10 refers to the item to be set with the value “Used”, and modifies the reproduction data, or the operation state information and the contents information, collected from the devices 30. For example, the value “Used” may be set to a specific item for a device with a specific device type. In another example, the value “Used” may be set to an item having a specific value that satisfies a preset condition.

In this example illustrated in FIG. 41, the value “Used” is set, when the connection destination has a value other than “None (indicated by a dash)”. Since the external device outside the meeting room may change depending on a meeting room in which a meeting is held, the value in this “connection destination” field may need to change when reproducing a meeting environment. The value collected from the device 30 may be registered as an initial value as illustrated in FIG. 33, with the value “Used” being set separately. With the initial value, the management apparatus 10A is able to display such initial value to a user, for example, when requesting the user to input a value “Used” when reproducing a meeting environment.

FIGS. 42A and 42B (FIG. 42) illustrate operation of reproducing a meeting environment, performed by the device management system of FIG. 30, according to this embodiment. The operation of FIG. 42 is substantially similar to the operation of FIG. 38, except for operation performed at the management apparatus 10A.

S141 to S143 are performed in a substantially similar manner as described above referring to S131 to S133 of FIG. 38. In response to detection of an access from a user terminal, the management apparatus 10A starts operation of FIG. 42 to display a reproduction request screen at S141. At S142, the management apparatus 10A receives a reproduction request including the selected reproduction data and destination meeting room. At S143, the management apparatus obtains the selected reproduction data from the storage area 112.

At S144, the management apparatus 10A determines whether there is any item that can be set by the user, in the reproduction data. The item that can be set by the user is set with the value “Used”.

When it is determined that there is an item that can be set by the user (“YES” at S144), the operation proceeds to S145.

At S145, the management apparatus 10A displays a screen that requests the user to input a value for that item with the value “Used”, and receives the value input by the user.

At S146, the management apparatus 10A updates the item that can be set by the user, with the user input value, and reflects that change to the reproduction data. In this example, the reproduction data to be modified with the user input value is reproduction data, which is read from the storage area 112 onto, for example, a work memory area. The reproduction data stored in the storage area 112 remains unchanged for later use.

At S147, based on the reproduced data updated at S146, the management apparatus 10A instructs the relay device 20 to reproduce a meeting environment specified by the reproduction data using the devices in the selected destination meeting room, in a substantially similar manner as described above referring to S133 of FIG. 38.

When there is no item that can be set by the user at S144 (“NO” at S144), the reproduction data to be referred to at S147 is not modified.

Based on the reproduction request, the relay device 20 instructs each device 30 in the selected destination meeting room to reproduce the operation state and the contents data, based on the reproduction data.

With this operation of FIG. 42, the device management system is able to reproduce a meeting environment, specified by the reproduction data which is partly different from the stored reproduction data. This improves flexibility and operability for the user, when using the reproduction data to reproduce a meeting environment. For example, there may be a case in which the devices in the meeting room are not so much different, but the destination connection may be different, from the previous meeting room or the previous time, when a videoconference is carried out among remotely located sites. Even in such case, only the connection destination, which is different, may be changed to modify the reproduction data.

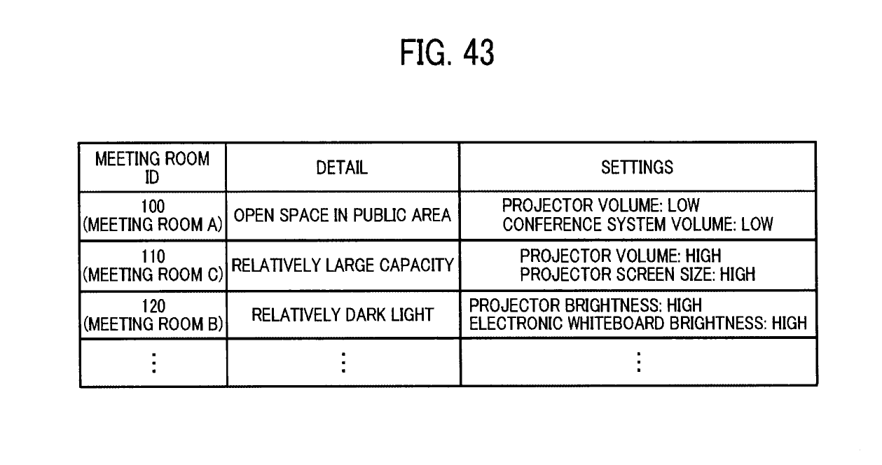

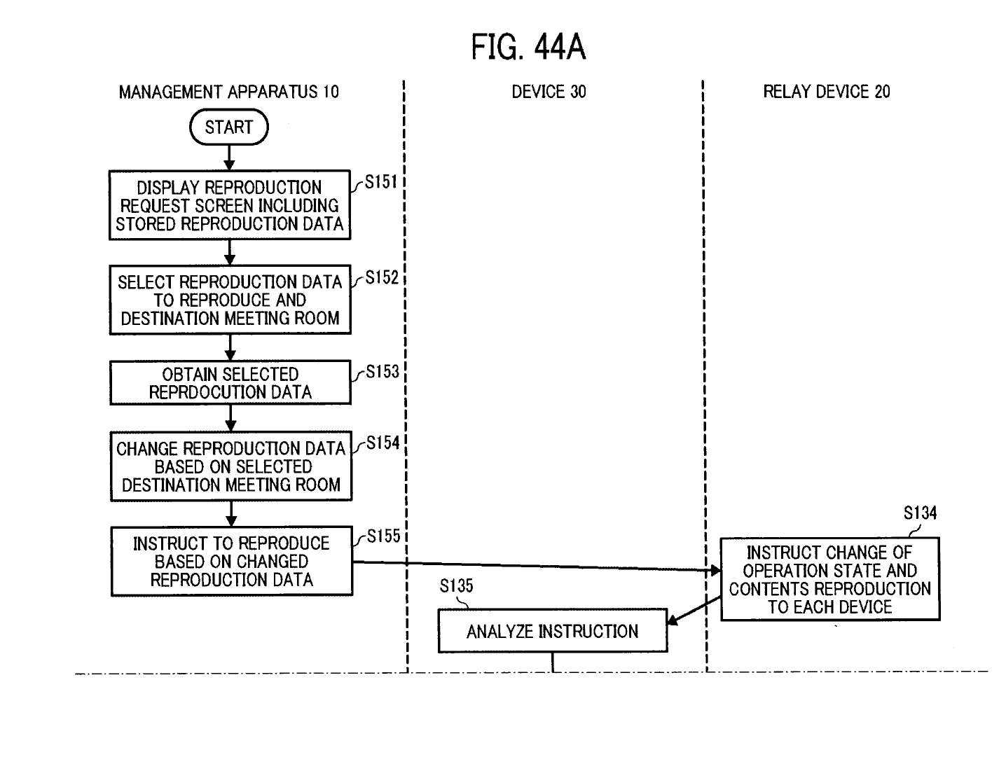

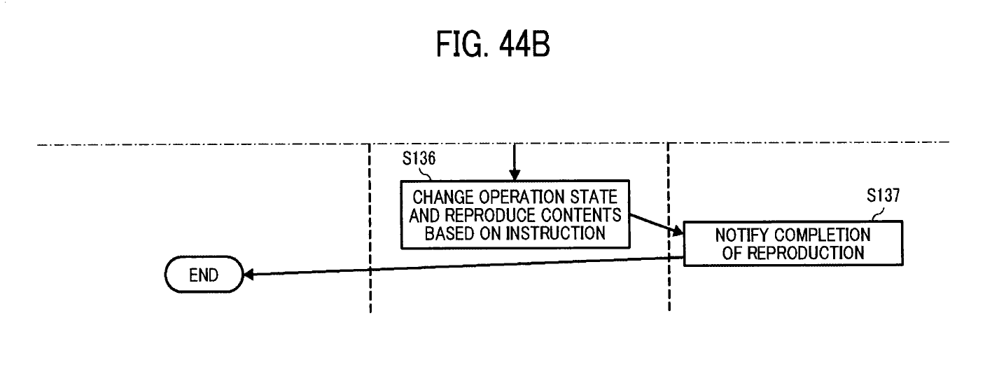

(Modified Example: FIGS. 43 and 44)

Referring now to FIGS. 43, 44A and 44B, a modified example is explained. In this embodiment of FIGS. 43, 44A and 44B, the device management system operates in a substantially similar manner as described above referring to FIGS. 30 to 40, except for some differences. The differences include automatically changing the settings to be reproduced according to the destination meeting room, when reproducing.

The meeting rooms having the devices to be managed by the management apparatus 10A are not always the same. For example, there may be a meeting room located in a public space such that outputting large sounds may not be preferable, or a large meeting room where outputting large sounds may be preferable. In this embodiment, the management apparatus 10A stores, for each meeting room available for use, information regarding the settings to be reflected to the reproduction data when reproducing a meeting environment based on the reproduction data, which is determined based on characteristics of the meeting room specified as a destination meeting room.

FIG. 43 illustrates a table storing information indicating the settings to be reflected to the reproduction data, which stores a meeting room ID, detail, and settings (items to be set), for each meeting room.

The meeting room ID is one example of identification information that identifies a meeting room. In FIG. 43, a meeting room name is described in the parenthesis. The “detail” field describes characteristics of the meeting room, which may be optionally provided for reference to the user. The “settings” field indicates a specific change to a specific item in the reproduction data.

Referring to FIG. 43, the meeting room A is an open space in a public area, such that the projector volume and the conference system volume are both set to “low”. The meeting room C is a large meeting room compared to the other meeting room, such that the projector volume is set to “high” and the projector screen (image) size is set to “high”, so that meeting participants in the room can hear or see from a distance.

In this example, any other items that are not set in the table of FIG. 43 is assumed that change is not required. Further, in the “settings” field, rather than the value to be set, the value to be changed may be set by a parameter. For example, the “settings” field may store information indicating that the sound volume is reduced to a level lower than the level set by the reproduction data. The management apparatus 10A previously stores information regarding the settings for each meeting room in the table of FIG. 43, before receiving a request for reproducing a meeting environment, according to an instruction from the administrator of the management apparatus 10A. While it is desirable to store information regarding the settings before storing the reproduction data, the management apparatus 10A may store information regarding settings after storing the reproduction data.

FIGS. 44A and 44B (FIG. 44) illustrate operation of reproducing a meeting environment, performed by the device management system of FIG. 30, according to an example embodiment of the present invention. The operation of FIG. 44 is substantially similar to the operation of FIG. 38, except for operation performed at the management apparatus 10A.

S151 to S152 are performed in a substantially similar manner as described above referring to S131 to S133 of FIG. 38. In response to detection of an access from a user terminal, the management apparatus 10A starts operation of FIG. 44 to display a reproduction request screen at S151. At S152, the management apparatus 10A receives a reproduction request including the selected reproduction data and destination meeting room. At S153, the management apparatus obtains the selected reproduction data from the storage area 112.

At S154, the management apparatus 10A refers to the table of FIG. 43 to obtain settings information, which is associated with the selected destination meeting room, using the meeting room ID of the selected destination meeting room. The management apparatus 10A changes the settings of an item of the reproduction data obtained at S153, as specified by the settings information.

At S155, based on the reproduced data modified at S154, the management apparatus 10A instructs the relay device 20 to reproduce a meeting environment specified by the reproduction data using the devices in the selected destination meeting room, in a substantially similar manner as described above referring to S133 of FIG. 38.

Based on the reproduction request, the relay device 20 instructs each device 30 in the selected destination device to reproduce the operation state and the contents data.

With this operation of FIG. 44, the device management system is able to reproduce a meeting environment, specified by the reproduction data which is modified according to an environment of the destination meeting room. This improves flexibility and operability for the user, when using the reproducing data to reproduce a meeting environment, without requiring manual operation by the user. For example, there may be a case in which the destination meeting room may be different, from the meeting room in which the reproduction data is collected. Even in such case, the difference between the meeting rooms may be considered to modify the reproduction data, thus setting the operation states of devices based on the modified reproduction data.

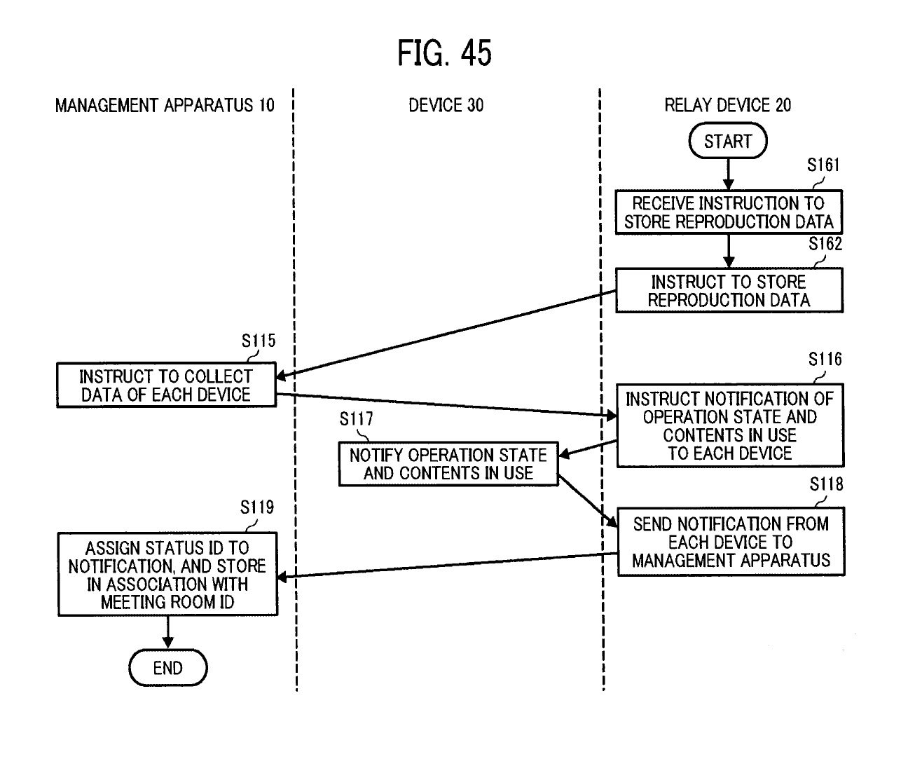

(Modified Example: FIG. 45)

Referring now to FIG. 45, a modified example is explained. In this embodiment of FIG. 45, the device management system operates in a substantially similar manner as described above referring to FIGS. 30 to 40, except for some differences. The differences include storing reproduction data at any desired time as instructed by a user.

FIG. 45 illustrates operation of storing reproduction data, performed by the device management system of FIG. 30, according to an example embodiment of the present invention. The operation of FIG. 45 is substantially similar to the operation of FIG. 36, except for addition of S161 and S162 before S115.

In response to an access from a user terminal, the relay device 20 displays a screen that allows the user at the user terminal to input an instruction for the devices in the meeting room, through the user terminal. The user terminal may be any device for relay management, or any other device such as a device that may be brought by the user. The user terminal may access the relay device using a browser, or dedicated application.

At S161, the relay device 20 receives a user instruction for storing reproduction data that reflects a meeting environment at a current time.

At S162, the relay device 20 sends an instruction for storing reproduction data regarding the devices for relay management, to the management apparatus 10A.

In response to the instruction, the management apparatus 10A requests the relay device 20 to collect information regarding the devices in the meeting room, and receives notification from the relay device 20 indicating a processing result including the collected information. Based on the collected information, the management apparatus 10A stores the reproduction data. The management apparatus 10A may send notification indicating completion of storing the reproduction data, to the relay device 20. The relay device 20 may further send such notification to the user terminal.

With the operation of FIG. 45, the management apparatus 10A may store the reproduction data reflecting a meeting environment, such as the state of meeting, at any desired time instructed by the user, irrespective of the change in operation state of the device. This improves flexibility and operability for the user, as the user preference may be reflected on the reproduction data being stored. In alternative to the above-described example, the instruction for storing reproduction data may be received at the management apparatus 10A, rather than at the relay device 20. In such case, in response to the instruction from the user terminal, the management apparatus 10A performs S115.

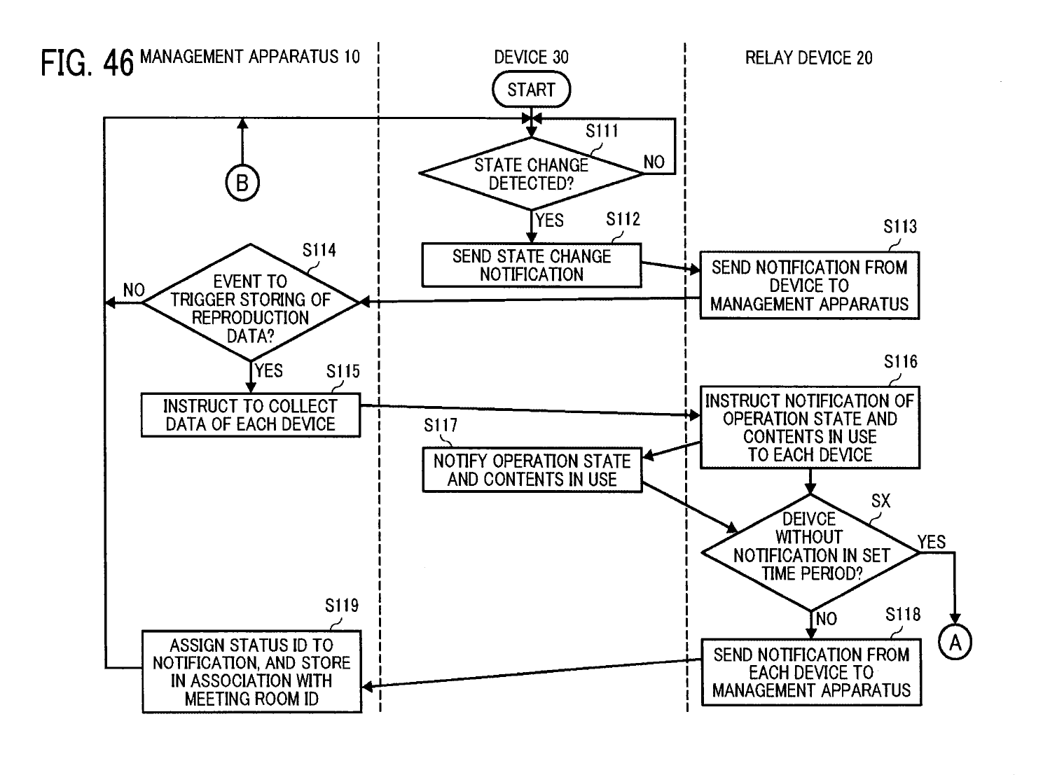

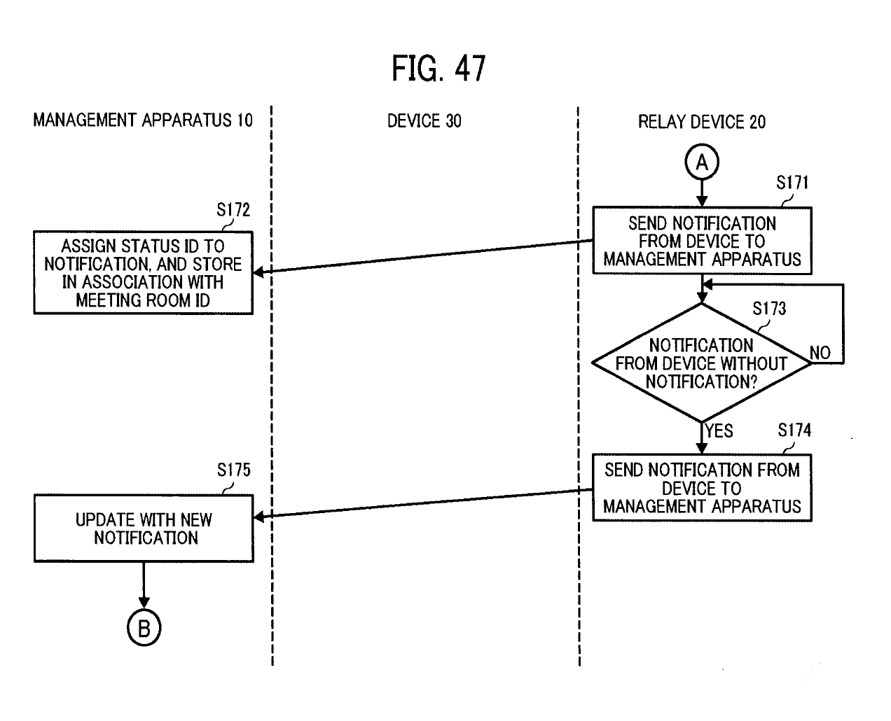

(Modified Example: FIGS. 46 and 47)

Referring now to FIGS. 46 and 47, a modified example is explained. In this example, when storing the reproduction data, it is assumed that operation state information and contents information are not obtained from at least a part of the devices for relay management.

FIGS. 46 and 47 illustrate operation of storing reproduction data, performed by the device management system of FIG. 30. The operation of FIGS. 46 and 47 is substantially similar to the operation of FIG. 36, except for the addition of step SX and operation of FIG. 47.

After requesting the device 30 to send the operation state information and the contents information to each device at S116, the operation proceeds to SX. At SX, the relay device 20 determines whether there is any device that has not sent the operation state information and the contents information for a preset time period. When it is determined that there is no device (“NO” at SX), the operation proceeds to S118 in a substantially similar manner as described above referring to FIG. 36.

When it is determined that there is at least one device that has not sent information (“YES” at SX), the operation proceeds to S171 of FIG. 47. For example, even when the device 30 normally operates, a response from the device 30 may not be received at relay device 20 within a preset time period, for example, due to a trouble on a network. For example, the loads on the network in the meeting room may increase, or the network may be temporarily disconnected.

At S171, the relay device 20 sends the operation state information and the contents information, which have been received for the preset time period, to the management apparatus 10A.

At S172, the management apparatus 10A assigns a status ID with the received information, and stores the received information in association with a meeting room ID at least temporarily in a memory. Since the management apparatus 10A is able to determine that the operation state information and contents information are not received from all devices, the management apparatus 10A does not register the received information as reproduction data.

At S173, the relay device 20 waits for information, such as the operation state information and the contents information, from the device that has not sent information. At S173, the relay device 20 continuously tries to collect information from the device that has not sent information. For example, the relay device 20 may send a request for operation state information and contents information to the device that has not sent information.

In response to receiving the information, at S174, the relay device 20 sends the received operation state information and the contents information to the management apparatus 10A.

At S175, the management apparatus 10A combines the temporarily stored information stored at S172, with the newly received information, to generate combined information. The management apparatus 10A further stores the combined information in the storage area 112 as reproduction data.

With this operation of FIGS. 46 and 47, even when some time is required for collecting information from devices 30, the management apparatus 10A is programmed to wait for the rest of information without causing a time-out error.

Alternatively, at S173, the relay device 20 may determine that the device that has not sent information for the preset time period is a device that is turned off, and sends the operation state information indicating the power off state for that device to the management apparatus 10A. Accordingly, even when the operation state information cannot be obtained from a part of the devices for relay management, the reproduction data can be generated and stored, as long as a number of devices not sending the information is not large.

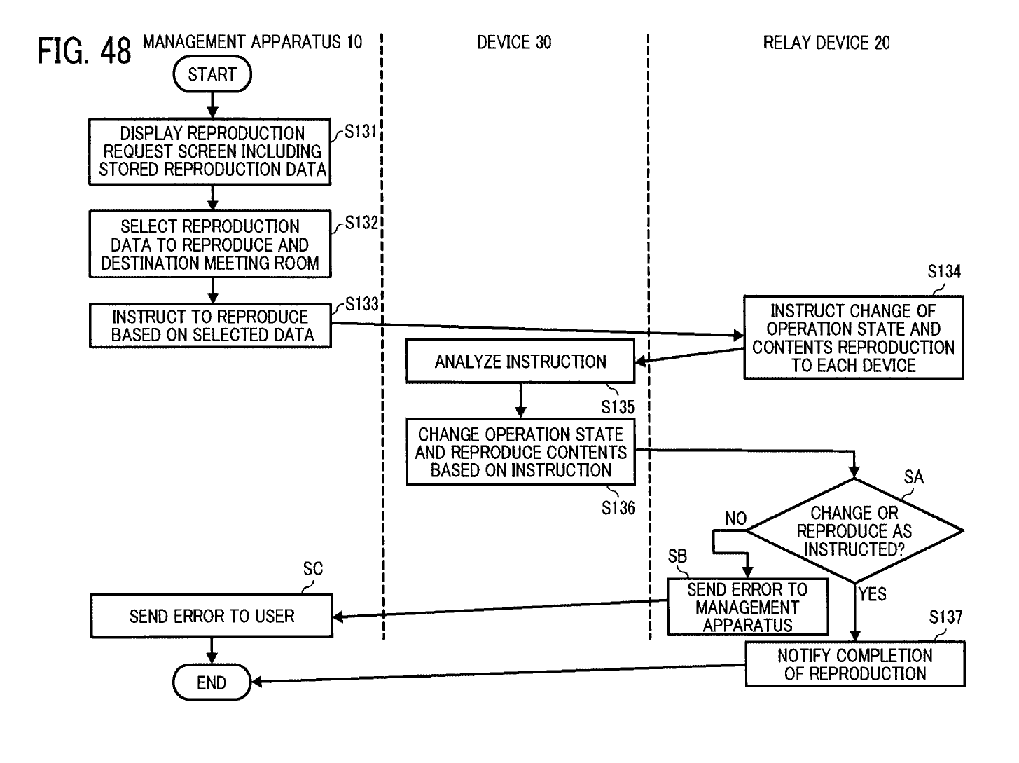

(Modified Example: FIG. 48)

Referring now to FIG. 48, a modified example is explained. In this example, it is assumed that reproduction of the operation state and the contents, using the reproduction data, fails.

FIG. 48 illustrates operation of storing reproduction data, performed by the device management system of FIG. 30, according to an example embodiment of the present invention. The operation of FIG. 48 is substantially similar to the operation of FIG. 38, except for the addition of steps SA to SC.

After requesting the device 30 to change the operation state and reproduce the contents using the reproduction data at S134, at SA, the relay device 20 collects the processing results indicating whether the reproduction request is successfully performed from the devices 30, and determines whether the change in operation state and the reproduction of contents have been successfully performed.

When it is determined that the change in operation state and the reproduction of contents have been successfully performed (“YES” at SA), the operation proceeds to S137 to notify completion of the reproduction request to the management apparatus 10A.

When it is determined that a part of devices, or all devices, have failed to change the operation state or reproduce contents (“NO” at SA), at SB, the relay device 20 sends notification indicating an error and the device that has failed to reproduce, to the management apparatus 10A.

At SC, the management apparatus 10A sends notification indicating an error and the device that has failed to reproduce, to a user terminal operated by the user, and the operation ends. For example, the management apparatus 10A may cause the browser or application, previously used for inputting the reproduction request by the user, to display a screen with a message dialog, or output warning sounds.

Examples of causes for error include, but not limited to, disconnection of a power cable to the device, disconnection of a wired network such as a cable to the device, and missing of the device in the meeting room.

With the operation of FIG. 48, the user who requests for reproducing a meeting environment is able to know that operation of reproducing fails, and a particular device that has failed. With this information, the user is able to visually check a cable connection for that device to correct any cause for error, and request the management apparatus 10A to try to reproduce again. Without such information, the user may need to walk around to find for any cause for an error, which may be cumbersome.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

For example, specific hardware or functional structures, processing, data structure, data format, available device type, communication function, role, etc., are not limited to those described above.

In some of the above-described embodiments, any one of the operation state, connection state, and contents to be reproduced, is assumed to be the same as the operation state, connection state, and contents that have been used during meeting. Alternatively, in one example, the user may edit the operation state or connection state to be reproduced, and store such information, for example, in the form of the state history table of FIG. 24 to be referred as information used for reproducing. In another example, the user may edit the operation state information to be reproduced before storing such information as the reproduction data.

Further, the meeting room is one example of an area that is managed by the device management system. For example, the area may be a classroom, show room, an event area, etc. In one example, the area may be applicable to any desired environment in which the connection state of a plurality of devices are to be changed, according to a specific area. In another example, the area may be applicable to any desired environment in which the operation state and contents of a plurality of devices are to be changed, according to a specific area. Each area does not have to be separated, for example, by a wall. The user may request to reproduce a specific environment, not only due to movement from one area to another area, but also due to the need for reproducing a specific environment. Similarly, any device in a specific area may be used, not only for meeting, but for the other purposes.

At S119 of FIG. 45, the management apparatus 10A assigns a status ID to reproduction data each time the reproduction data is stored. Alternatively, the management apparatus 10A may compare reproduction data to be stored, with previously stored reproduction data. When the contents are the same for both of the reproduction data to be stored and the previously stored reproduction data, the management apparatus 10A may assign the same status ID, used for the previously stored reproduction data, to the reproduction data to be stored. In this example, it is assumed that the contents are the same, when the contents in the reproduction data indicate the same meeting.

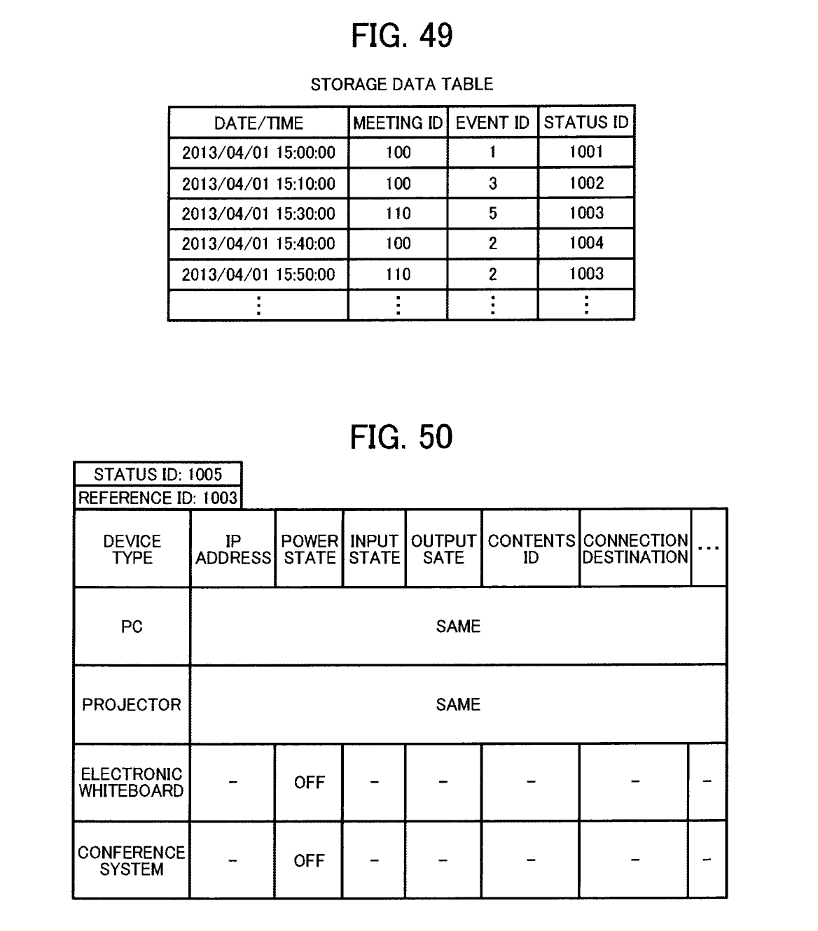

For example, referring to FIG. 49, assuming that reproduction data to be stored at 15:50:00 has the same contents as the reproduction data stored at 15:30:00, the management apparatus 10A may register the status ID “1003”, which is assigned to the reproduction data at 15:30:00, as a part of the reproduction data to be stored at 15:50:00. This indicates that the reproduction data stored at 15:30:00 can be used as the reproduction data to be stored at 15:50:00.

With this configuration, the reproduction data having the same contents does not have to be registered a plurality of times, thus reducing a memory area, i.e., the storage area, required for storing the reproduction data.

Similarly, when the contents in use matches between the contents information to be stored, and the contents information previously stored, the contents ID assigned to the previously stored contents information may be registered as a contents ID of the contents information to be stored. Accordingly, the reproduction data to be stored, which corresponds to the contents information, includes this contents ID. When comparing the contents of the reproduction data, the contents ID is also considered.

Alternatively, even when the contents of the reproduction data to be stored is not the exactly the same as that of the previously stored contents data, the management apparatus 10A may obtain the previously stored reproduction data having the contents that is substantially similar to that of the reproduction data to be stored to obtain a difference between those reproduction data. The obtained difference is stored in the storage area 112.

FIG. 50 illustrates an example case in which the difference in reproduction data is stored in the storage area 112. In this example, the reproduction data having the status ID “1005” is to be stored at 15:50:00, and is similar to the reproduction data having the status ID “1003” that is previously stored. In particular, information regarding the PC and the projector are the same for both of the reproduction data “1003” and “1005”. The reproduction data with the status ID “1005” indicates that the whiteboard and the conference system are both turned off (“off” for the power state), such that the other operation state information remains blank.

The reproduction data of FIG. 50, which is assigned with the status ID “1005”, includes the reference ID “1003” to request the management apparatus 10A to refer to the reproduction data having the status ID “1003”. The PC and projector information, which is the same as that of the reproduction data “1003”, is entered with the value “same”. The whiteboard and conference system information, which only differs in power state, is entered with the value “off” for the power state field, as a difference to the reproduction data “1003” to be referred.

In this example, the items that are common or different are determined on a device-basis. Alternatively, the items that are common or different may be determined in various other ways, for example, using any other basis such as a specific data field for a specific device.

Even when the reproduction data to be newly stored, and the reproduction data previously stored are not exactly the same, the management apparatus 10A is able to share common data as long as at least a part of contents are the same. This further reduces a requirement for a memory space.

In the above-described example, the management apparatus 10 or 10A is provided independently from the other devices 30 to be managed. Alternatively, any one of the functions of the management apparatus 10 or 10A may be performed by any device 30 to be managed.

Further, the management apparatus 10 or 10A does not have to be implemented as a single machine such as a single computer. Alternatively, a plurality of machines may operate in cooperation to perform the function of the management apparatus 10 or 10A.

In the above-described example, the first area and the second area are remotely located from each other. Alternatively, the second area may be same as the first area, for example, when the user wants to reproduce a meeting environment for the previous time, at the later time, even when the first area and the second area happen to be the same. Even in such case, the management apparatus 10 can perform any one of the above-described operation to reproduce a meeting environment in the first area onto the second area. In this manner, even when the environment has changed over time even in the same area, the environment in the first area (in this case, in a specific area at a first time) can be reproduced onto the second area (in this case, in the specific area at a second time).

Further, specific functional modules described above for the management apparatus is not limited to the above-described examples, as long as, the management apparatus 10 performs the functions according to a device management program.

For example, the illustrated server, that is, the management apparatus is only illustrative of one of several computing environments for implementing the embodiments disclosed herein. For example, in some embodiments, the management apparatus includes a plurality of computing devices, e.g., a server cluster, that are configured to communicate with each other over any type of communications link, including a network, a shared memory, etc. to collectively perform the processes disclosed herein. Similarly, the relay device can include a plurality of computing devices that are configured to communicate with each other.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

For example, a device management program may be executed by one or more processing circuits or circuitry, which may operate in cooperation, to perform a plurality of functions of the management apparatus 10.

The device management program may be partly, or entirely, stored in a memory such as a ROM or a nonvolatile memory such as a flash memory or EEPROM. The device management program, which may be stored in a nonvolatile memory such as a memory card, CD, DVD, or blue ray disc, to be distributed. In one example, such program stored in the memory may be installed onto one or more computers to perform any one of the above-described function or operation. In another example, such program stored in the memory may be downloaded onto one or more computers to perform any one of the above-described function or operation.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. A device management apparatus, comprising:
a processing circuitry configured to
store, in a memory, for each one of a plurality of areas, device information regarding a plurality of devices provided in the area, the device information indicating, for each device of the plurality of devices in the area, one or more roles that can be performed by each device and one or more communication functions available for each device;
store, in the memory, usage information indicating usage of one or more devices of the plurality of devices in a first area of the plurality of areas, the usage information indicating a role performed by each device of the one or more devices in the first area and a communication function used by each device of the one or more devices in the first area to establish a connection with a counterpart device;
receive a request for reproducing the one or more devices in the first area using a plurality of devices provided in a second area of the plurality of areas, through a network;
determine, for each one of one or more devices in the second area, 1) a role to be assigned to each device, and 2) a communication function to be used by each device to establish a connection with a counterpart device, using the usage information for the first area and the device information for the second area, so as to reproduce roles and connections of the one or more devices in the first area using the one or more devices in the second area;
send an instruction to establish the connection with the counterpart device using the determined communication function and to perform the determined role, to each one of the one or more devices in the second area that is assigned with the determined role, through the network.

2. The device management apparatus of claim 1, wherein, when the processing circuitry determines that at one specific device of the one or more devices in the second area is not capable of establishing the connection using the determined communication function, the processing circuitry is further configured to
select a communication function that is commonly available for the specific device and the counterpart device to be connected, using the device information for the second area, and
instruct the specific device to establish the connection with the counterpart device using the selected communication function.

3. The device management apparatus of claim 2, wherein, when the device information for the second area indicates no communication function that is commonly available for the specific device and the counterpart device to be connected, the processing circuitry is further configured to
select an alternative device in the second area capable of performing the role that is assigned to the specific device, and
instruct the alternative device to establish the connection with the counterpart device using a communication function that is commonly available for the alternative device and the counterpart device.

4. The device management apparatus of claim 1, wherein, when the processing circuitry determination that at least one specific device of the one or more devices in the second area is not capable of establishing the connection using the determined communication function, the processing circuitry is further configured to
determine whether a user operation is required to establish the connection of the specific device with the counterpart device, and
cause at least one of the plurality of devices in the second area to output information regarding the required user operation.

5. The device management apparatus of claim 1, wherein the processing circuitry is further configured to
detect a temporary device that is temporarily brought into any one of the plurality of areas,
obtain device information from the temporary device to additionally store the obtained device information in the memory, and
obtain usage information indicating usage of the temporary device in the area where the temporary device is detected, to additionally store the obtained usage information in the memory.

6. The device management apparatus of claim 1, wherein the usage information stored in the memory indicates usage of one or more devices of the plurality of devices in two or more of the plurality of areas, and the processing circuitry is further configured to
select one of the two or more of the plurality of areas according to priority information previously set, as the area subjected for reproducing onto the second area, and
determine the role and the communication function for each one of the one or more devices in the second area, using the usage information for the selected area subjected for reproducing.

7. The device management apparatus of claim 1, wherein the processing circuitry receives the usage information indicating usage of one or more devices of the plurality of devices at least from the first area at a predetermined time, and
further stores information indicating the time when the usage information is stored.

8. The device management apparatus of claim 7, wherein the usage information further indicates an operation state of each device of the one or more devices in the first area, and
the processing circuitry receives the usage information indicating the operation state of each device of the one or more devices in the first area, when the change in operation state of at least one of the one or more devices in the first area is detected.

9. The device management apparatus of claim 8, wherein the usage information further indicates contents data being used by each device of the one or more devices in the first area, and
the processing circuitry further sends an instruction to operate to be in the operation state indicated by the usage information for the first area, and reproduce the contents data indicated by the usage information for the first area, to each one of the one or more devices in the second area, in response to the request for reproducing.

10. The device management apparatus of claim 9, wherein the processing circuitry is further configured to modify the usage information for the first area according to characteristics information regarding the second area to generate modified usage information, and to send the instruction to each one of the one or more devices in the second area to operate in the operation state indicated by the modified usage information.

11. A system of reproducing an environment of a first area onto a second area, comprising:
a plurality of first devices provided in the first area, including:
one or more devices in the first area each configured to send usage information indicting usage of the device, which indicates a role performed by the device and a communication function used by each device to establish a connection with a counterpart device; and
a plurality of second devices provided in a second area remotely located from the first area, including
one or more devices in the second area each configured to receive an instruction to establish a connection with a counterpart device using a communication function and to perform a role, in response to a request for reproducing the one or more devices in the first area using the plurality of devices in the second area,
the counterpart device, the communication function, and the role being respectively determined based on the usage information for the first area and device information for the second area.

12. The system of claim 11, wherein, when at least one specific device of the one or more devices in the second area is not capable of establishing the connection using the determined communication function, the specific device in the second area further receives an instruction to establish the connection with the counterpart device using a communication function that is commonly available for the specific device and the counterpart device to be connected, which is selected using device information for the second area.

13. The system of claim 12, wherein, when the device information for the second area indicates no communication function that is commonly available for the specific device and the counterpart device to be connected, an alternative device of the one or more devices in the second area, other than the specific device, further receives an instruction to establish the connection with the counterpart device using a communication function that is commonly available for the alternative device and the counterpart device, the alternative device being capable of performing the role that is assigned to the specific device.

14. The system of claim 11, wherein, when at least one specific device of the one or more devices in the second area is not capable of establishing the connection using the determined communication function, at least one of the plurality of devices in the second area is caused to output information regarding a required user operation, based on determination that the user operation is required to establish the connection of the specific device with the counterpart device.

15. The system of claim 11, wherein the usage information further indicates an operation state of each device of the one or more devices in the first area, and contents data being used by each device of the one or more devices in the first area, and
the one or more devices in the second area are each configured to receive an instruction to operate to be in the operation state indicated by the usage information for the first area, and reproduce the contents data indicated by the usage information for the first area.

16. A method of reproducing an environment of a first area onto a second area, the method comprising:
obtaining usage information indicating usage of one or more devices of a plurality of devices provided in a first area, from the one or more devices in the first area, the usage information indicating a role performed by each device of the one or more devices in the first area and a communication function used by each device of the one or more devices in the first area to establish a connection with a counterpart device;
accepting a request for reproducing the one or more devices in the first area using a plurality of devices provided in a second area remotely located from the first area;
reproducing connections of the one or more devices in the first area, through establishing a connection of each one of one or more devices in the second area with a counterpart device using a communication function, the counterpart device and the communication function for each device being determined based on the usage information for the first area and device information for the second area; and
reproducing roles of the one or more devices in the first area, through causing each one of the one or more devices in the second area to perform a role indicated by the usage information for the first area.

17. The method of claim 16, wherein, when at least one specific device of the one or more devices in the second area is not capable of reproducing the connection using the determined communication function, the method further comprising:
selecting an alternative communication function that is commonly available for the specific device and the counterpart device to be connected, using the device information for the second area; and
reproducing a connection of a device in the first area corresponding to the specific device in the second area, through establishing a connection of the specific device with the counterpart device using the selected communication function of the specific device.

18. The method of claim 17, wherein, when the device information for the second area indicates no communication function that is commonly available for the specific device and the counterpart device to be connected, the method further comprising:
selecting an alternative device of the one or more devices in the second area, other than the specific device, which is capable of performing the role assigned to the specific device;
reproducing a role of a device in the first area corresponding to the specific device in the second area, through causing the selected alternative device to perform the role once assigned to the specific device; and
reproducing a connection of the device in the first area corresponding to the specific device in the second area, through establishing a connection of the selected alternative device with the counterpart device using a communication function that is commonly available for the selected alternative device and the counterpart device.

19. The method of claim 16, wherein, when at least one specific device of the one or more devices in the second area is not capable of reproducing the connection using the determined communication function, the method comprising:
outputting information regarding a required user operation, based on determination that the user operation is required to establish the connection of the specific device with the counterpart device.

20. The method of claim 16, wherein the usage information further indicates an operation state of each device of the one or more devices in the first area, and contents data being used by each device of the one or more devices in the first area, the method further comprising:
reproducing operation states of the one or more device in the first area, through causing each one of the one or more devices in the second area to operate to be in the operation state indicated by the usage information for the first area; and
reproducing contents used by the one or more devices in the first area, through causing each one of the of the one or more devices in the second area to process the contents data indicated by the usage information for the first area.
